(19) United States
(12) Patent Application Publication
(10) Pub. No.: US 2013/0003543 A1
(43) Pub. Date: Jan. 3, 2013

(54) NEXT-GENERATION BANDWIDTH MANAGEMENT CONTROL SYSTEMS FOR MULTIPLE-SERVICE CALLS, SESSIONS, PACKET-LEVEL PROCESSES, AND QoS PARAMETERS - PART 1: STRUCTURAL AND FUNCTIONAL ARCHITECTURES

(75) Inventor: Lester F. LUDWIG, Belmont, CA (US)

(73) Assignee: AVISTAR COMMUNICATIONS CORPORATION, San Mateo, CA (US)

(21) Appl. No.: 13/540,545

(22) Filed: Jul. 2, 2012

Related U.S. Application Data
(60) Provisional application No. 61/503,053, filed on Jun. 30, 2011.

(51) Int. Cl. H04L 12/26

(52) U.S. Cl. 370/230

(57) ABSTRACT

System and method for addressing immense, long-standing problem of bandwidth management, for example, in enterprise networks, VPNs, real-time and stored video services, mobile applications, wireless networks, and cloud computing applications. Described features include an automatic closed-loop control system infrastructure encompassing multiple time-scales and performing control actions optimized to the extent possible with respect to administrator-provided performance metrics. One aspect utilizes available or innovatively accessible means of session and QoS control (settings in configuration files, gateway APIs, QoS parameters, application bit-rate settings, etc.) within the context of practical multiple-vendor products in evolving multiple-service networks. Another aspect utilizes available or innovatively accessible means of session and QoS observations (values in reporting log files, gateway APIs, network monitoring, etc.) within the context of practical multiple-vendor products in evolving multiple-service networks. Traffic-measurement controlled adaptive reservations for distributed myopic single-service gatekeepers effectively shapes the permitted state-space boundary over a range of arbitrary curvatures.

### CROSS-REFERENCE TO RELATED APPLICATIONS

This application claims priority from U.S. Provisional Patent Application 61/503,053, filed Jun. 30, 2011, the entire content of which is herein incorporated by reference, and which is further incorporated herein.

### COPYRIGHT & TRADEMARK NOTICES

A portion of the disclosure of this patent document may contain material, which is subject to copyright protection. Certain marks referenced herein may be common law or registered trademarks of the applicant, the assignee or third parties affiliated or unaffiliated with the applicant or the assignee. Use of these marks is for providing an enabling disclosure by way of example and shall not be construed to exclusively limit the scope of the disclosed subject matter to material associated with such marks.

### BACKGROUND OF THE INVENTION

1. Field of the Invention

This invention relates in general to bandwidth management and, more particularly, to providing bandwidth management control systems for multiple-service calls, sessions, packet-level processes, and QoS parameters.

2. Description of the Related Art

Driven by many forces ranging from the natural evolution of advanced network-based computer applications in the workplace to economic and market forces propelling “unified communications” networking products, corporate enterprise networks are besieged by ever-increasing volumes of communications traffic.

Additionally, an ever-increasing portion of this traffic has real-time or near-real-time performance requirements. Anecdotally, most enterprise IT organizations consulted repeatedly express continuing and escalating exasperation as to bandwidth management challenges despite the considerable advances in IT technology performance.

FIG. 1 depicts an example representation of some of the traditional forces that have been building up over many years which contribute to creation of the increasingly urgent needs for bandwidth management within the Enterprise. On the technology side, various types of real-time (live) and near-real-time (for example, streamed or view-as-downloaded) video and voice applications both load the network and require higher performance. These recent but increasingly familiar network-challenging technologies are occurring as other yet older enterprise uses of non-real-time data (database transactions, database sessions, client-server, web browsing, etc.) are also seeing vast growth. On the business directive side, forces such as organizational performance (effectiveness and efficiency), market pressures (customer expectations, competitive pressure), and opportunity losses incurred from network limitations push Information Technology (IT) organizations to increase network capabilities and performance. On the business operations side, numerous forces raise equipment and services costs to tremendous scales while staffs increasing are shorted in numbers, adequate expertise, and fundamental human limitations.

Yet further networking challenges that contribute to the urgent needs for bandwidth management within the Enterprise come from the virtualization of servers and desktops. In the case of (now widely adopted) server virtualization, a recent accounting offered in the article “No end to innovation” by John Dix, Network World, May 23, 2011, points out the tremendous added volume of traffic that has been created:
“ . . . Of course in this new dynamic IT world, data center machine assets are increasingly virtual, more specialized, have a tendency to move around, and result in ever more server-to-server links across the data center network.
This so called East/West traffic already accounts for some 75% of data center traffic, and adding more server-to-server links will increase latency in traditional three-tier data center networks that have to route that traffic North/South up and down tiers, says HP's Michael Nielsen, director of network solutions . . . . ”
(available at http://www.networkworld.com/columnists/2011/052311-editorial.html?source.NWWNLE_nit_daily_am_{—}2011-05-24, visited May 24, 2011).

Even more importantly, in the case of the new entrant of desktop virtualization (also known as “Virtual Desktop Infrastructure” or “VDI”), a significant amount of network traffic will also added as enterprise desktop computing environments of every enterprise user become split between servers and “thin-client” endpoints that operate only as simply display and user-input devices. Anticipated adoption will create immense volumes of an entirely new type of bursty traffic which will have near real-time performance requirements. Even minor shortfalls in performance have been held as reasons to hold back on VDI by users, while the cost-reduction and operational-simplification appeals of widespread enterprise VDI deployment to corporate IT organizations and cost decision-makers is forcing VDI traffic into the network.

Accordingly, a vast proportion of the exploding amounts of current and future network traffic in the Enterprise will comprise bandwidth-intensive real-time applications and near-real-time applications:
bandwidth-intensive real-time applications such as VoIP, video conferencing, live webinars, etc.;
bandwidth-intensive near-real-time applications such those involved with Content Delivery Network (“CDN”) applications such as YouTube and other recorded video, recorded audio, retrieved webinars, etc.

Most analysts and network equipment manufacturers agree that the bandwidth-intensive real-time communications portion of enterprise networking will soon dominate enterprise network traffic, yet further increasing the challenge.

### Limited Available Solutions for the Enterprise and Mobile Wireless Networks

There are only a few commercially available primitive capabilities useful for bandwidth management, these being:
Limited sets of simple QoS (Quality-of-Service) features in routers and switches to offer some level of quality to VoIP and live-video applications; and
Proprietary service-specific and product-specific session management systems for services used by applications such as VoIP and live-video.
   These primitive capabilities essentially operate “open loop” and “myopically” without regard to changes in network conditions.
   Larger View of Accelerating Problem Scope within the Enterprise and Mobile Wireless Networks

Enterprise bandwidth management challenges will continue to sharply and rapidly broaden and deepen, driven at least by:
the volume of deployed networking technology increases and diversifies;
new “spiking” forces such as:
   corporate video conferencing usage increases and performance upgrades;
   sudden needs for international real-time networking;
   new mobile and wireless network capabilities;
   reliance on heavily networked (on-site and off-site) cloud services; and
shock failures of ‘reliable’ network and systems.

### Imperative Bandwidth Management Needs of the Enterprise and Mobile Wireless Networks

As the abovementioned forces, trends, and events appear with accelerating intensity and frequency, the need will become absolutely imperative for a coherent, realistic, multiple-vendor, multiple-service, multiple-network, bandwidth management approach that:
Works for a varied mixes of a wide range of IP-based communications services in the enterprise;
Provides adequate performance to real-time applications;
Comes as close as possible to optimal on-going performance over a wide range of conditions; and
Provides optimal instantaneous adaptation to shocks.
   In fact, in the view of many of the aforementioned enterprise IT organizations, the need for any viable approach that would address even small subsets of those goals is already an absolute imperative. Further, despite impressive developments an promise in micro-cellular, pico-cellular, and femto-cellular wireless antenna and transceiver technologies, wireless and mobile networks are equally in peril as more and more bandwidth demands appear monthly with the threat of enhanced real-time two-way video services loaming.

### SUMMARY OF THE INVENTION

Features and advantages of the embodiments of the invention will be set forth in the description which follows, and in part will be apparent from the description, or may be learned by practice of the embodiments of the invention. The objectives and other advantages of the invention will be realized and attained by the structure particularly pointed out in the written description and claims hereof as well as the appended drawings.

At least one aspect of the inventive concept seeks to address the needs listed above by providing a realistic bandwidth management approach compatible with today's known and tomorrow's anticipated future multiple IP services that:
works for a varied mixes of a wide range of IP-based communications services in the enterprise;
provides at least adequate-quality performance to real-time applications;
comes as close as possible to optimal on-going performance over a wide range of conditions; and
provides (as close as possible to) optimal instantaneous adaptation to shocks.

Additional aspects related to the invention will be set forth in part in the description which follows, and in part will be obvious from the description, or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The above and other aspects, features and advantages of the present invention will become more apparent upon consideration of the following description of preferred embodiments taken in conjunction with the accompanying drawing figures. The accompanying figures are examples of the various aspects and features of the present invention and are not limiting either individually or in combination. The accompanying figures, which are incorporated in and constitute a part of this specification exemplify the embodiments of the present invention and, together with the description, serve to explain and illustrate principles of the inventive technique. Specifically:

FIG. 1 depicts an exemplary representation of example traditional forces creating the increasingly urgent need for bandwidth management within the Enterprise.

FIG. 2 depicts an exemplary integrated representation of call or session processes and packet processes.

FIG. 3 depicts an exemplary integrated model of call or session activity processes and packet processes associated with an endpoint operated by a user during the call or session.

FIG. 4 depicts a user community representation of a call or session process for bandwidth allocation purposes.

FIG. 5 depicts a version of the representation of FIG. 4 wherein arrival rates for calls/sessions are recognized as vary over time, these variations occurring at various time-scales.

FIG. 6 depicts an adaptation of the representation of FIG. 4 comprising a plurality of differing types of services.

FIG. 7 depicts an exemplary “pie chart” representation of a network supporting N different types of services ({Service 1, Service 2, . . . , Service N}) makes bandwidth available for general use by any of the services.

FIG. 8 depicts an exemplary state space for a two-service bandwidth allocation model in a situation where bandwidth is shared among varying numbers of instances of two types of services.

FIG. 9 depicts the effects on the state of admitting a new call or session and of the completion of an active call or session.

FIG. 10A depicts an exemplary region of permitted states, an example region of impossible states, and an example boundary separating these regions for the example state space model of FIG. 8 that is subjected to a maximum bandwidth constraint.

FIG. 10B depicts representative examples of two-service mixed bit-rate call/session blocking behaviors as a function of the ratio of the bit rates.

FIG. 11A is a reproduction of FIG. 7 provided for comparison with FIG. 11B.

FIG. 11B depicts an exemplary “pie chart” representation of an example general bandwidth partition arrangement accommodating N different types of services ({Service 1, Service 2, . . . , Service N}) wherein each service is provided with its own exclusive bandwidth pool.

FIG. 11C shows the permitted states for an example of such a situation in terms of the state space of FIG. 8, FIG. 9, and FIG. 10A.

FIG. 11D shows the proportion of fully-shared states in the rectangle of allowed states as a function of the proportion of either L₁r₁ or L₂r₂ to Rₘₐₓ.

FIG. 11E shows the proportion of fully-shared states in the rectangle of allowed states as a function of the ratio of either L₁r₁/L₂r₂ or L₂r₂/L₁r₁.

FIG. 12A depicts an exemplary modification of the example region of permitted states identified in FIG. 10A wherein in this modification some bandwidth is reserved for the exclusive use of Service 2.

FIG. 12B depicts an exemplary arrangement wherein reservations are provided for Service 1 rather than Service 2,

FIG. 12C depicts an exemplary arrangement wherein reservations are provided for both Service 1 and Service 2.

FIG. 13A depicts a “reserved parking” analogy example for the reserved bandwidth arrangement of the type represented by FIG. 12A.

FIG. 13B depicts an expanded “reserved parking” analogy example for the reserved bandwidth arrangement of the type represented by FIG. 12C.

FIG. 14A is a reproduction of FIG. 7 provided for comparison with FIG. 14B.

FIG. 14B depicts an exemplary “pie chart” representation of an example general bandwidth reservation arrangement accommodating N different types of services ({Service 1, Service 2, . . . , Service N}) sharing a common bandwidth pool.

FIG. 14C depicts an exemplary implementation of a reservation system for a multiservice network wherein a “global” control system provides updates to the each of the gateways as to the maximum number of calls/sessions each service is to permit.

FIG. 14D depicts an example of how such a “global” control system can manipulate the maximum number of calls/sessions each service is to permit so as to create a reservation system.

FIG. 14E depicts an exemplary implementation without a centralized controller wherein information can be exchanged among communications silos through use of a shared database or shared files.

FIG. 14F depicts another exemplary implementation without a centralized controller wherein information can be exchanged among communications silos through direct peer-to-peer communications among the communications.

FIG. 15 depicts a “reserved parking” analogy for the reserved bandwidth arrangement of the type represented by FIG. 14B.

FIG. 16 provides a representation of the increasing numbers of unified communications services (such as VoIP, H.323 video, SIP video, Content Delivery Network streaming, VDI, and other services) each provide their own reservation system gatekeepers.

FIG. 17 depicts an exemplary general high-level representation of some packet traffic attributes relevant to QoS-based networking support for a plurality of differing types of services.

FIG. 18 depicts an exemplary general IP session framework.

FIG. 19 depicts an exemplary primitive session-level control framework.

FIG. 20 depicts an example of a yet richer session-level control framework wherein a rate-adaptation control capability has been added.

FIG. 21 depicts an exemplary enhancement of the session-level control framework depicted in FIG. 20 wherein rate-adaptation control capability has been added, allowing the transmission rate to be controlled during an active session.

FIG. 22 depicts an exemplary primitive packet-level QoS control framework for QoS capabilities of network elements.

FIG. 23 depicts an example of a richer packet-level QoS control framework for QoS capabilities of packet generation processes within applications.

FIG. 24 depicts an example of an overall call/session packet-level QoS control framework.

FIG. 25 depicts an adaptation of the representation of FIG. 24 which more broadly includes other “input” variables.

FIG. 26 depicts an example of the representation of FIG. 25 which further comprises primitive collection of example variable monitoring and estimation processes.

FIG. 27 depicts an example of the representation of FIG. 26 which further comprises a richer collection of example variable monitoring and estimation processes.

FIG. 28A, FIG. 28B, and FIG. 28C depict exemplary evolutionary paths for bandwidth management technologies.

FIG. 29 depicts a key principle leveraged by the present invention.

FIG. 30 depicts an example of a two-layer control implementation with no coordination between call/session admission control and QoS control.

FIG. 31A depicts an example of a two-layer control implementation with coordination between call/session admission control and QoS control.

FIG. 31B depicts an example of a unitary two time-scale control implementation providing call/session admission control and QoS control.

FIG. 32 depicts an exemplary basic call/session admission closed-loop control system.

FIG. 33A depicts an exemplary adaptation of FIG. 14C wherein the fixed reservation control system is replaced by an adaptive reservation control system, or modified so as to provide adaptive reservation control capabilities.

FIG. 33B depicts an exemplary adaptation of FIG. 14C wherein the fixed reservation control system is in turn controlled by an additional control system that can modulate the fixed reservation settings.

FIG. 33C depicts an exemplary adaptation of FIG. 14E wherein an external adaptive reservation control system can communicate with the shared database or shared files

FIG. 33D depicts an exemplary adaptation of FIG. 14F wherein an external adaptive reservation control system can communicate with each of the communications silos.

FIG. 33E depicts a representation generalizing each of the examples described in conjunction with FIGS. 33A-33D (as well as other arrangements).

FIG. 34A depicts exemplary shaded sub-regions of reservation regions are unfair to the other service(s).

FIG. 34B depicts exemplary alternative reservation boundary shapes.

FIG. 35A depicts a representation of an adaptive reservations controller comprising a quantization process.

FIG. 35B depicts a representation of an adaptive reservations controller comprising a hysteresis process.

FIG. 36 depicts an exemplary adaptation of the arrangement of FIG. 32 wherein the basic call/session admission closed-loop control system also variably controls call/session rate allocation made at the beginning of each new call/session allocation.

FIG. 37 depicts an exemplary arrangement wherein a control system controls QoS parameters affecting packet transport responsive to network traffic conditions.

FIG. 38 depicts an exemplary arrangement wherein a control system controls bit rate at applications, varying these over time responsive to network traffic conditions.

FIG. 39 depicts an exemplary arrangement wherein a common control system controls bit rate at applications and packet transport QoS parameters at network elements, varying these over time responsive to network traffic conditions.

FIG. 40 depicts an exemplary arrangement wherein a common control system to vary both QoS parameters at applications and packet transport QoS parameters at network elements, varying these over time responsive to network traffic conditions.

FIG. 41 extends the exemplary arrangement of FIG. 40 further by also including control of rate adaptation provisions at applications.

FIG. 42 depicts an exemplary adaptation of the arrangement of FIG. 36 wherein the basic session admission closed-loop control system also variably controls at least one rate adaptation parameter within the duration of an active call or session.

FIG. 43 depicts an exemplary combined closed-loop feedback control of session/call admission, rate adaptation parameters, and network element QoS parameters.

FIG. 44 depicts an exemplary adaptation of the arrangement of FIG. 43 wherein the QoS closed-loop control system additionally variable controls application packet generation QoS parameters other than rate adaptation.

FIG. 45 illustrates an exemplary embodiment of a computer/server hardware platform upon and in the context of which the inventive system may be implemented.

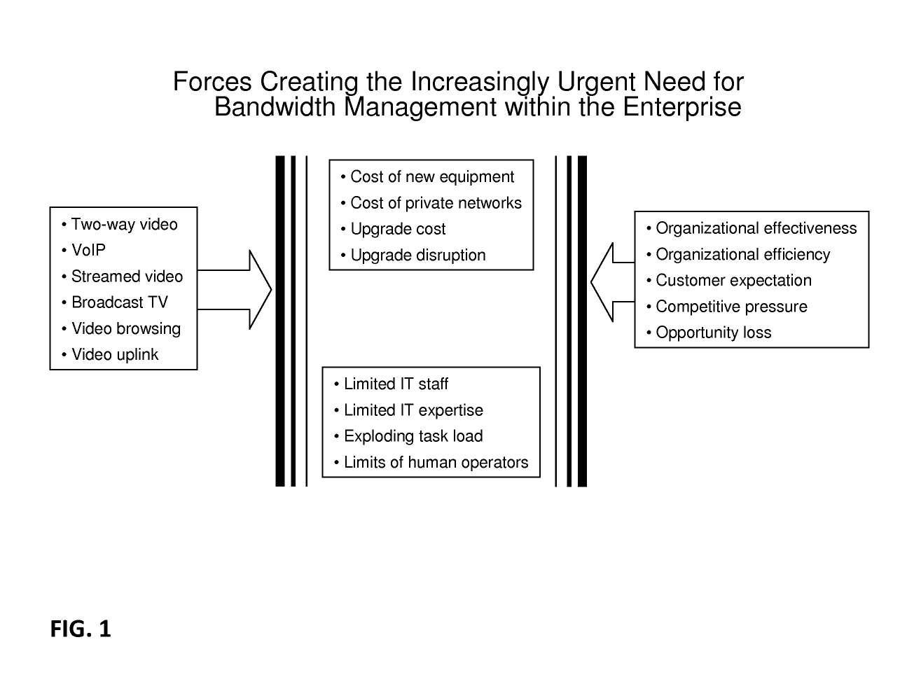

### DETAILED DESCRIPTION

In the following description, reference is made to the accompanying drawing figures which form a part hereof, and which show by way of illustration specific embodiments of the invention. It is to be understood by those of ordinary skill in this technological field that other embodiments can be utilized, and structural, electrical, as well as procedural changes can be made without departing from the scope of the present invention. The aspects and features described herein may be used singly or in combination unless specifically stated otherwise. Additionally, the various embodiments of the invention as described may be implemented in the form of a software running on a general purpose computer, in the form of a specialized hardware, or combination of software and hardware.

### Overview of the Aspects of the Invention

Against these vast needs, challenges, and absence of appropriate solutions, various aspects of the present invention are directed. The inventive approach:
Creates and/or aggregates available or innovatively accessible means of session and QoS control (settings in configuration files, gateway APIs, QoS parameters, application bit-rate settings, etc.) within the context of practical multiple-vendor products in evolving multiple-service enterprise networks;
Creates and/or aggregates available or innovatively accessible means of session and QoS observation (values in reporting log files, gateway APIs, network monitoring, etc.) within the context of practical multiple-vendor products in evolving multiple-service enterprise networks; and
Provides an automatic closed-loop control system infrastructure encompassing multiple time-scales and performing control actions optimized to the extent possible with respect to administrator-provided performance metrics.

### 1. Single-Service and Multiple-Service IP Network Loading

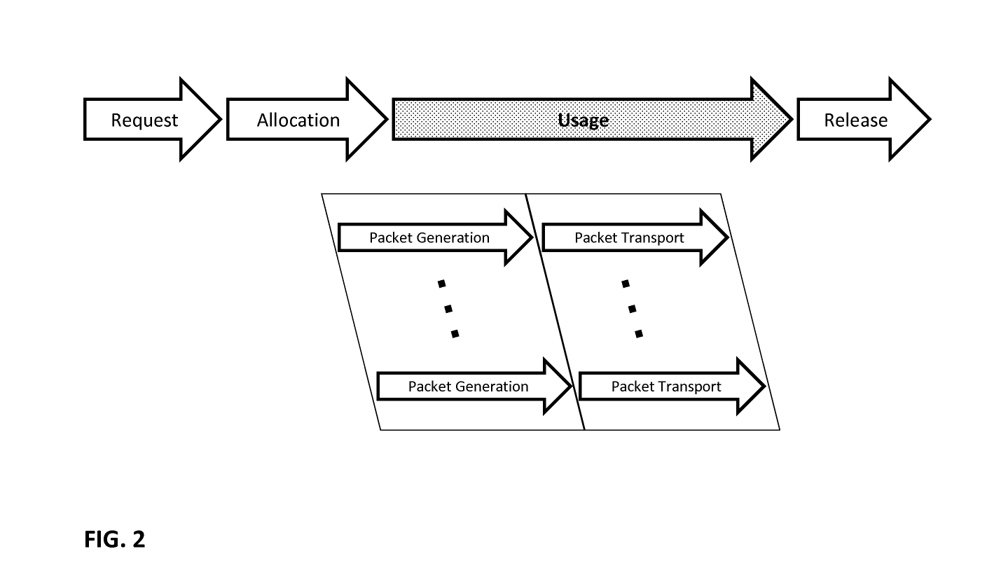

FIG. 2 depicts an exemplary integrated representation of call or session processes and packet processes. In the figure, time increases (although not necessarily at a fixed scale) from left to right. The network arrangement depicted in FIG. 2 can apply to machine-to-machine transactions as well as to session oriented network protocols such as TCP/IP, but for this discussion the upper portion of the figure relates to matters of the user experience and the lower portion of the figure relates to packet generation and transport.

Here a call request, session log-in, or other initiation request is submitted by a user for a call or session that will involve the use of network bandwidth. The acceptance or denial of call request, session log-in, or other initiation request can be made by various entities (end users of a call, application server, etc.) depending on the application or service. Once acceptance occurs, resources of various types (including computational resources, network resources, communications server resources, database resources, firewall ports, etc.) are some sense allocated for use by the call or session. Then the, resulting in a “usage” phase of the call or session typically begins. Throughout the interval of time wherein the call or session is in this “usage” phase, packets are generated at endpoints and transported by the network. After some interval of time, the call or session ends at which time the allocated resources are released and the generation and transport of packets ceases.

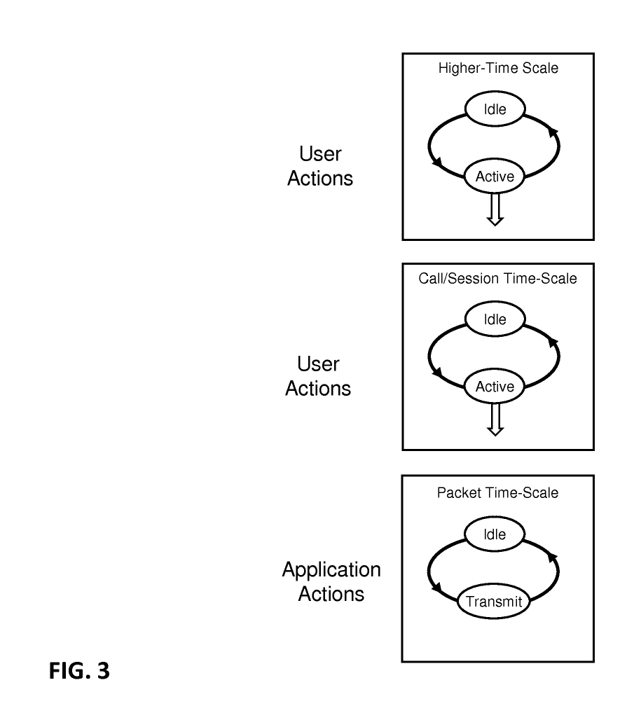

FIG. 3 depicts an exemplary integrated model of call or session activity processes and packet processes associated with an endpoint operated by a user during the call or session. At the highest-level time-scale user can move between time intervals of actively acting on needs for calls or sessions and time intervals of where there is no such action (the latter of which, from the viewpoint of a call or session, could be viewed as intervals of idleness). Once a call or session is active, the user can move between intervals of activity or idleness, which typically (although not necessarily) affects the generation of packets (for example affecting the number of packets per interval of time, the length of packets, the time between packet generations, etc.). Representations such as that of FIG. 3 can be analytically useful in models and simulations leveraged to understand network behavior as well as in the design and operation of network control systems such as those of the present patent application. Additionally, the representation of FIG. 3 can be used to call out the relative time constants for the idle/activity cycles at each of the three levels depicted, and the implicit hierarchical structure in dynamics within the overall traffic generation environment. In analytical or simulation models, probability distributions can be associated with the dynamics of idle/activity cycles at each of the three levels depicted, and yet additional levels of detail can be introduced to represent or account for detailed phenomena.

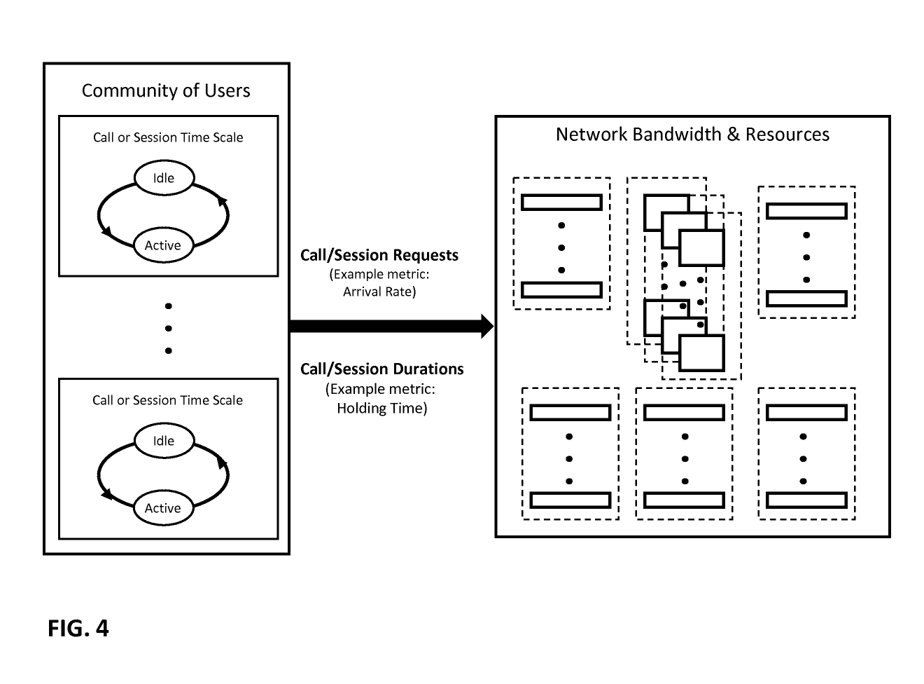

Further as to this, the dynamics of idle/activity cycles can be characterized in terms of rates (or frequencies) of state transitions between idle and activity states or can be characterized in terms of durations of time spent in idle and activity states. Examples of the former are “arrival rates” and “departure rates” while examples of the latter are “inter-arrival times” and “holding times.” These dynamics can be considered one-by-one for individual users, but it is typically more useful to consider the behavior of communities of users that share a common resource (such as network bandwidth). FIG. 4 depicts a user community representation of a call or session process for network bandwidth and associated resource allocation purposes. In most cases, the dynamics of call or session process for a even a relatively small community of users probabilistically behave, at least for intervals of time, as a comprising a Poisson arrival process (and more generally can be very accurately modeled as a modulated Poisson arrival process with time-varying arrival rate) together with exponentially-distributed holding times (or more general forms of a renewal process). These allow for Erlang (all but smallest community sizes) or Enset (smallest community sizes) processes to be used to accurately model blocking processes for shared resources, as will be useful later.

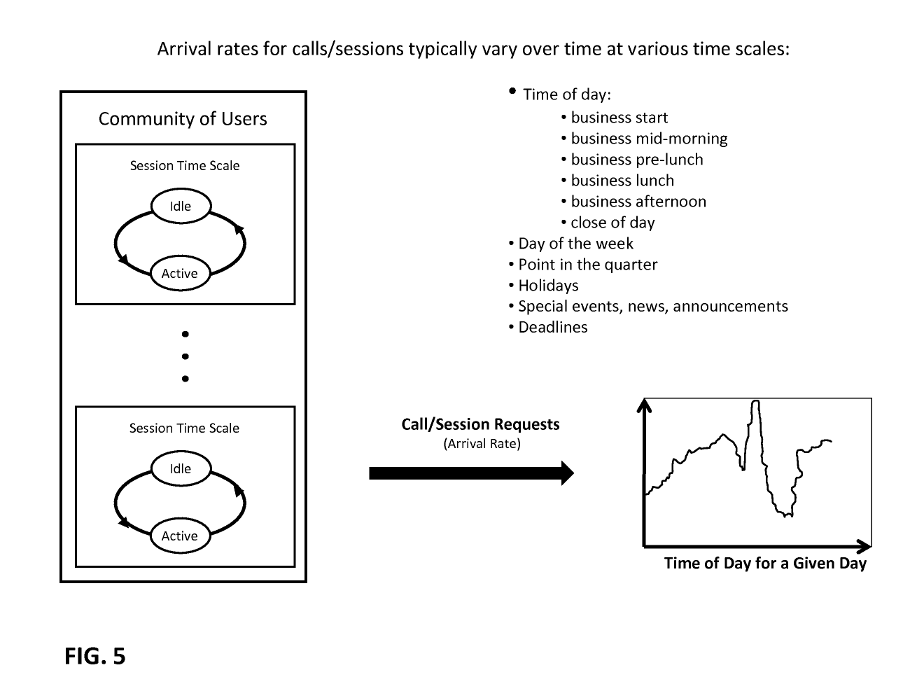

Further as to modulated Possion arrival processes, FIG. 5 depicts a version of the representation of FIG. 4 wherein arrival rates for calls/sessions are recognized as varying over time, these variations occurring at various time-scales and responsive to various events and factors, for example:
Time of day:
   business start of day;
   business mid-morning;
   business pre-lunch;
   business lunch;
   business afternoon;
   close of day;
Day of the week;
Point in the quarter;
Holidays;
Special events, news, announcements;
Deadlines.

In an enterprise network supporting a wide range of services, it is entirely likely that the statistics of calls/sessions and packets for each type of service will differ from one another. For example, VDI sessions will likely have longer holding times and have more bursty packet generation behavior than streaming video sessions or video conferencing calls. The enterprise network bandwidth is shared among then not only a community of users but also among a number of services (with differing call/session and packet statistics) that are employed by those users.

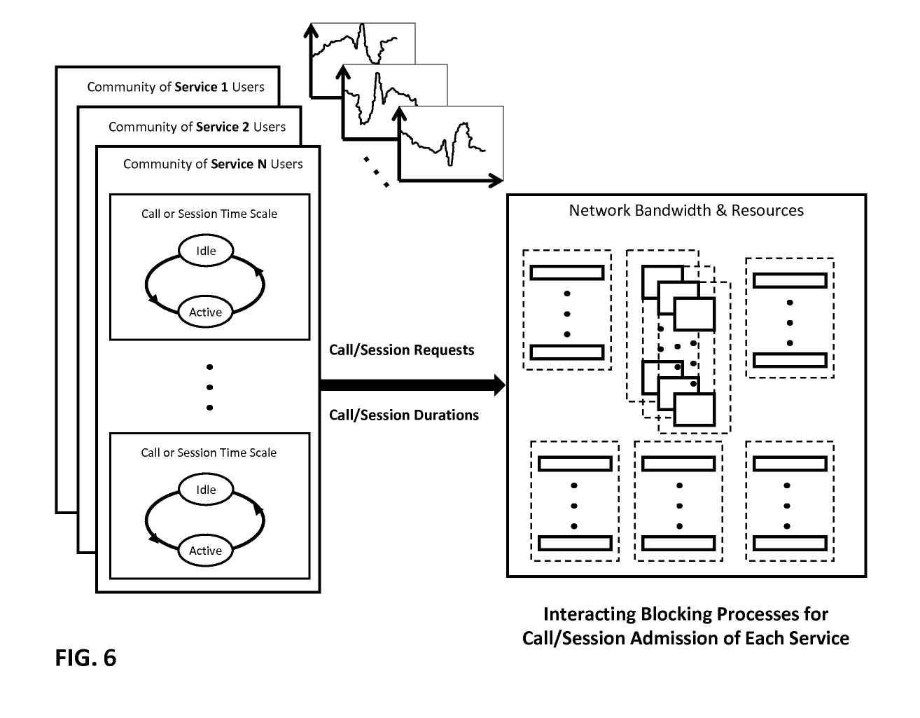

As to this, FIG. 6 depicts an exemplary adaptation of the session-oriented representation of the FIG. 4 comprising a plurality of differing types of services. In some situations all users employ all services, but in general each service can be thought of as having its own community. A first example user can use VoIP, video conferencing, and CDN services, while a example second user can use VoIP and VDI services—in such a situation the Community of VoIP service users in the enterprise includes both the first and second example users, the Community of video conferencing service users in the enterprise includes the first but not the second example users, the Community of VDI service users in the enterprise includes the second but not the first example users, etc. In many enterprises, each of these service communities can share the same network bandwidth (and perhaps other resources) and (at times when available network bandwidth becomes scarce) compete with each other for the last remaining instances of available network bandwidth.

The competition for available network bandwidth occurs most directly at the packet level. When the enterprise network becomes increasingly heavily loaded with packet traffic, network performance becomes increasingly poor. For services such as email, browsing, etc., that employ simple data transfers over the network, such degraded performance is typically not experienced as a problem or much of a problem. In real-time or near-real-time services, excessive values of delay-time, jitter, or packet loss can make the service session/call unusable.

### 2. Partition and Reservation Approaches to Session-Level Bandwidth Management

Because excessive delay-time, excessive jitter, or excessive packet loss can make a particular real-time or near-real-time service unusable, call or session reservation systems for a particular real-time or near-real-time service have appeared in the marketplace. In some ways this is a conceptual extension of the RSVP protocol which, where possible, makes a resource reservation for an IP packet stream subject to the outcome of an admission control (and policy control) decision module. In both RSVP and real-time network services reservations, an admission control function in some manner decides if the enterprise network facilities involved have sufficient bandwidth to support the IP packet stream.

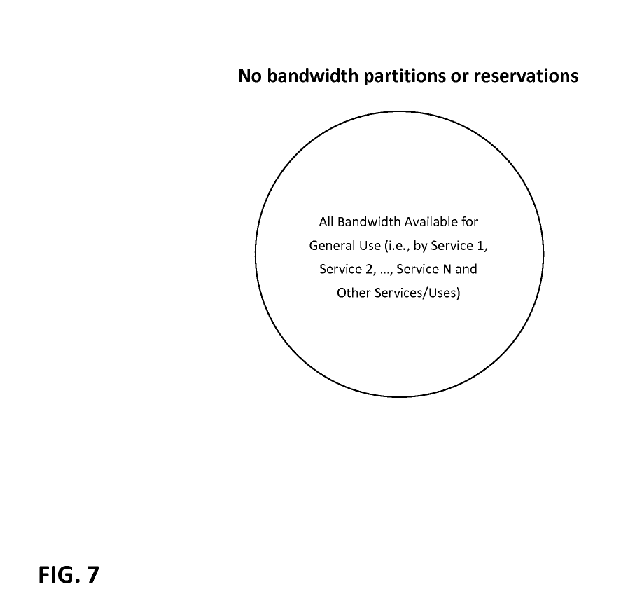

Although various metaphorical models can be brought forth for introducing the idea of bandwidth partitions and reservations, some brief mention will be made of a pie chart metaphor before directing attention to analytical geometry frameworks. In FIG. 7, the bandwidth of a network supporting N different types of services ({Service 1, Service 2, . . . , Service N}) that makes bandwidth available for general use (that is all bandwidth is available for use by any of the services) without any partition or reservation structure is represented as a full unstructured pie. It is noted that such laissez-faire arrangements can create situations where, under heavy network loads, there is too small a quantity of available bandwidth to support important real-time services (such as VoIP and video conferencing) or critical near-real-time services important to the enterprise. Such are the motivations for bandwidth partitions, improvements over partitions via fixed-reservation systems, and the further call/session-level adaptive-reservation systems taught in U.S. Pat. No. 7,738,492, U.S. patent application Ser. No. 12/828,145, and the yet further improvements over all of these taught by the present invention. These will be discussed and developed in turn after building a few introductory models and formalities, beginning with analytical models.

### 2.1 Analytical Models of Bandwidth Sharing Among Services

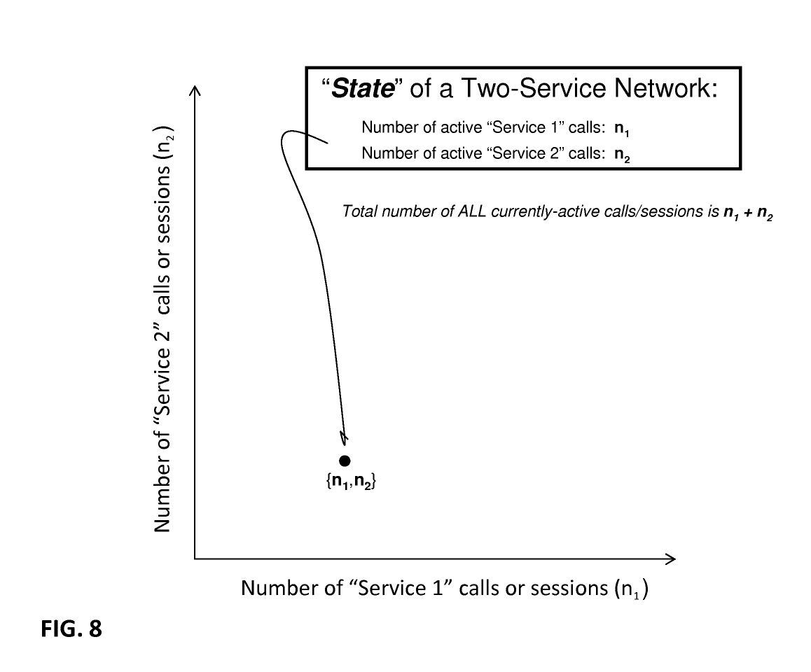

As an exemplary analytical model, FIG. 8 depicts an exemplary state space for a two-service bandwidth allocation model in a situation where bandwidth is shared among varying numbers of instances of two types of call- or session-oriented services. Although alternatives and variations are of course possible, in this example such a state space is actually a 2-dimensional vector space where the n₁ and n₂ components of the vectors {n₁,n₂} represent the number of active calls or sessions, and the values of the components of the vectors are non-negative. In a similar fashion, a three-service model where bandwidth is shared among varying numbers of instances of three types of call- or session-oriented services, the corresponding state space would be a 3-dimensional vector space where the components of the vectors represent the number of active calls or sessions, and the values of the components of the vectors {n₁, n₂, n₃} are non-negative. Accordingly, extending to N types of call- or session-oriented services, the corresponding state space would be an N-dimensional vector space where the components of the vectors represent the number of active calls or sessions, and the values of the components of the vectors {n₁, n₂, . . . , n_{N}} are non-negative:

nₖ≧0∀kε{1, 2, . . . N}

The total number of all currently active calls and/or sessions is then

$${\sum }_{k = 1}^{N} {n}_{k}$$

(which for the two-service case N=2 is n₁+n₂).

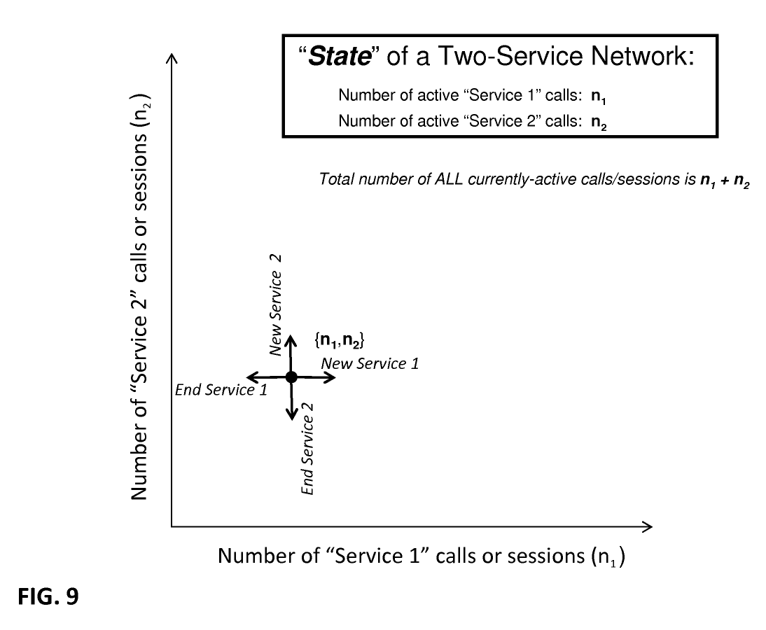

FIG. 9 depicts the effects on the state of admitting a new call or session and of the completion of an active call or session. With respect to the geometry of the state space as defined in FIG. 8, the “Service 1” axis is positioned horizontally, so admitting a new “Service 1” call or session causes the position of the current state to shift to the right, while ending an existing “Service 1” call or session causes the position of the current state to shift to the left. With respect to the geometry of the state space as defined in FIG. 8, the “Service 2” axis is positioned vertically, so admitting a new “Service 2” call or session causes the position of the current state to shift upwards, while ending an existing “Service 2” call or session causes the position of the current state to shift downwards.

Because the underlying media is packet-oriented, admission control systems that are not involved with or responsive to packet level processes treat each call/session a particular service type as if it occupies or consumes some sort of “bandwidth footprint,” (i.e. an “effective bandwidth” value, “average bandwidth” value, “peak bandwidth” value, etc.), that is an abstract block of bandwidth for each call/session of a particular service type. Terms such as “effective bandwidth”, “average bandwidth”, and “peak bandwidth” have taken on formal mathematical definitions over the years, some driven by mathematical or standards definition conveniences for particular types of network technologies (such as mid-generation envisionings of future public and private ATM networks). Thus in an effort to avoid confusion, avoid inheriting cumbersome definition implications, etc. the (hopefully as yet unused) term “bandwidth footprint” will be used as a stand-in and generalization of these concepts in the resource allocation discussions to follow.

Thus although from instant to instant each individual active service instance can vary in instantaneous bandwidth (as characterized by some analytical or empirical metric), if the k^{th} service has an “bandwidth footprint” of rₖ at a particular instant then the total bandwidth designated as actively in use is given by

$${\sum }_{k = 1}^{N} {r}_{k} {n}_{k} .$$

If a service, say Service m, is one with a Constant Bit Rate (CBR) network profile, the value of the “bandwidth footprint” of rₘ is well-defined and constant over the duration of a call or session. If a service is one with a Renegotiated Constant Bit Rate (RCBR) or Rate Adaptation network profile, the value of the “bandwidth footprint” of rₘ is also well-defined but piecewise-constant function of time with typically extremely few changes in value over the duration of a call or session. If a service is one with that adapts its information transmission rate to the available bandwidth (for example, as with TCP/IP traffic) and/or to variations in source material (for example, highly responsively to the presence or absence of talk spurts or motion-compensated video scene changes) the value of the “bandwidth footprint” takes on a statistical and/or stochastic character. Various ways of handling the value of the “bandwidth footprint” for the latter types of traffic will be considered later, but for now one can view the value of the “bandwidth footprint” of a given communications service as a constant, slowly-varying piecewise-constant function of time, or more rapidly varying piecewise-constant function of time.

As an example, summarizing for the two-service case represented by FIG. 8, note that:
The number of active “Service 1” calls or sessions is given by: n₁
The number of active “Service 2” calls or sessions is given by: n₂
The number of all active calls and/or sessions is given by: n₁+n₂
The bandwidth used by the n₁ active “Service 1” calls or sessions, each with bit-rate r₁, is given by: r₁n₁
The bandwidth used by the n₂ active “Service 2” calls or sessions, each with bit-rate r₂, is given by: r₂n₂
The bandwidth used for all active calls and/or sessions (both “Service 1” and “Service 2”) is given by: r₁n₁+r₂n₂.

In one or more embodiments, the network traffic will typically be routed through at least a moderately complex network arrangement comprising various network elements such as links, switches, routers, gateways, firewalls, transcoders, encrypters, etc., and each of these typically impose a bandwidth limitation. (It is noted that call/session-level management of non-link network elements such as switches, routers, gateways, firewalls, transcoders, encrypters, etc., in conjunction with bandwidth management is taught in U.S. patent application Ser. No. 12/828,145.)

In one or more embodiments, for any selected one of the various network elements, one could (by way of illustration) designate a maximum bandwidth capacity having a value of Rₘₐₓ. Then in order for the traffic being modeled to be carried by, through, across, etc. that selected network element, one must have in some sense a “maximum bandwidth constraint” such as

$${\sum }_{k = 1}^{N} {r}_{k} {n}_{k} \leq {R}_{max} .$$

The terms in this expression are well-defined for collections of services with a Constant Bit Rate (CBR), Renegotiated Constant Bit Rate (RCBR), or Rate Adaptation network profile. When including services that adapt information transmission rate to the available bandwidth and/or to variations in source material, the sense can be a statistical one, a sense involving maximum bounds, etc. More consideration will be applied to these cases later but for now one can view the values of the “bandwidth footprint” terms rₘ as being a constant, a slowly-varying piecewise-constant function of time, or a more rapidly varying piecewise-constant function of time.

In all of these cases, the maximum bandwidth constraint permits some state vector values, i.e., those such that

$${\sum }_{k = 1}^{N} {r}_{k} {n}_{k} \leq {R}_{max}$$

and forbids other state vector values, i.e., those such that

$${\sum }_{k = 1}^{N} {r}_{k} {n}_{k} > {R}_{max} .$$

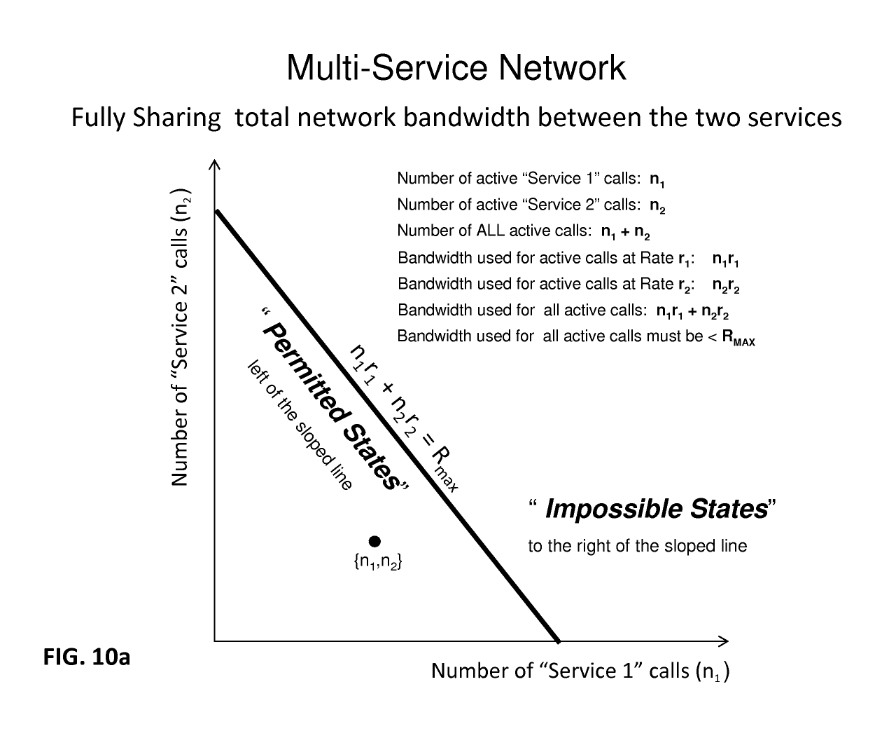

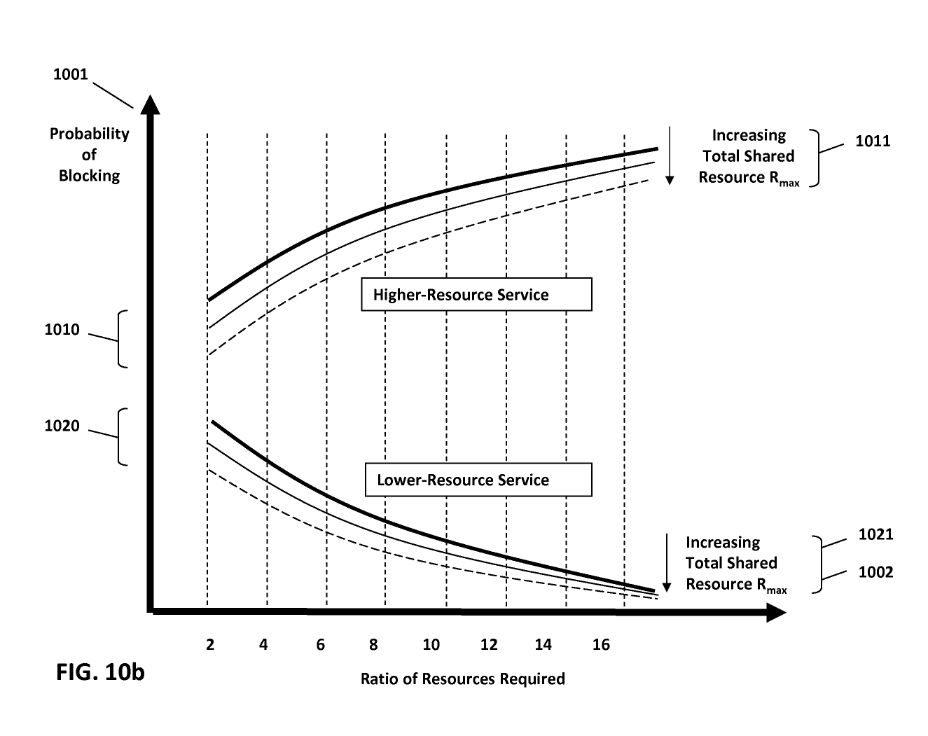

FIG. 10A depicts an exemplary region of permitted states, an example region of impossible (forbidden) states, and example boundary separating these regions for the example two-service state space model of FIG. 8 that is subjected to a maximum bandwidth constraint.

For each service, denoted “Service m” for some integer mε{1, 2, . . . N} carried by a network element (such as a link, switch, router, gateway, firewall, transcoder, encrypter, etc.) supporting N different types of services ({Service 1, Service 2, . . . , Service N}) and having bandwidth capacity Rₘₐₓ, the maximum number of calls or sessions occurs when no other service uses enough bandwidth capacity to prevent even a single “Service m” call or session. Such a condition would always be satisfied if there are no calls or sessions for any services other than “Service m” (that is

nₖ=0∀kε{1, 2, . . . m−1, m+1, . . . , N})

in which case the maximum number of “Service m” calls or sessions is given by

Floor[Rₘₐₓ/rₘ]

where “Floor” is the least-integer function. For example, if Rₘₐₓ=100 units of bandwidth and rₘ=12 units of bandwidth, then the maximum number of “Service m” calls or sessions that could be supported is Floor[100/12]=8. Note that, in this case, 8 simultaneously active “Service m” calls or sessions use 8*12=96 units of bandwidth, leaving 4 units of bandwidth left that could be used for calls or sessions of other services without interfering with the bandwidth requirements for the 8 simultaneously active “Service m” calls or sessions.

Should calls or sessions of other services interfering with the bandwidth requirements for the maximum number simultaneously active “Service m” calls or sessions, fewer simultaneously active “Service m” calls or sessions can be supported (as there is less available bandwidth for “Service m” calls or sessions to use). Accordingly, heavy network loading resulting from some services can therefore crowd out requests for even low numbers of calls or sessions.

There are various fairness shortcomings associated with such a full sharing model. First and more apparent among these is that such arrangements can create situations where, under heavy network loads there is too small a quantity of available bandwidth to support important real-time services (such as VoIP and video conferencing) or critical near-real-time services important to the enterprise.

Another more subtle issue buried in the stochastic behavior is that sharing bandwidth between services with differing bandwidth requirements is that services requiring higher bandwidth per call or session will experience a higher blocking probability than services requiring lower bandwidth per call or session. This general phenomenon is represented in FIG. 10B which illustrates some representative examples of cases involving the free unrestricted sharing of a bandwidth pool among two or more services having differing bandwidth requirements. Such free unrestricted sharing results in services requiring higher bandwidth per call/session will experience a higher blocking probability than services requiring lower bandwidth per call/session. Details will also depend on relative service request arrival rates for each type of service, and although there are notable curve variations as well as pathologies and exceptions, FIG. 10B (adapted from a graph developed by Lyndon Ong reported in [1] using the results of Kaufman [2]) illustrates examples of mixed bit-rate blocking behaviors and their general structure for non-extreme ranges of parameters. Families of blocking probability curves are shown for the “higher-resource service” 1010 and “lower-resource service” 1020. For each family of curves, the blocking probability 1001 decreases 1011, 1012 with increasing numbers of total shared resource, as is almost always the case in shared resource environments. However, the two families of curves 1010, 1020 spread with increasing divergence as the ratio 1002 of resource required increases, showing an increasingly unfair advantage afforded to the “lower-resource service.” In general, the behavior and quantitative dynamics of such arrangements are treated in references [2] (in the context of blocking systems) and [3] (in the context of ATM), among others.

One way to make allocations and denials fairer, and in general have more predictable operation, is to impose various types of limits on the maximum and/or minimum bandwidth allocations available to each service so as to limit the amount of shared bandwidth that can be monopolized by any one service. This can be done, for example, by restricting regions of the triangular region (or more generally, “simplical hypervolume”) of permitted shared bandwidth states. Ultimately any type of system imposing limitations on a shared pool of bandwidth interacts with imposed maximum and minimum bandwidth allocations (due to the algebra of shared resource equations), but two types of approaches to be considered first differ by what they start with:
Bandwidth partitions, considered in Section 2.2 to follow, result from imposing a maximum available bandwidth to each of one or more services in the multiple-service network, and
Bandwidth reservations, considered in Section 2.3 and throughout the remainder of this patent application, result from guaranteeing a minimum available bandwidth to each of one or more services in the multiple-service network. Both fixed-reservation and adaptive-reservation systems are defined with special attention in the present patent application to the development of various types of adaptive-reservation control system approaches.

### 2.2 Service-Exclusive Bandwidth Partitions

One way that commercial service-specific gatekeeper product offerings for services such as VoIP, H.323-video, SIP-video, Content Deliver Network (CDN) streaming, VDI, and other services in unified communications networks have sought to manage bandwidth is by setting a maximum number of calls or sessions for each service. This effectively compartmentalizes network element bandwidth into fully-isolated partitions.

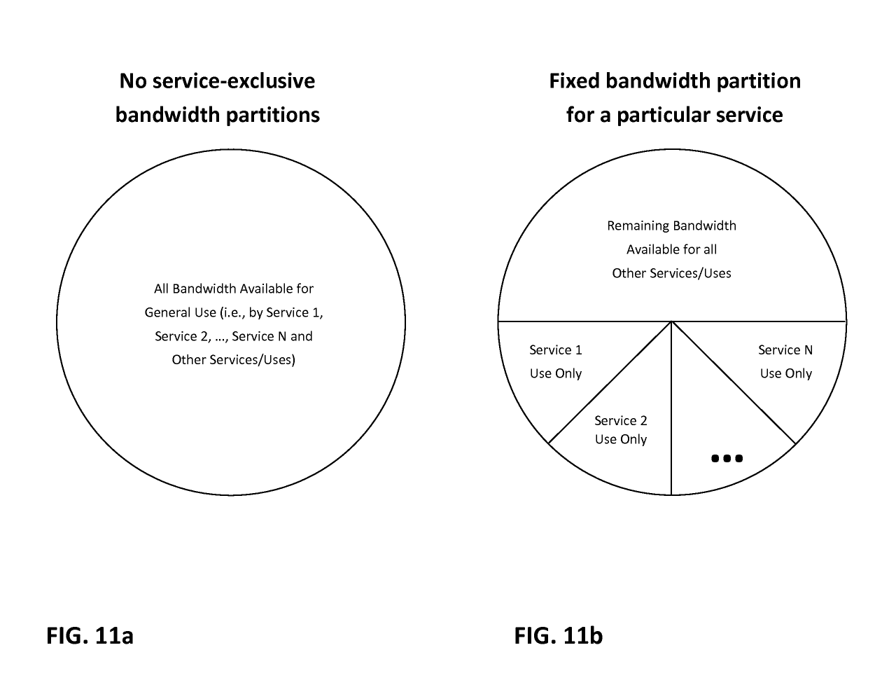

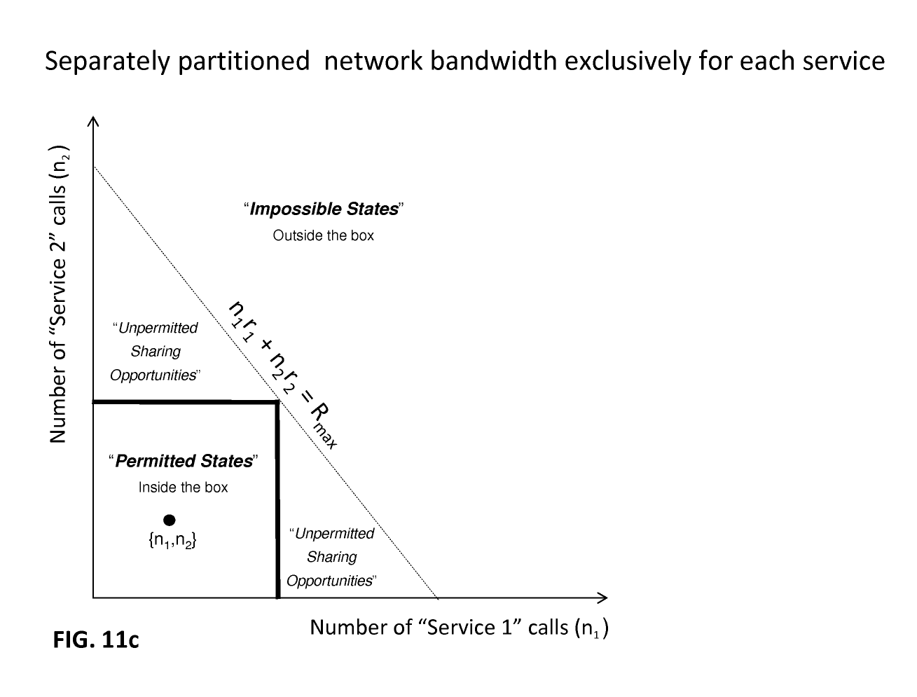

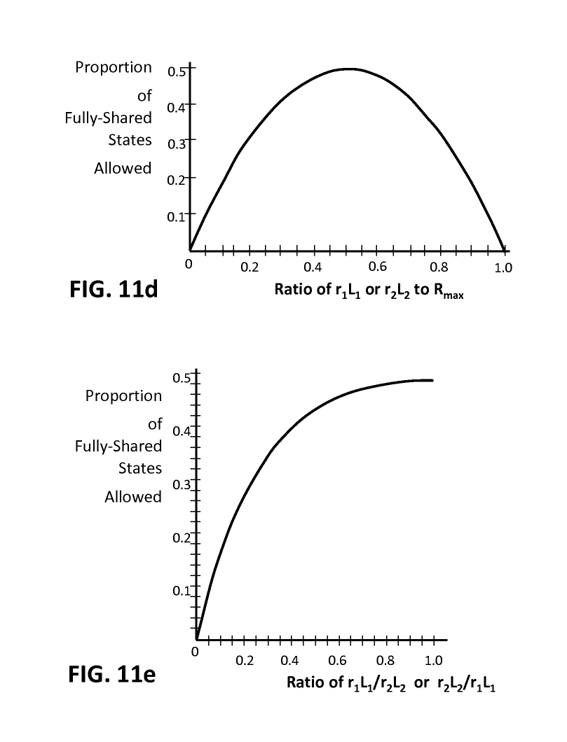

FIG. 11A reproduces FIG. 7 wherein the bandwidth of a network supporting N different types of services ({Service 1, Service 2, . . . , Service N}) that makes bandwidth available for general use (that is all bandwidth is available for use by any of the services) without any reservation structure is represented as a full undivided pie. As mentioned earlier, such arrangements can create situations where, under heavy network loads, there is too small a quantity of available bandwidth to support important real-time services (such as VoIP and video conferencing) or critical near-real-time services important to the enterprise.

FIG. 11B depicts an example “pie chart” representation of an example general bandwidth partition arrangement accommodating N different types of services ({Service 1, Service 2, . . . , Service N}) wherein each service is provided with effectively its own exclusive bandwidth pool. Each service is only allowed to use its partition of bandwidth. Gatekeepers for specific applications (for example, video teleconferencing, VoIP, streaming video, etc.) set maximum numbers of permitted simultaneous sessions.

Further as to this, FIG. 11C shows the permitted states for an example of such a situation in terms of the state space of FIG. 8, FIG. 9, and FIG. 10A. The exclusive bandwidth partition for each of the services force the permitted states to be confined only to the rectangular region depicted. The triangular regions whose extreme edges cause requests for a less-used service to be shut out due to usage of a far more popular service are removed from possibilities, but the removed areas are quite large and take with them many sharing opportunities among the services for non-extreme conditions.

The resulting situation typically can be extremely wasteful and lead to poor network and application performance. Statistically, quite often much bandwidth in each isolated partition actually goes unused, and if one service experiences crisis heavy loading, the large number of reserved bandwidth partitions can luxuriously go relatively unused. As a result overall resource utilization drops, inefficiency increases, and fairness decreases.

More specifically as to this, as shown in FIG. 11C, a significant amount of the triangular area (tetraheronal volume for three services, and for larger numbers of services “simplicially-shaped” hypervolume) of the region of the state space of viable resource sharing opportunities is not covered by the allowed rectangular area (in higher dimensions for larger numbers of services, “hyperrectangle or hypervolume”). To explore in further detail for the two services case with limits L₁ for service 1 and L₂ for Service 2 meeting the constraint that

L₁r₁+L₂r₂=Rₘₐₓ

the state space area of the allowed rectangular area is:

L₁r₁L₂r₂

Using the constrain and solving for either L₁r₁ or L₂r₂ results in an equation for the area of the form

X(Rₘₐₓ−X)

where X can be either L₁r₁ or L₂r₂. Taking the derivative with respect to X and setting this to zero to find the maximum results in the equation

Rₘₐₓ−2X=0

so the maximum area of the rectangle will occur when

L₁r₁=L₂r₂=Rₘₐₓ/2.

The area of the (viable) triangular region is not affected by the tradeoffs between values of L₁r₁ and L₂r₂ that satisfy the constraint and the constant area of the triangular area can be shown to be twice the maximum area of the rectangle. However, for values of L₁r₁ and L₂r₂ other than

L₁r₁=L₂r₂=Rₘₐₓ/2.

the area of the rectangle will be less than the maximum and in fact will approach zero for small values of L₁r₁ or L₂r₂ as well as for values of L₁r₁ or L₂r₂ approaching the maximum value Rₘₐₓ permitted by the constraint.

FIG. 11D shows the proportion of fully-shared states in the rectangle of allowed states as a function of the proportion of either L₁r₁ or L₂r₂ to Rₘₐₓ. This amounts to a plot of x(1−x) vs x. Note if the ratio of relative average demand for L₁r₁ with respect to L₂r₂ (or L₂r₂ with respect to L₁r₁) differs from 1 (is the case equivalent to L₁r₁=L₂r₂=Rₘₐₓ/2, denoted as 0.5 on the horizontal axis) the proportion of fully-shared states in the rectangle of allowed states drops and attains in the limit a value of zero.

FIG. 11E shows the proportion of fully-shared states in the rectangle of allowed states as a function of the ratio of either L₁r₁/L₂r₂ or L₂r₂/L₁r₁. Note that, although the proportion of allowed states remains ˜50% for average demand ratios falling as low as 0.6, the curve begins to rapidly fall—for example, when the ratio of relative average demand is 0.1 the proportion of allowed states drops to 17%.

Thus, for the two-service case, setting a limiting maximum number of calls or sessions for each type of service does not result in a very efficient, effective, robust, or fair use of shared bandwidth, and this can be exasperated when the various types of services sharing the bandwidth are not roughly of equal (traffic-loading) demand.

This analysis can be extended to larger numbers of services with the same basic outcome. For n different services sharing a total bandwidth pool of Rₘₐₓ but with limit {Lₖ} and bit-rate {rₖ} for service k, thus meeting the constraint that

ΣLₖrₖ=Rₘₐₓ

the state space hyper-area of the allowed hyper-rectangular region is:

$${\prod }_{i = 1 , n} {L}_{k} {r}_{k}$$

To simply notation, set xₖ=Lₖrₖ for kε{1,n}

To maximize of minimize the state space hyper-area of the allowed hyper-rectangular region, each of the n partial derivatives

$$\frac{δ}{δ {x}_{j}} {\prod }_{i = 1 , n} {x}_{k} , j ∈ \{ 1 , n \}$$

are set to zero. These n equations are of the form

$$( {\prod }_{{i = 1 , n}_{i \neq j}} {x}_{k} ) ( {R}_{max} - {\sum }_{{i = 1 , n}_{i \neq j}} {x}_{i} - 2 {x}_{j} ) = 0 , j ∈ \{ 1 , n \} .$$

The product term is associated with the minimums for the various xⱼ set to zero and can be discarded. By algebra or (far easier) symmetry arguments, it can be seen that the maximum is obtained for xⱼ=Rₘₐₓ/n. Thus, more generally for the n-service case, setting a limiting maximum number of calls or sessions for each type of service does not result in a very efficient, effective, robust, or fair use of shared bandwidth, and this can be exasperated when the various types of services sharing the bandwidth are not roughly of equal (traffic-loading) demand.

### 2.3 Fixed-Reservation Approaches

As a next-stage improvement, reservation systems have been introduced in various commercial network services and applications products. Such reservation systems and related approaches like them reserve a minimum amount of bandwidth for one or more specific services.

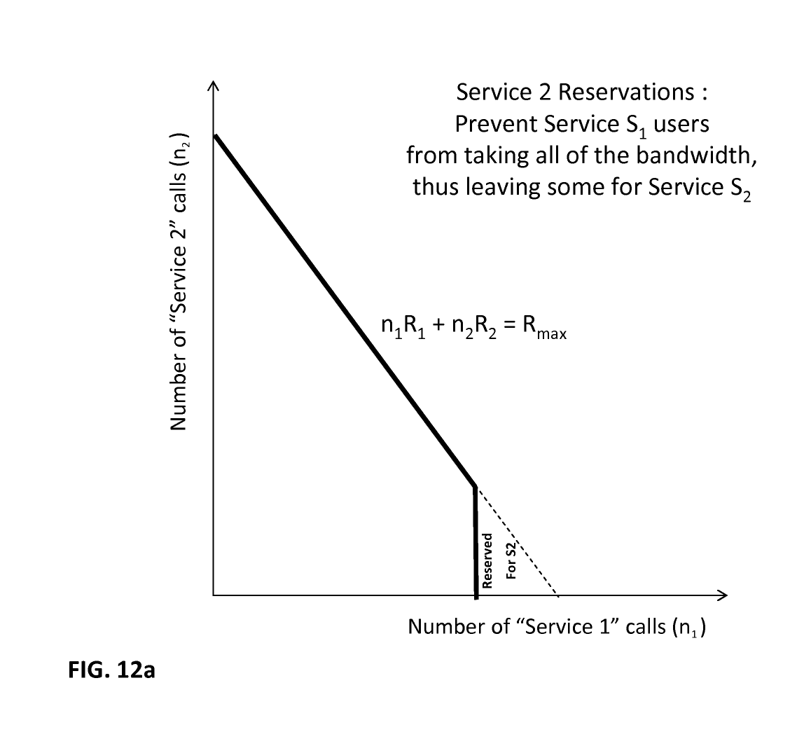

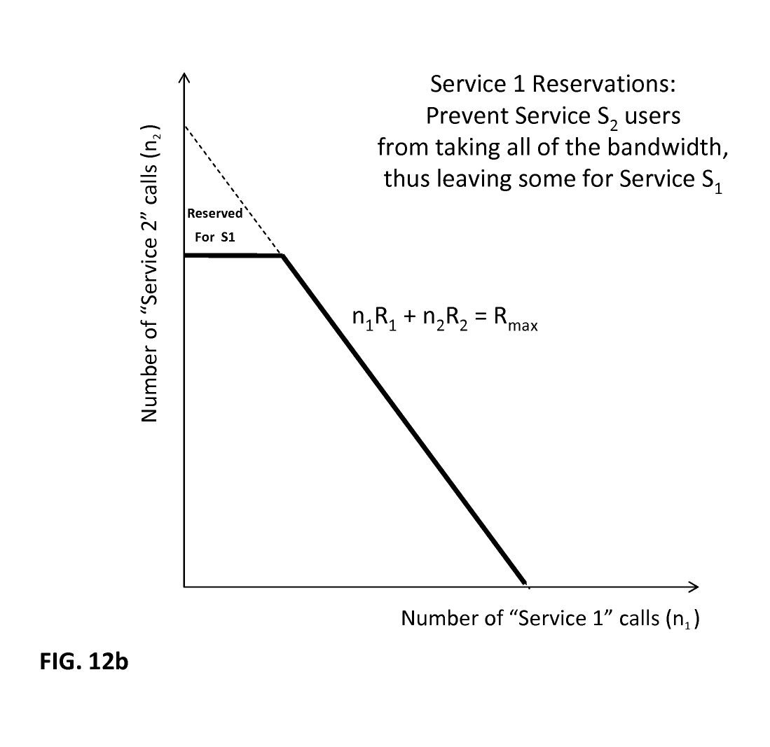

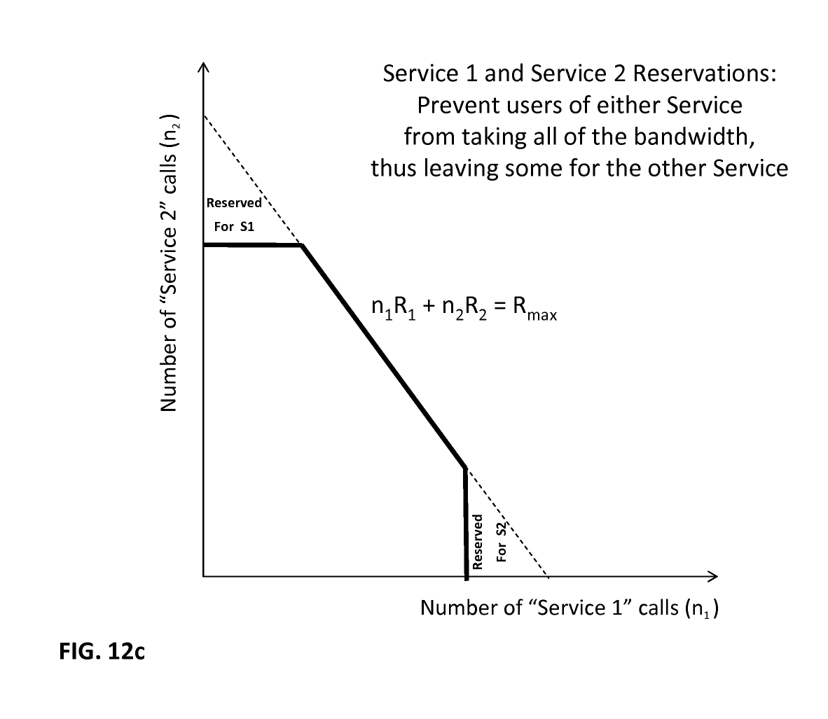

In order to reserve bandwidth for one of the two services (for example, Service 2) in a two-service network, a mechanism of some sort is used to prevent the other service (here then, accordingly, Service 1) from taking on its largest possible values in the region of permitted states imposed by the maximum bandwidth constraint. FIG. 12A depicts an example modification of the example region of permitted states identified in FIG. 10A wherein in this modification some bandwidth is reserved for the exclusive use of Service 2 by simply rejecting any new call or session requests for Service 1 once the number of active Service 1 calls or sessions exceeds a certain threshold. Since new Service 2 call or session requests still have access to the shared bandwidth those requests can continue to be granted. Under such an arrangement, only after at least one active Service 1 call or session completes can a new Service 1 call or session request be granted.

In more detail regarding the example described in conjunction with FIG. 12A, if the amount of bandwidth partitioned off as reserved for Service 2 is given by the quantity p₂, then the maximum number of “Service 2” calls or sessions is given by

Floor[Rₘₐₓ/r₂]

but the maximum number of “Service 1” calls or sessions is given by

Floor[(Rₘₐₓ−p₂)/r₁],

(where “Floor[x]” denotes the “least integer” function whose value is the integer portion of the real-valued variable x).

FIG. 12B depicts an example arrangement wherein reservations are provided for Service 1 rather than Service 2, and FIG. 12C depicts an example arrangement wherein reservations are provided for both Service 1 and Service 2.

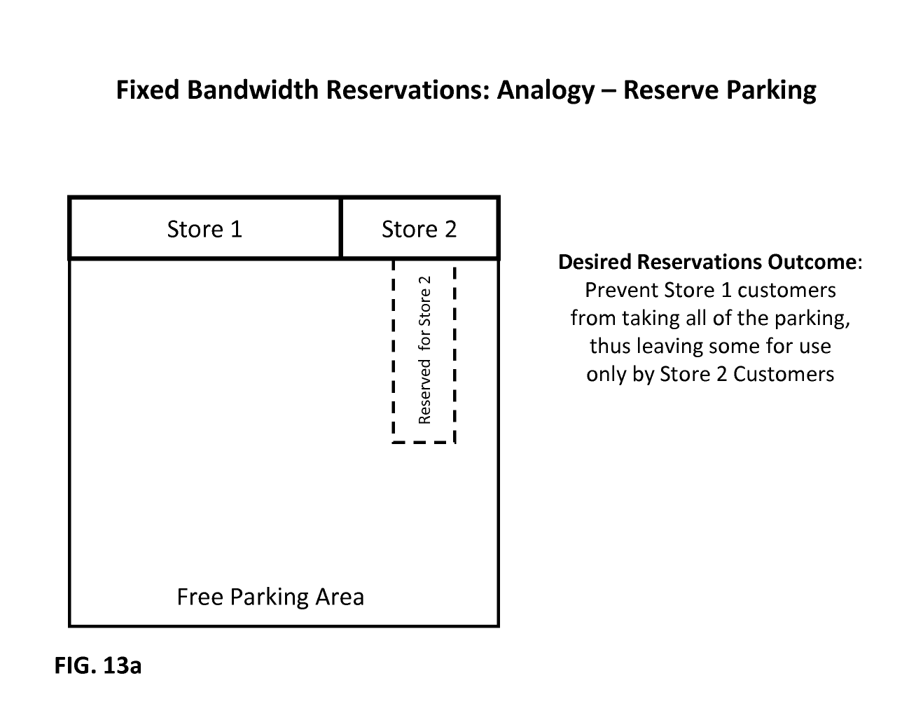

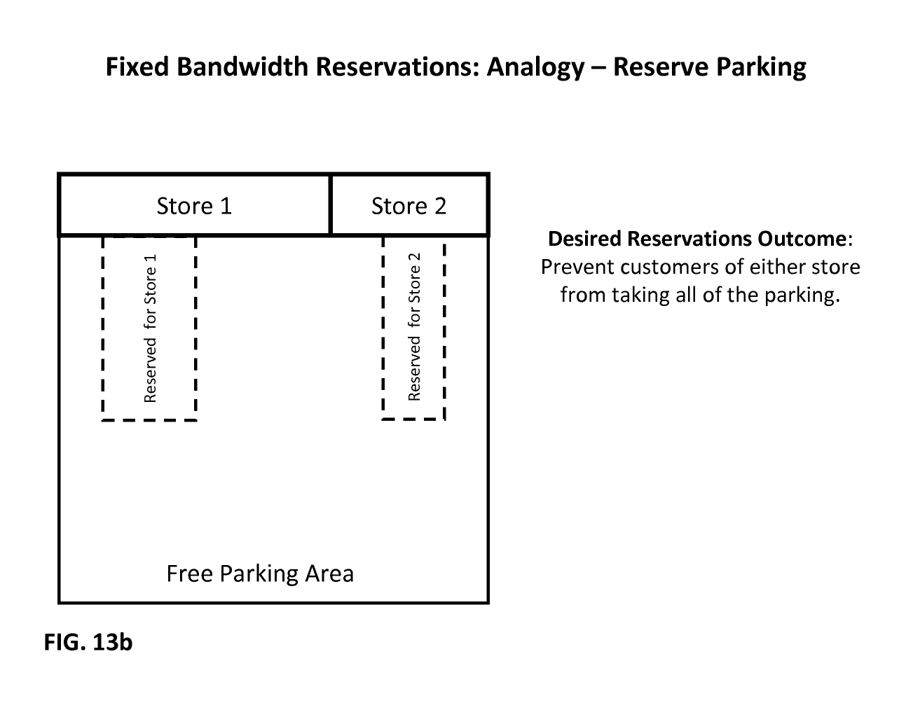

Earlier a “pie chart” metaphor was used as an analogy for reservation arrangements. FIG. 13A depicts a “reserved parking” analogy for the reserved bandwidth arrangement of the type represented by FIG. 12A. In this, two retail stores (in analogy to the two communications services) share a common parking lot (analogous to the network element bandwidth shared by the two services), but a portion of the parking lot is reserved for used only by customers of retail Store 2. This effectively permits customers of retail Store 2 to use up to the entire shared parking lot, while customers of retail Store 1 only can park in a reduced-size portion the shared parking lot.

If retail Store 2 (or analogously, Service 2) does not experience much traffic and retail Store 1 (or analogously, Service 1) on frequent occasions has enough traffic to fill the entire parking lot (or analogously, use all available bandwidth), such a reservation arrangement can be statistically fair to both stores (or analogously, both services). However, if both retail stores (or analogously, both services) on comparably frequent occasions can have enough traffic to fill the parking lot (or analogously, use all available bandwidth), then a fairer system would provide reservations for both retail stores (or analogously, both services) as depicted in FIG. 13B. Note that FIG. 13B depicts a “reserved parking” analogy for a dual reserved bandwidth arrangement of the type represented by FIG. 12C.) In more detail, if:
the bandwidth partitioned off as reserved for Service 1 is given by p₁,
the bandwidth partitioned off as reserved for Service 2 is given by p₂, then the maximum number of “Service 1” calls or sessions is given by

Floor[(Rₘₐₓ−p₂)/r₁].

and the maximum number of “Service 2” calls or sessions is given by

Floor[(Rₘₐₓ−p₁)/r₂].

Such an arrangement can provide an expanded range of fairness under many situations, but as will be seen this approach does not scale well as more and more services each partition off their own reserved resources from the otherwise shared resource pool. Overall, fixed bandwidth reservations (partitioning separate portions of the total bandwidth to provide guaranteed minimum bandwidth for at least one service) can provide increased fairness in the allocation of bandwidth among communications services, but does this at the expense of efficiency.

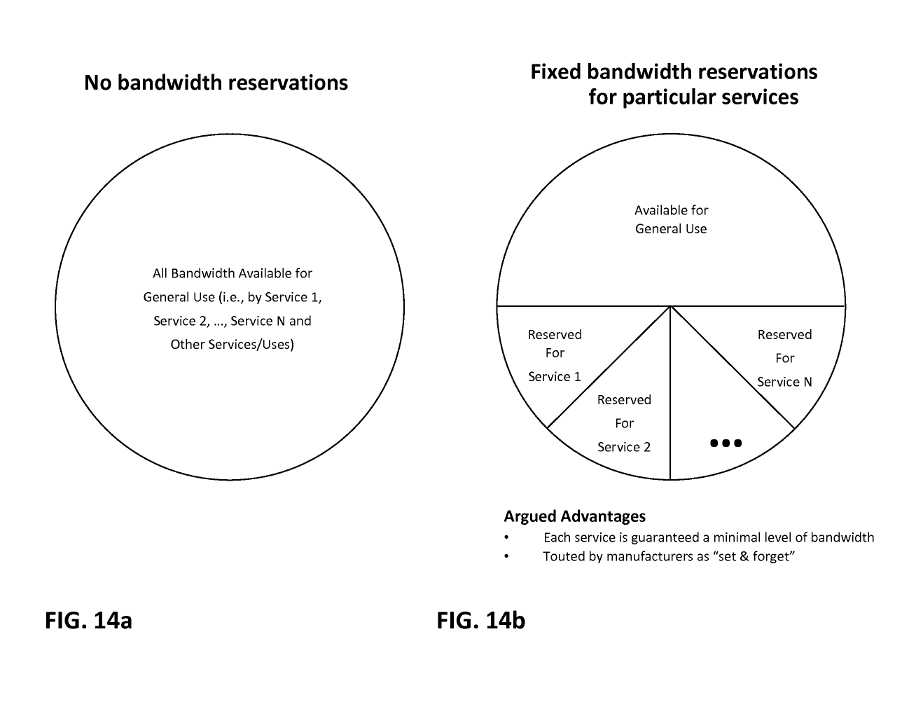

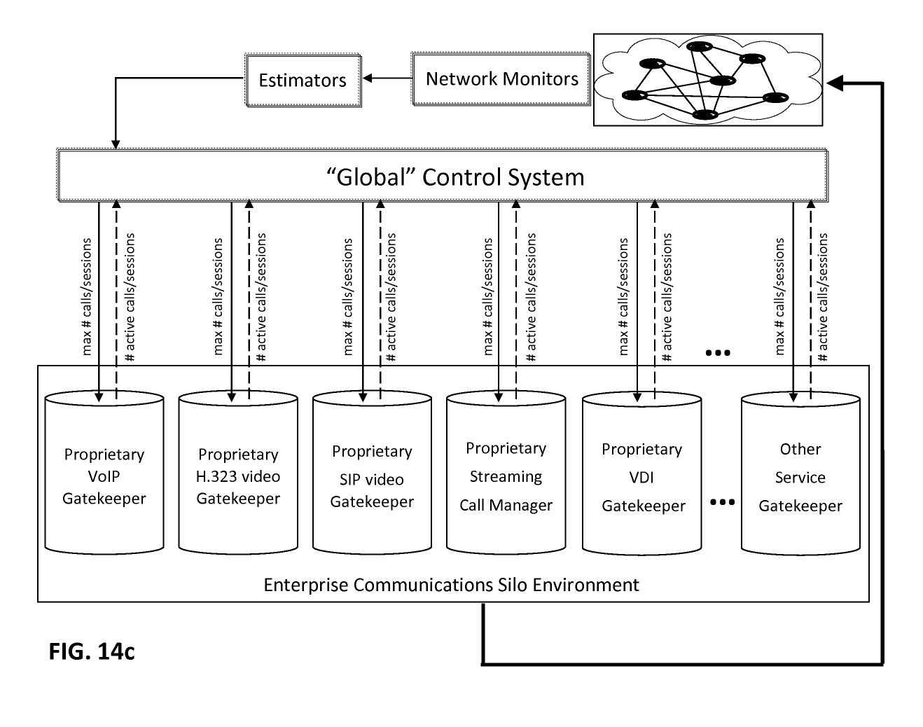

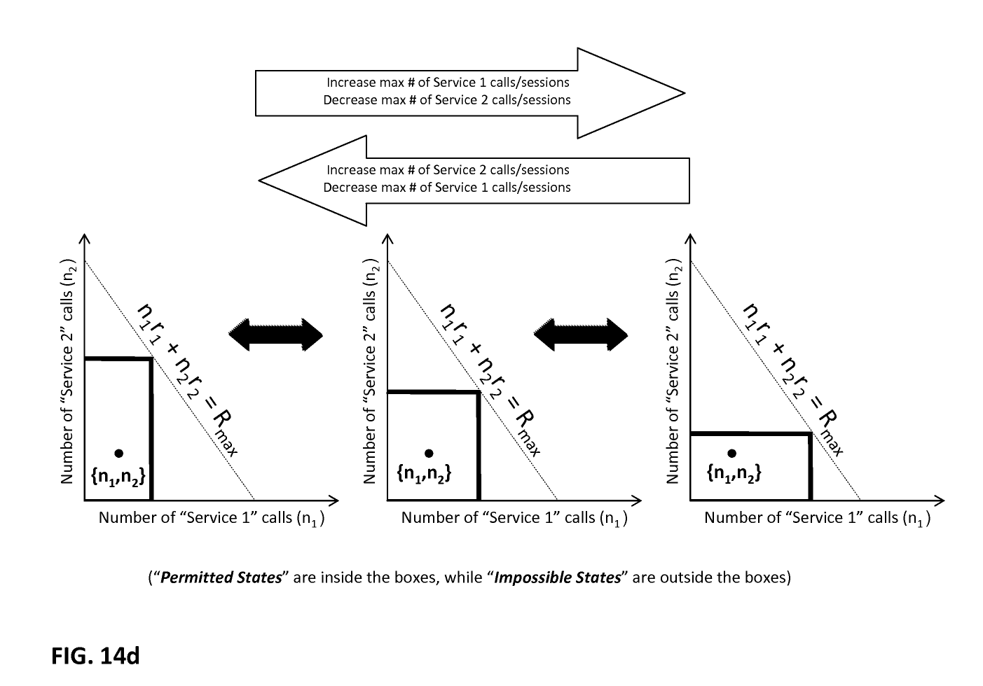

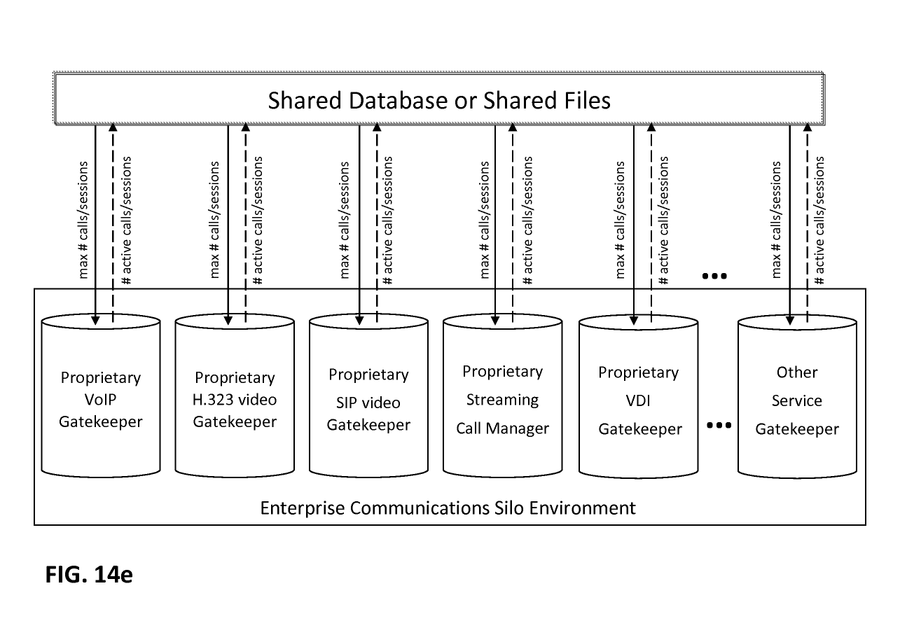

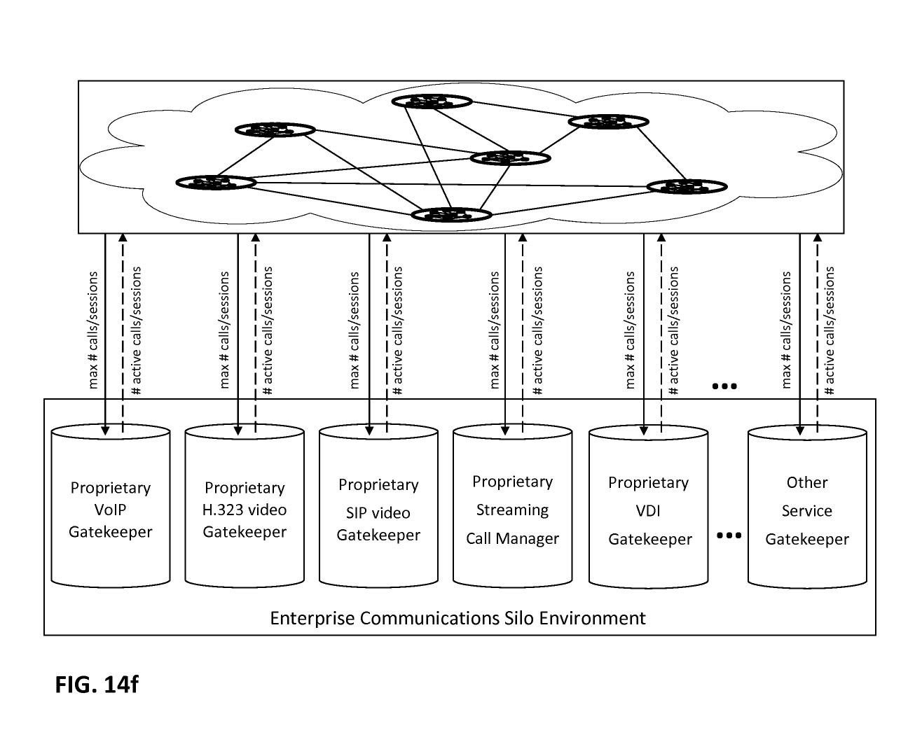

For ease of comparison, FIG. 14A again reproduces FIG. 7 wherein the bandwidth of a network supporting N different types of services ({Service 1, Service 2, . . . , Service N}) that makes bandwidth available for general use (that is all bandwidth is available for use by any of the services) without any reservation structure is represented as a full unstructured pie. FIG. 14B depicts an example “pie chart” representation of an example general bandwidth reservation arrangement accommodating N different types of services ({Service 1, Service 2, . . . , Service N}) sharing a common bandwidth pool. Each service is free to use the portion remaining available for general use, but as network bandwidth starts to become scarce, a certain amount of reserved bandwidth is held back for exclusive use by each service that is provided with reservations. Thus for example, if enterprise network activity loads up the network to near its capacity, a minimum amount can be held back for specific services. For example, should a business event cause network loading due to heavy VDI, database, and streaming video usage, a minimum amount of bandwidth is held back for use by VoIP services.

Such reservation functions can be implemented in various ways, both direct and indirect. As part of this, additionally or alternatively, gatekeepers for specific applications (for example, video teleconferencing, VoIP, streaming video, etc.) can also set maximum numbers of permitted simultaneous sessions.

FIG. 14C depicts an example implementation of a reservation system for a multiservice network wherein a “global” control system provides updates to the each of the gateways as to the maximum number of calls/sessions each service is to permit. In various implementation approaches, the “global” control system can be provided with the number of active calls/session from information by the gatekeepers, a network monitoring system (for example, inspecting packet headers) fitted with one or more call/session counter/estimator(s), or a combination of these.

FIG. 14D depicts an example of how such a “global” control system can manipulate the maximum number of calls/sessions each service is to permit so as to create a reservation system. This manipulation can be accomplished, for example, by event-driven or time-driven update messages sent from the “global” control system to each of the gatekeepers (or in another implementation, individual instances of endpoint applications). These manipulations over time can be used to prevent any one service from unfairly consuming an undue portion of the bandwidth shared by the services involved. Further, with information as to the number of currently active calls/sessions of each service type, the “global” control system can be configured to only adjust a given maximum number of calls/sessions downward to a level that is not less than the current number of actively calls/sessions for that service. By utilizing various control policies, the “global” control system can implement a multiple-service fixed reservations arrangement or an adaptive one as to be discussed later.

Alternatively, the reservation system can be implemented in a wide variety of other ways, including for example, implementations without a centralized controller. For example, information (relating to setting a current maximum permitted number of calls/sessions for each service, relating to the number of currently active calls/sessions, etc.) can be exchanged among communications silos through use of a shared database or shared files as represented in FIG. 14E. As another example, information setting the maximum number of currently permitted calls/sessions for each service and the number of currently active calls/sessions can be exchanged among communications silos through direct peer-to-peer communications among the communications silos (as represented in FIG. 14F. Other implementation arrangements are also possible, anticipated, and are accordingly provided for by the invention.

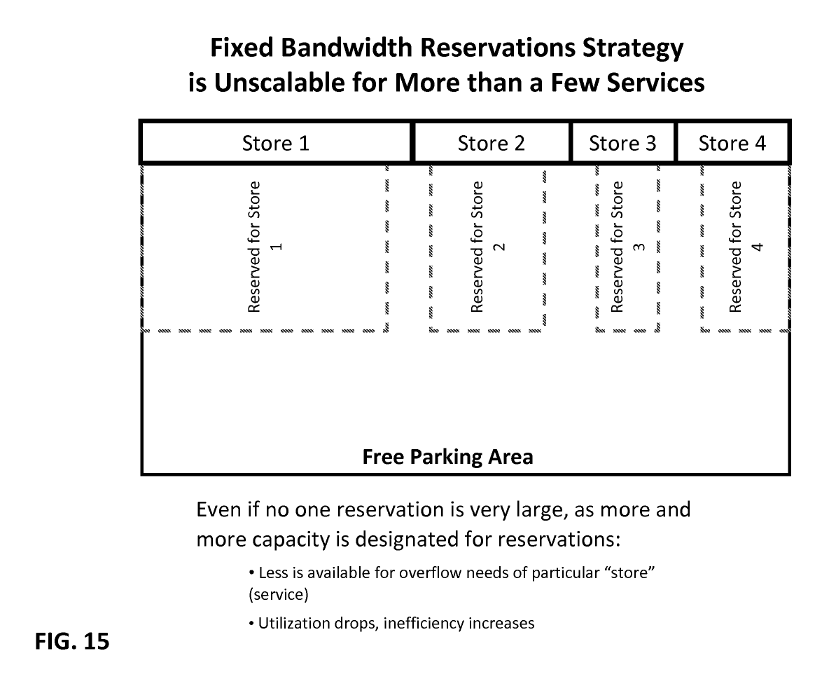

Regarding larger numbers of services each partitioning off their own reserved resources, FIG. 15 depicts a “reserved parking” analogy for the reserved bandwidth arrangement of the type represented by FIG. 14B. In this case, four retail stores share the parking lot and each have their own partitioned-off reserved portions of the shared parking lot. Analytically, if the quantity of resource partitioned off as reserved for “Service m” is given by pₘ, then:
maximum number of Service 1 calls or sessions is Floor[(Rₘₐₓ−p₂−p₃−p₄)/r₁],
maximum number of Service 2 calls or sessions is Floor[(Rₘₐₓ−p₁−p₃−p₄)/r₂],
maximum number of Service 3 calls or sessions is Floor[(Rₘₐₓ−p₁−p₂−p₄)/r₃],
maximum number of Service 4 calls or sessions is Floor[(Rₘₐₓ−p₁−p₂−p₃)/r₄].
   As can be seen, each service actually has access to less and less of the available bandwidth.

Even if no one reservation is very large, as more and more shared resource capacity is designated for reservations, less and less is available for overflow needs of particular store/service). Statistically, quite often the reserved resources (which ironically were originally designated to improve fairness in cases of extreme loading by other competing services) actually go unused. Thus if one service experiences crisis heavy loading, the large number of reserved bandwidth partitions can luxuriously go relatively unused. As a result overall resource utilization drops, inefficiency increases, and fairness actually decreases. Thus this myopic “separate reservation” approach does not scale as more and more services individually partition off their own reserved resources from the shared resource pool.

### 2.4 Need for Adaptive-Reservation Approaches

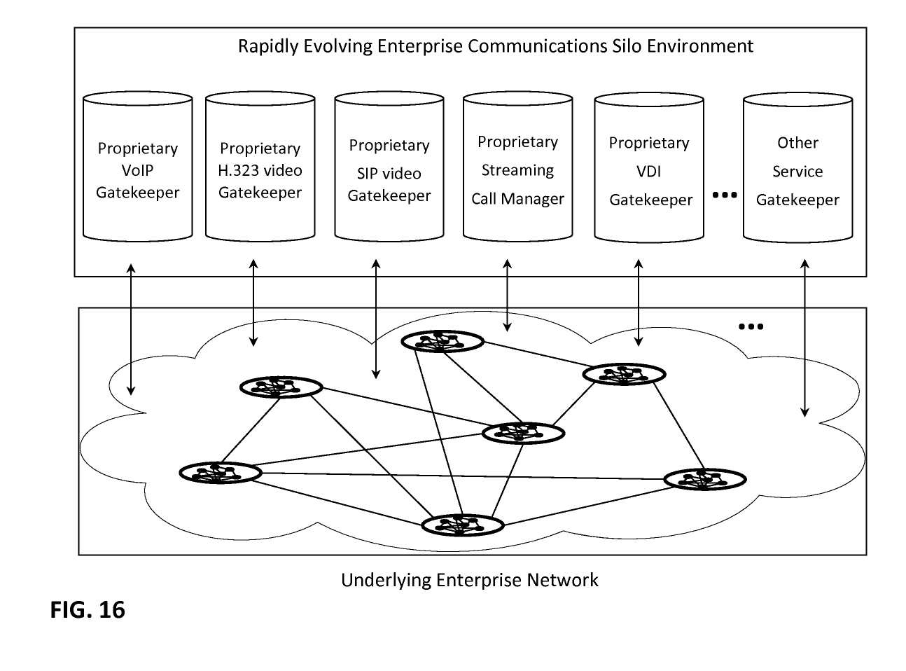

As indicated in the opening remarks in the present patent application, very real problems lie ahead as increasing numbers of unified communications services such as VoIP, H.323 video, SIP video, Content Delivery Network (CDN) streaming, Virtual Desktop Infrastructure (VDI), and other real-time or near-real-time services each provide their own reservation system gatekeepers, a situation depicted in FIG. 16. As to this, the present invention (along with the related technology of U.S. Pat. No. 7,738,492 and U.S. patent application Ser. No. 12/828,145), addresses the many network management problems described in this section by providing closed-loop automatic control arranged for adjusting some or all reserved resource partition values

pₖ∀kε{1, 2, . . . , N}.

for call/session based bandwidth management. The invention further provides closed-loop automatic control bandwidth management for QoS aspects of packet networks, and additionally provides closed-loop automatic control bandwidth management spanning and linking QoS aspects of packet networks and call/session based bandwidth management. Prior to developing these, however, attention is first directed to the topics of packet-level process and Quality of Service (QoS) approaches for packet-level bandwidth management.

### 3. Network Quality of Service (QoS) Approaches for Packet-Level Bandwidth Management

As mentioned earlier, the competition for available network bandwidth occurs most directly at the packet level. When the enterprise network becomes increasingly heavily loaded with packet traffic, network performance becomes increasingly poor. For services such as email, browsing, etc., that employ simple data transfers over the network, such degraded performance is typically not experienced as a problem or much of a problem. Again as mentioned earlier, excessive delay-time, excessive jitter, or excessive packet loss can make real-time or near-real-time services unusable.

For this reason, so-called “Quality-of-Service” (“QoS”) features are beginning to be supported in increasing numbers of network switch and router products. Such features, for example, can affect how queues within a network switch are serviced, and more generally include QoS utilities such as:
Diffserve;
RSVP;
Traffic smoothing and flow shaping;
Queue service disciplines, approximations, and implementations.

Example QoS parameters affecting these include delay bounds, jitter bounds, packet loss rate bounds, and priority definitions as well as
traffic priority;
maximum sustained traffic rate;
maximum traffic burst;
minimum reserved traffic rate;
minimum tolerable traffic rate;
flow synchronization (for the of synchronization among related flows);
flow performance (various user flow performance requirements);
level of service (degree of required response, for example deterministic, predictive, “best effort,” etc.).

Existing and ongoing work on network QoS standards, models, architectures, mechanisms, and analysis is both extensive and diverse, and the listed examples above are intended to be only illustrative and representative, not comprehensive or exhaustive. In its full glory, the goals of network QoS would be realized through cooperative arrangements, interfaces, and architectures that span across enterprise applications, endpoint devices, operating systems, servers, network switches, routers, firewalls, and additionally correspondingly similar elements within wide area network (WAN) infrastructure. For example, Microsoft computer operating systems and networking software includes some basic QoS features as do router and switch products from network product manufactures such as Cisco and Juniper. However, although it is often posed that QoS features are essential indigenous in contemporary internet and enterprise networks, in actuality the QoS feature availability in product offerings is currently (and for the projected future) quite limited when compared to envisioned possibilities.

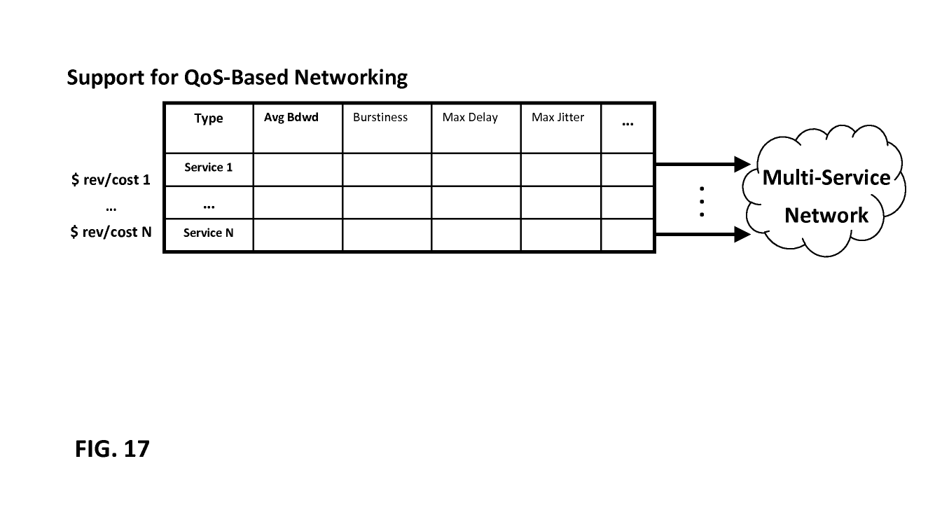

FIG. 17 depicts an example general high-level representation of some packet traffic attributes relevant to QoS-based networking support for a plurality of differing types of services. The table is meant to convey the likely differing QoS parameter values among differing services that are carried by the enterprise network.

4. Environment on which to Impose Closed-Loop Control

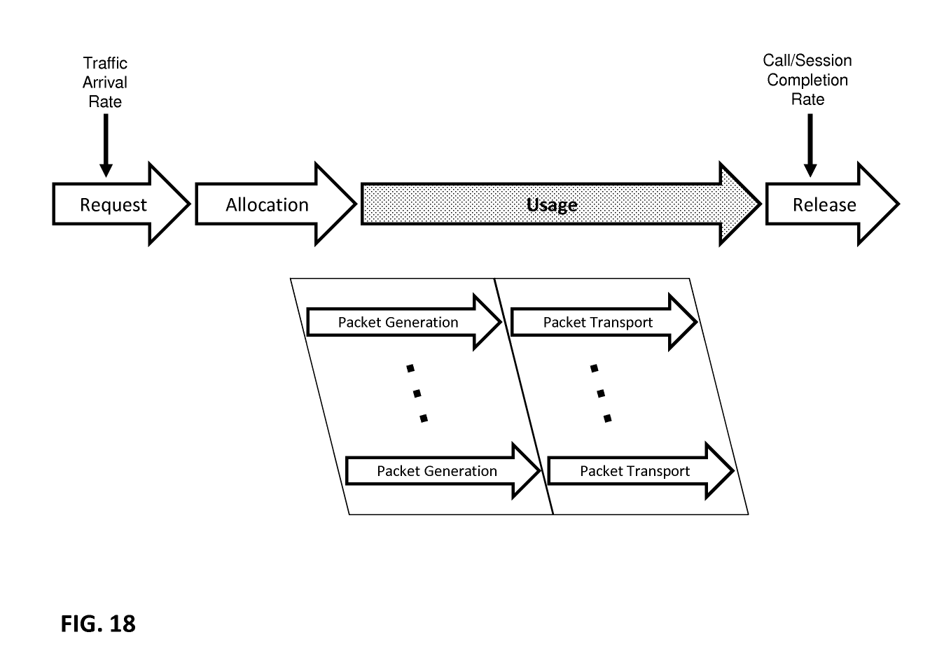

FIG. 18 depicts a session framework within a general IP network environment on which to impose closed-loop control. The activity of the population of users at any given moment determine the traffic arrival rates (rate at which requests for calls/sessions occur) and call/session completion rate. An incoming request is considered according to a session admission system and is either accepted or rejected. If accepted, the session is allocated to the network. If there is a communications silo associated with the session, that communications silo is aware of new the session (and keeps the status of this and other active session allocations in memory for use in considering the next incoming session request). Once allocated the session starts and usage begins. Usage starts with packet generation; the generated packets are then transported through the network (where they are eventually received at the destination network endpoint). At the end of the session, the resources are released (and the communications silo is notified so that the released resources can be used in considering the next incoming session request.

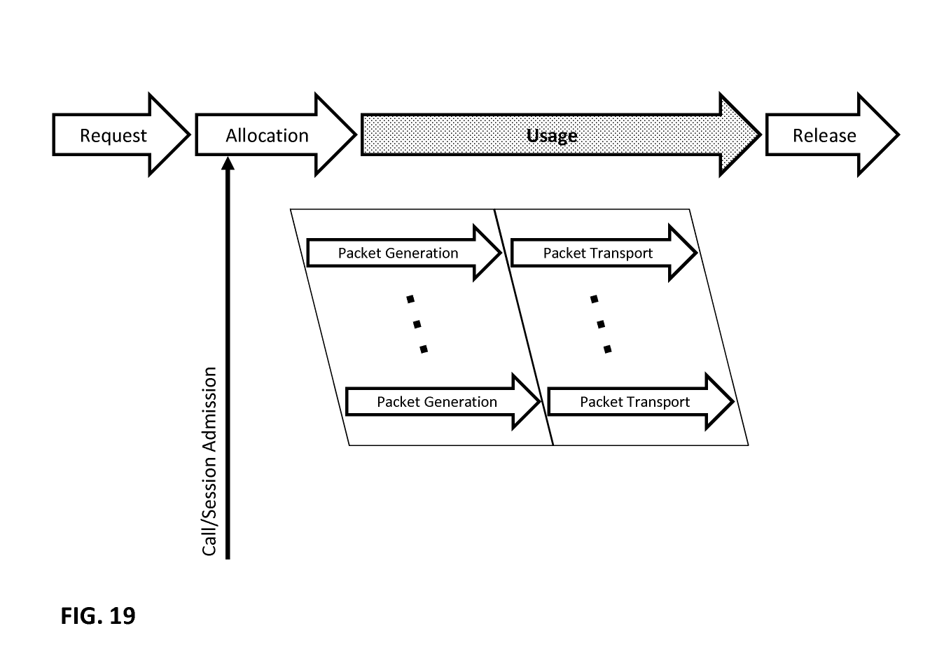

FIG. 19 depicts an adaptation of the framework depicted in FIG. 18 to at least the primitive control of session-admission. Here an adjustable control parameter is shown which can be used to affect the decision of the call/session-admission and call/session-allocation process(es). This level of control was considered and developed in the related technology of U.S. Pat. No. 7,738,492 and U.S. patent application Ser. No. 12/828,145.

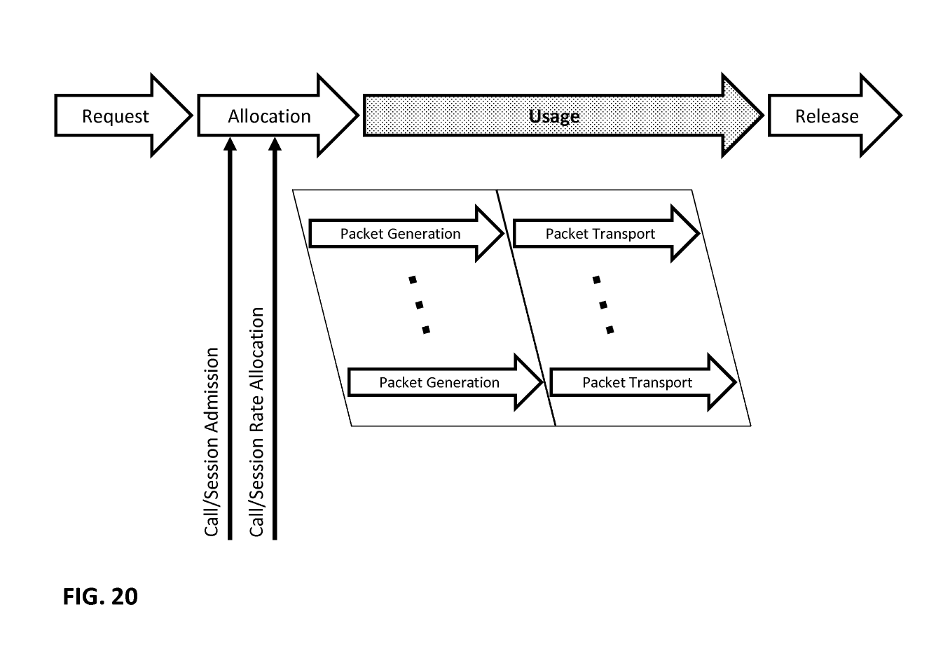

FIG. 20 depicts an example of a yet richer session-level control framework wherein a call/session transmission rate allocation control capability has been added. Such a capability allows control over the transmission rate of the call or session (for example, setting the information transfer rate for encoders and decoders of audio and video, etc. for at least the beginning (if not the full duration) of the call or session. Use of such a call/session transmission rate allocation control capability by a closed-loop automatic control system to provide improved bandwidth management capabilities and network performance is one of several innovative steps provided by the present invention.

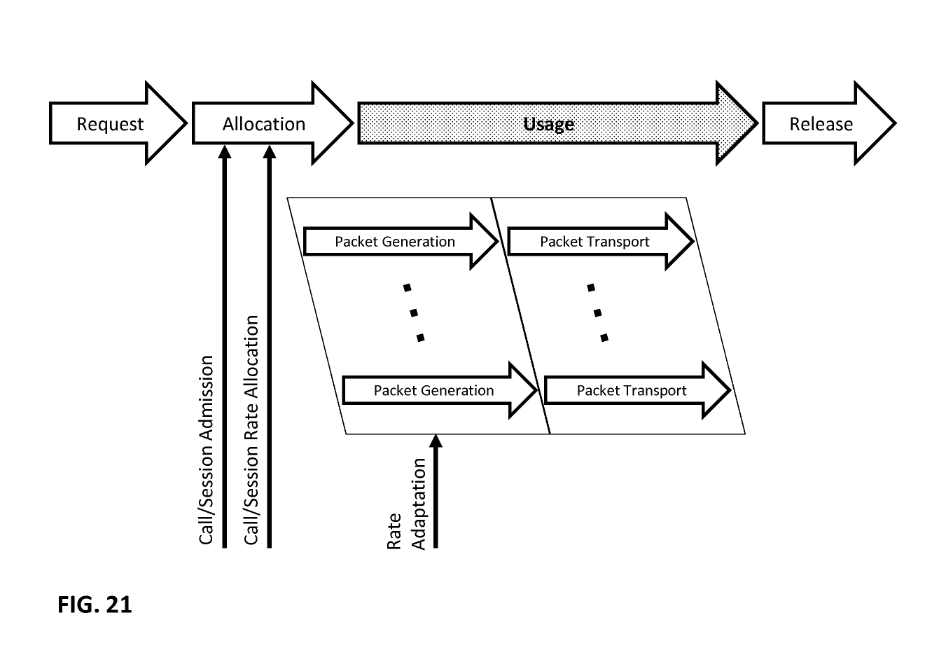

FIG. 21 depicts an exemplary enhancement of the session-level control framework depicted in FIG. 20 wherein rate-adaptation control capability has been added, allowing the transmission rate to be varied during an active call or session after that call or session begins using the call/session transmission rate control capability described in conjunction with FIG. 20. Use of such a rate-adaptation control capability by a closed-loop automatic control system to provide improved bandwidth management capabilities and network performance is another of several innovative steps provided by the present invention.

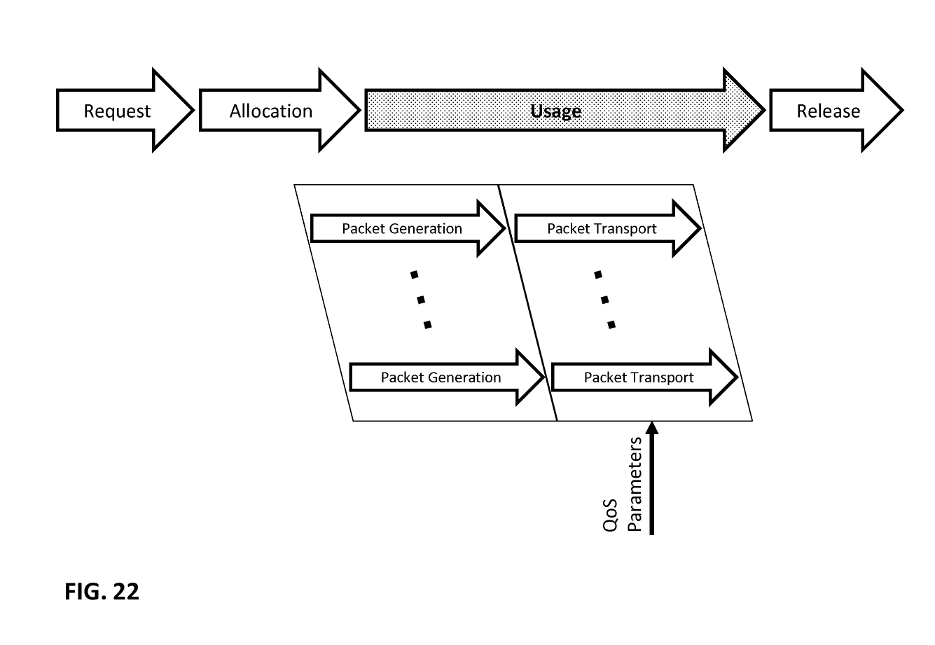

FIG. 22 depicts an example primitive packet-level QoS control framework for QoS capabilities of network elements. Use of such a network element packet-level QoS control framework control capability by a closed-loop automatic control system to provide improved bandwidth management capabilities and network performance is yet another of several innovative steps provided by the present invention.

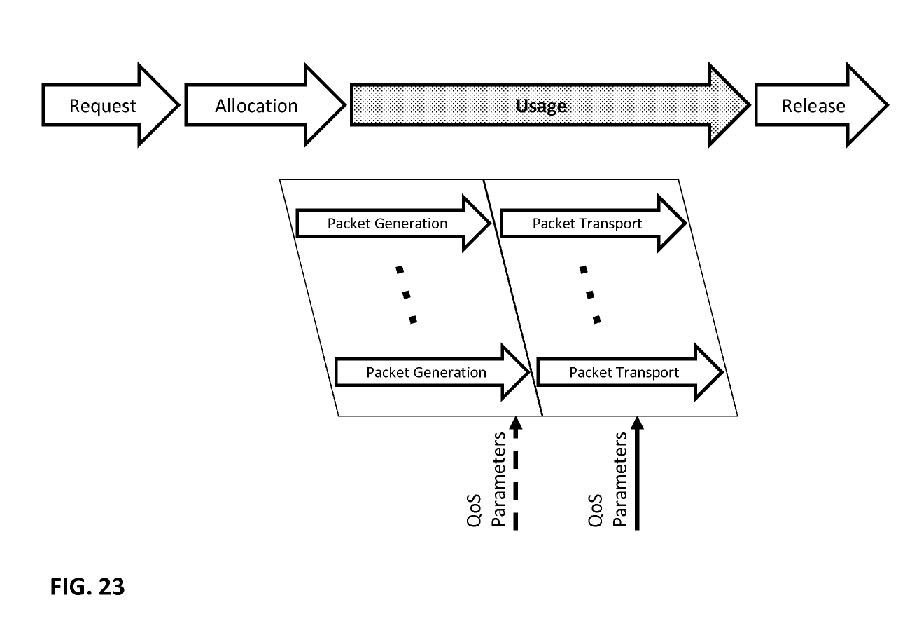

FIG. 23 depicts an example of a richer packet-level QoS control framework wherein control of QoS capabilities of packet generation processes within applications is added. Adding such a packet generation processes QoS control framework control capability to a closed-loop automatic control system to provide improved bandwidth management capabilities and network performance is still yet another of several innovative steps provided by the present invention.

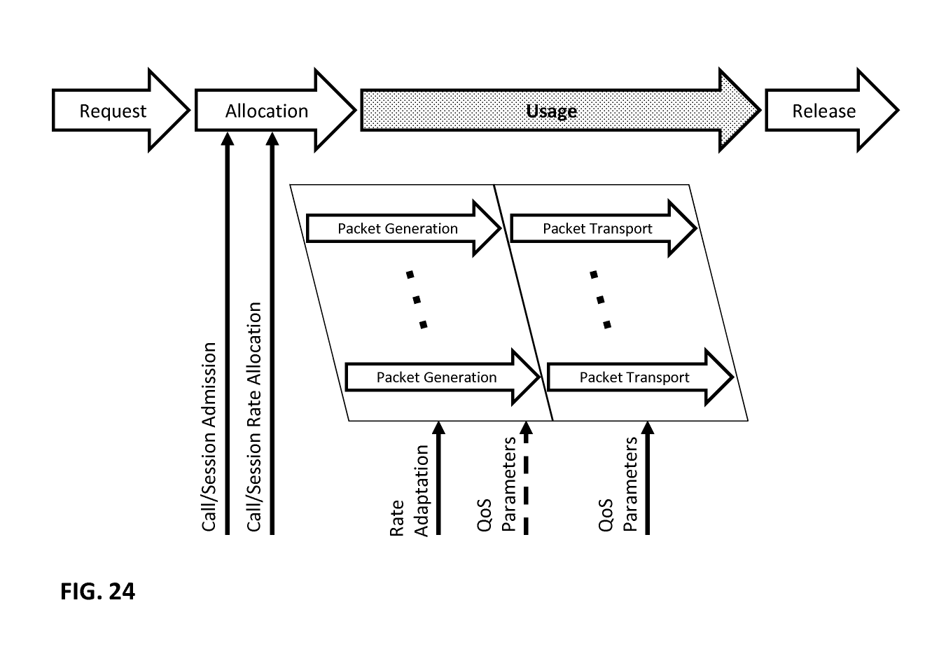

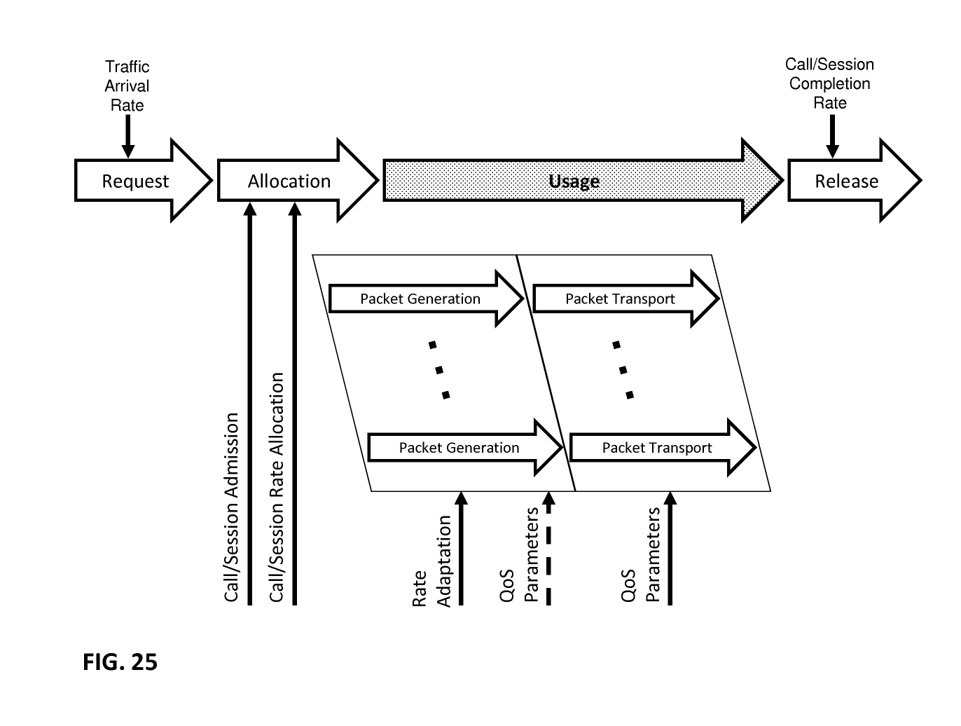

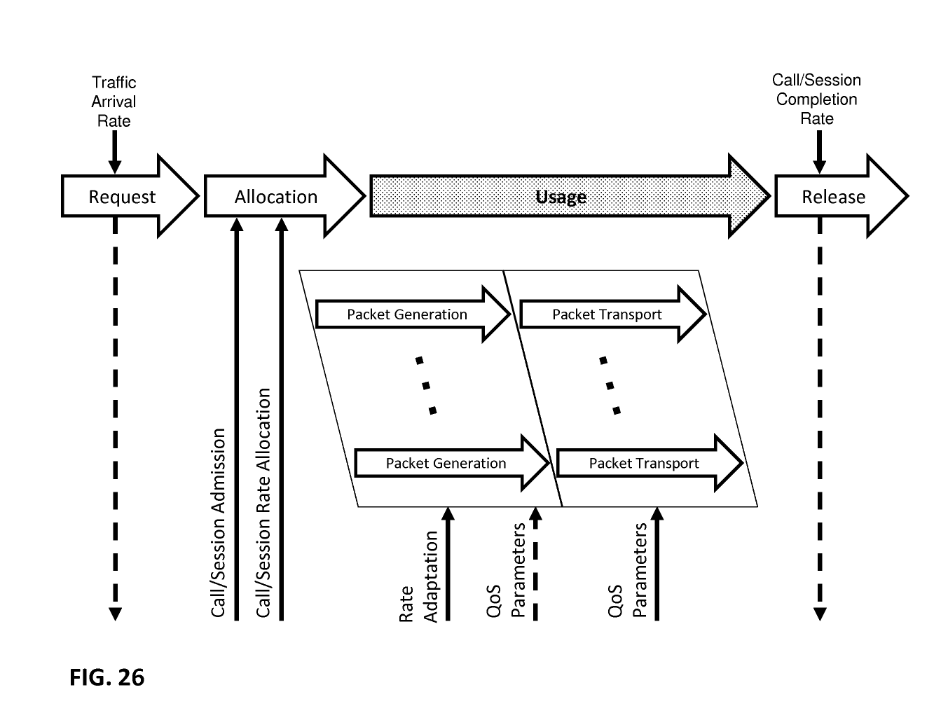

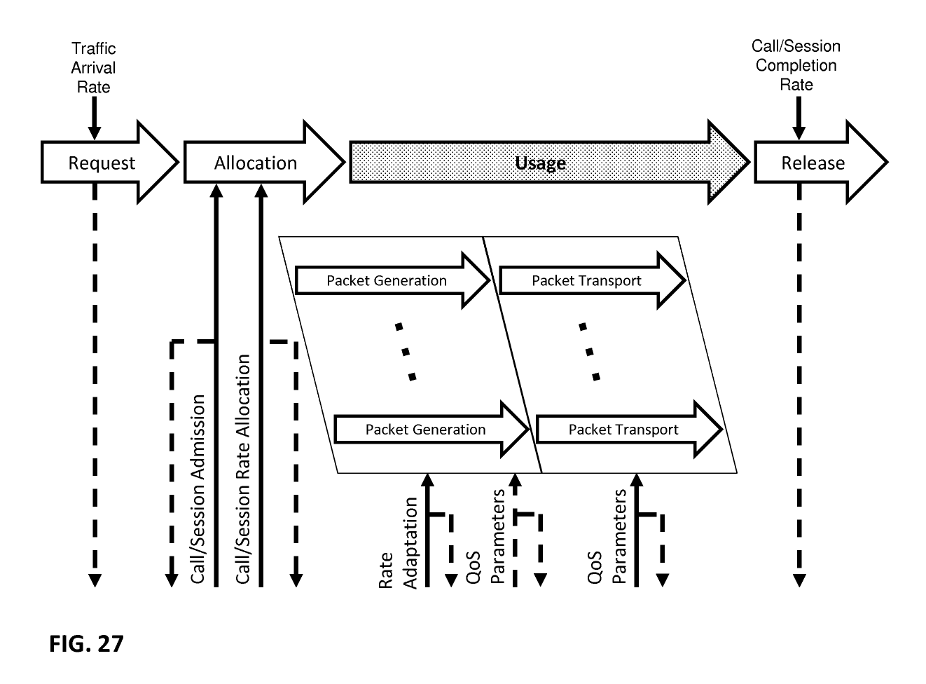

FIG. 24 depicts an example of an overall call/session packet-level QoS control framework integrating the capabilities described thus far. FIG. 25 depicts an adaptation of the representation of FIG. 24 which more broadly includes the other “input” variables to the bandwidth system, namely call/session traffic arrival rates and call/session completion rates. FIG. 26 depicts an example of the representation of FIG. 25 which further comprises primitive collection of example variable monitoring and estimation processes. FIG. 27 depicts an example of the representation of FIG. 26 which further comprises a richer collection of example variable monitoring and estimation processes. Such variable monitoring and estimation capabilities can comprise various approaches including interactions with gatekeepers, configuration files, APIs, network monitors, etc., for example as taught in U.S. Pat. No. 7,738,492.

### 5. Control Technology Approaches and Evolutionary Paths

Early in the development of IP protocols for the internet, control systems of various types were introduced for controlling packet transmission pacing so as to avoid buffer overflows. This technical area has since become known as “flow control” and is notably a component of TCP/IP, TP4, and XTP (the destined successor for TCP, UDP, etc.).

In this section, attention is directed to various degrees and types of control for call/session admission and QoS to improve network performance, for use in isolation and as part of a bandwidth management system.

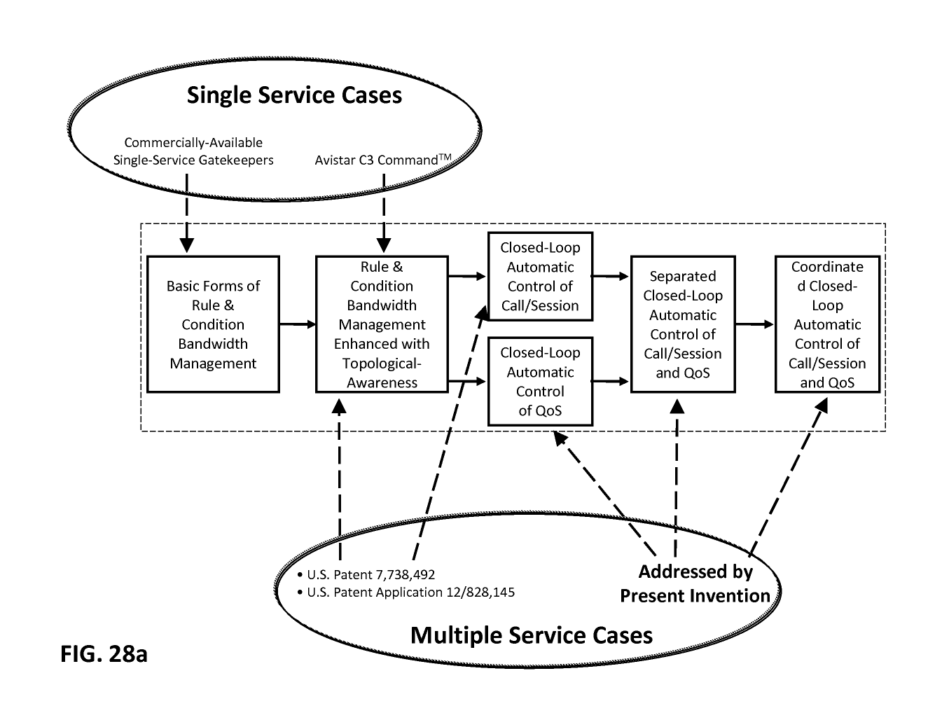

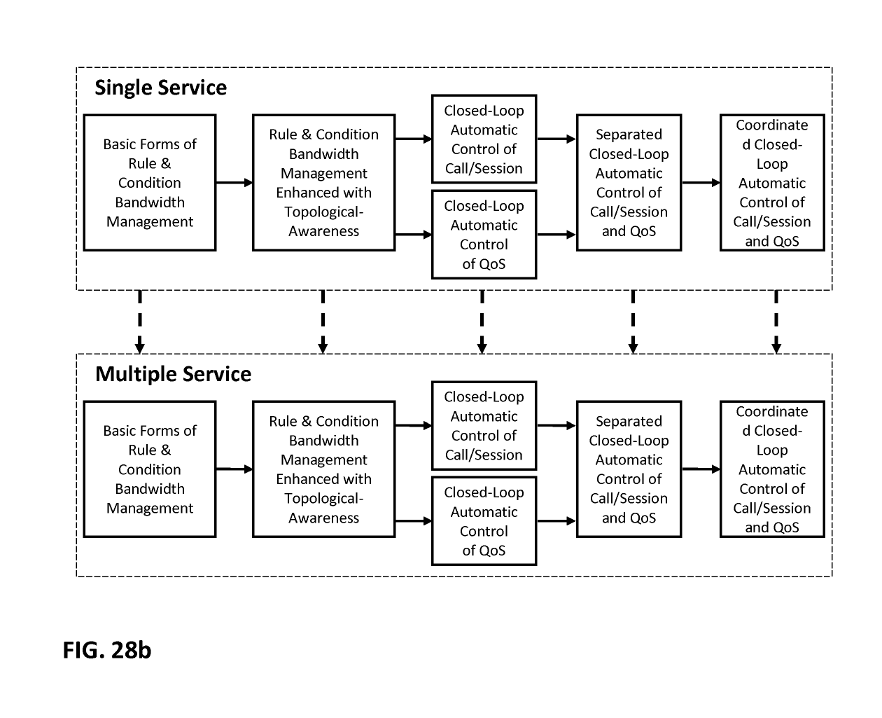

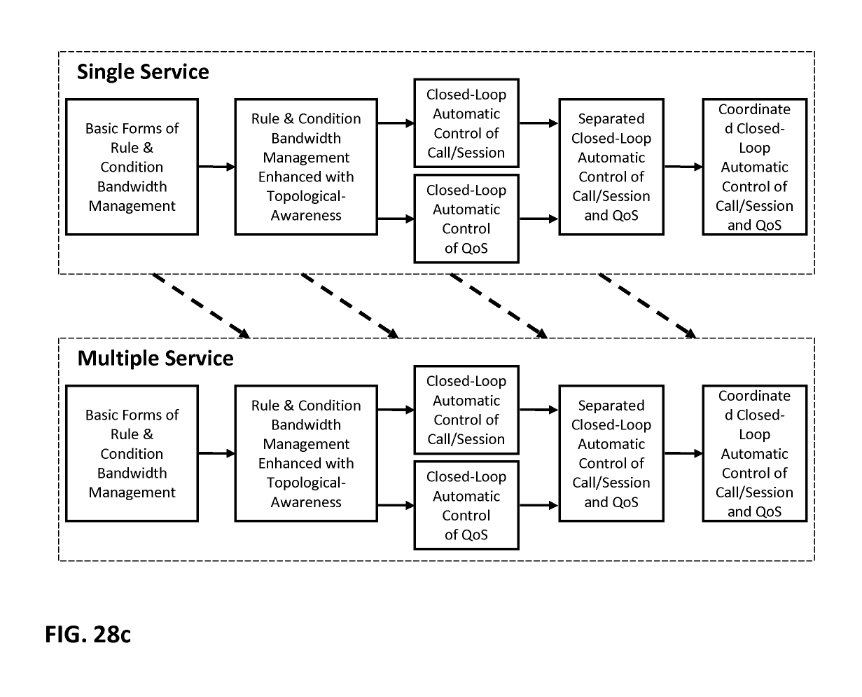

FIG. 28A depicts an example evolution path from primitive single-service implementations of various early steps (a few of these commercially available) to the more advanced types of bandwidth management control systems taught in related U.S. Pat. No. 7,738,492, related U.S. patent application Ser. No. 12/828,145), and in the present invention (none of these currently commercially available):
Basic forms of single-service rule and condition bandwidth management (these using conditional tests rather than mathematically-structured control systems) have been commercially available from various manufacturers in the form of gatekeepers and silos;
Single-service rule & and condition bandwidth management enhanced with topological-awareness capabilities has been commercially available via Avistar C3 Command™;
Multiple-service rule & and condition bandwidth management enhanced with topological-awareness capabilities is taught in U.S. Pat. No. 7,738,492;
Multiple-service closed-loop automatic control of the admission of call/session requests is taught in U.S. Pat. No. 7,738,492;
Multiple-service closed-loop automatic control of the admission of call/session requests involving non-link network elements such as switches, routers, gateways, firewalls, transcoders, encrypters, etc., in conjunction with bandwidth management is taught in U.S. patent application Ser. No. 12/828,145;
Multiple-service closed-loop automatic control of network element QoS systems have been studied somewhat in the literature; this knowledge and further enhancements and adaptations are taught in the present invention;
Multiple-service closed-loop automatic control of application packet generation QoS arrangements are taught in the present invention;
Multiple-service separated closed-loop automatic control of the admission of call/session requests and closed-loop automatic control of network element QoS systems are taught in the present invention;
Multiple-service separated closed-loop automatic control of the admission of call/session requests and closed-loop automatic control of both network element QoS systems and application packet generation QoS arrangements are taught in the present invention;
Multiple-service coordinated closed-loop automatic control of the admission of call/session requests and network element QoS systems are taught in the present invention;
Multiple-service coordinated closed-loop automatic control of the admission of call/session requests, network element QoS systems, and application packet generation QoS arrangements are taught in the present invention.

In principle, the lineage and flow of the evolutionary steps in the dashed-line box of FIG. 28A can be accomplished for either single-service situations or multiple-service network arrangements. Cross-migration of these evolutionary steps from single-service implementations of various evolutionary steps (for example, a few of the depicted early steps are commercially available) to multiple-service versions (none of these currently commercially available) can occur laterally as suggested in FIG. 28B or can include leapfrog steps suggested in FIG. 28C. Both lateral and leapfrog evolutions, as well as other evolutionary paths, are anticipated and provided for by the invention.

### 5.1 Myopic Conditional-Based Open-Loop Control

As stored one-way “content delivery” video, VoIP, and live real-time videoconferencing product offerings began to significantly impose negative effects on enterprise network performance, vendors began to creation myopic session management systems (which have come to be called silos) for their application products. For VoIP and video communications, examples include the Avistar C3 Command™, the Cisco Call Manager™, the Microsoft OCS™, the Polycom DMA™, as well as similar products from streaming media application, Content Delivery Network (CDN) providers and others. These simply enforce a maximum number of calls/session, reserve a minimum amount of bandwidth to ensure that a minimum number of calls or sessions can operate and/or a maximum number of simultaneous sessions, or combinations of these. The numerical values of these minimum and maximum limits are not affected by network conditions, and thus these systems are “open-loop,” i.e., without feedback (in the sense that there is no feedback of network conditions which is used to affect the call or session admission process).

### 5.2 Global, Less-Quantized Closed-Loop Control

Van Jacobson is a well-known IP expert who made critical contributions to the current state of the TC/IP protocol. In his landmark 1988 paper concerning flow control (“Congestion Avoidance and Control,” ACM Computer Communications Review, 18(4), August 1988, pp. 314-329), he writes “A packet network . . . ” (here referring to one with TCP protocols) “ . . . is to a very good approximation a linear system made of gains, delays, and integrators . . . . ” Jacobson shows the TCP/IP protocol acts as a closed-loop linear delay-feedback control system (and can thus can be tuned and optimized as such).

In a similar fashion, closed-loop feedback control system frameworks with lesser levels of quantization (i.e., similar to linear feedback control) can be created and leveraged for session admission and QoS control to improve network performance. This, especially in regards to session admission, is considered in U.S. Pat. No. 7,738,492.

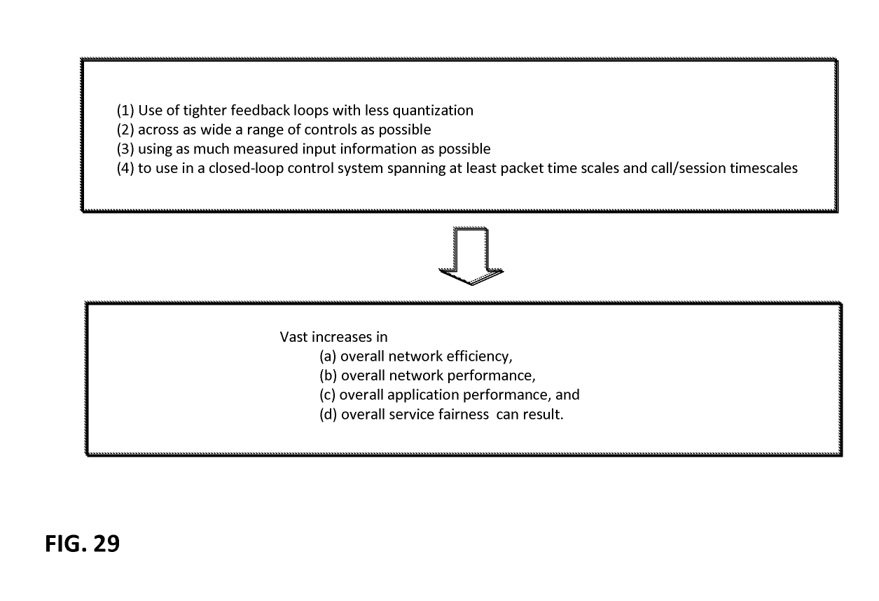

Accordingly, a key principle leveraged by the present invention is that by creating (1) tighter feedback loops with less quantization (2) across as wide a range of controls as possible (3) using as much measured input information as possible (4) to use in a closed-loop control system spanning at least packet time-scales and call/session time-scales, a result of vast increases in (a) overall network efficiency, (b) overall network performance, (c) overall application performance, and (d) overall service fairness can result. This is summarized in the depiction of FIG. 29.

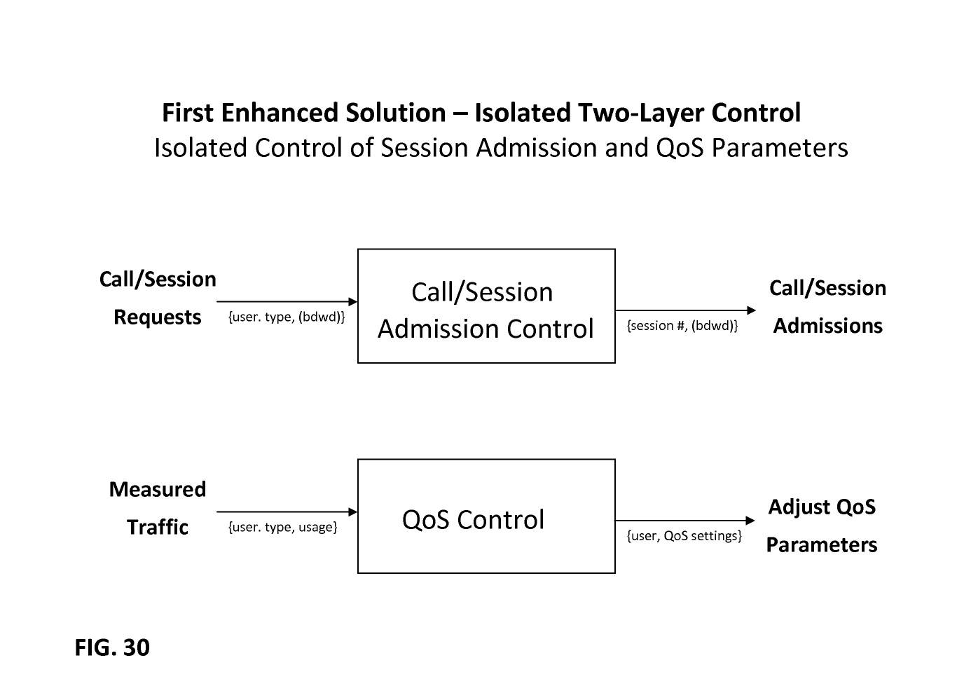

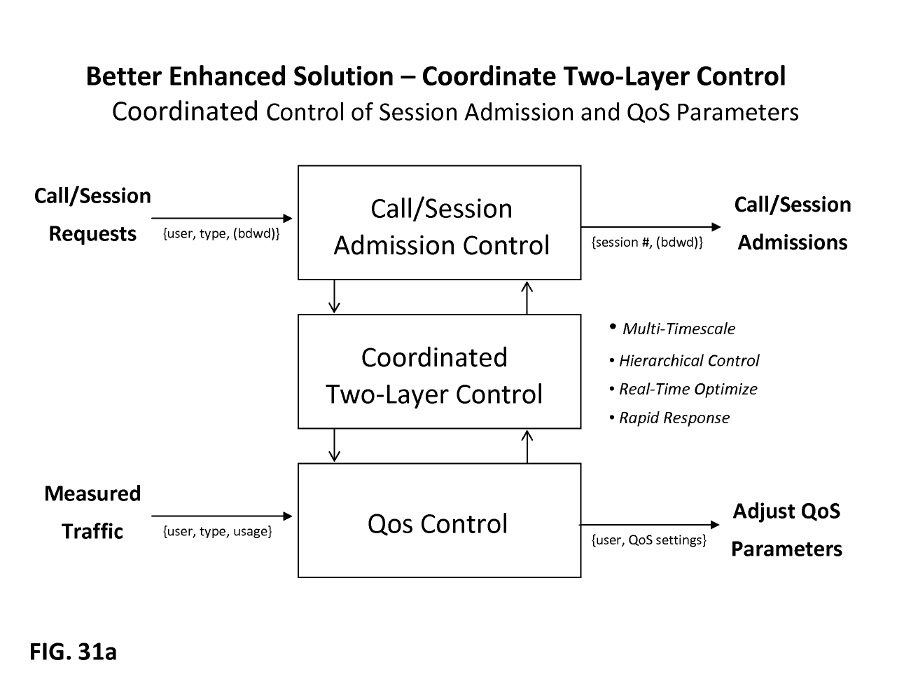

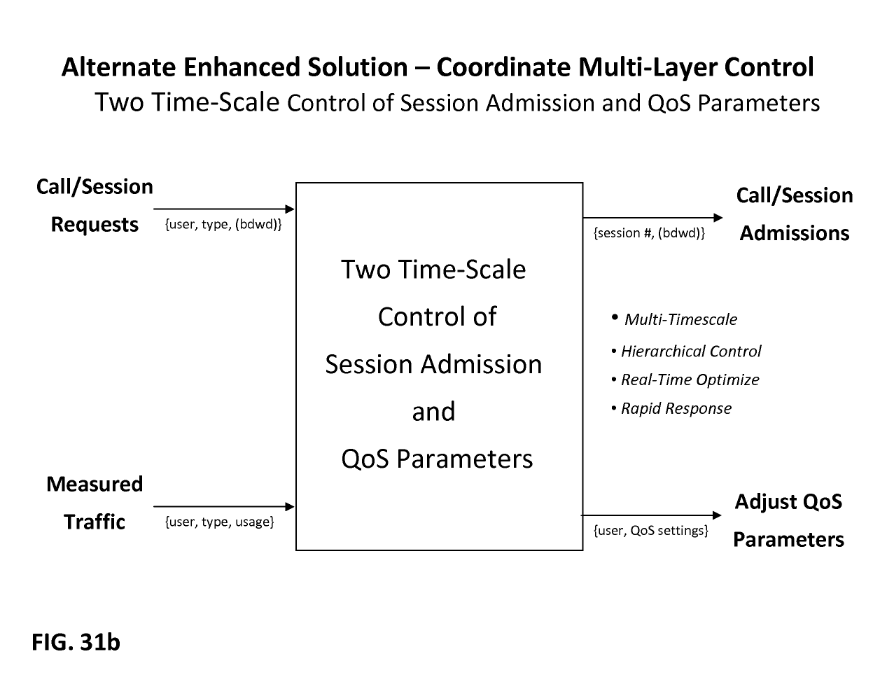

Regarding item 4 in the above list (and FIG. 29), the arrangements shown in FIG. 30, FIG. 31A and FIG. 31B depict example alternative approaches to a two-layer control implementation. FIG. 30 depicts an example of a two-layer control implementation with no coordination between call/session admission control and QoS control. An arrangement such as depicted in FIG. 30 leverages the combination of the separate call/session admission control (for example as discussed in Section 6) uncoupled to QoS control (for example as discussed in Section 7). Alternatively, FIG. 31A depicts an example of a two-layer control implementation with coordination between call/session admission control and QoS control (for example as discussed in Section 8), while FIG. 31B depicts an example of a unitary two time-scale control implementation providing call/session admission control and QoS control.

In general, example embodiments of the present invention provides for a real-time control system comprising at least first operation comprising a first time-scale associated with sessions (for example session allocation, initial bit-rate at the time of allocation, etc.) and a second operation comprising a second time-scale associated with packets (for example QoS processes and parameters). These would both be present, for example, in each of the arrangements depicted in FIG. 30, FIG. 31A, and FIG. 31B.

In various embodiments, the present invention further provides for the real-time control system to additionally include at least a third operation comprising both the first time-scale and the second time-scale. An example of the latter is the “coordinated multilayer control” element depicted in FIG. 31A. Alternatively, other embodiments can comprise only the third operation comprising both the first time-scale and the second time-scale in a unitary controller implementation, as depicted in FIG. 31B.

The present invention provides a flexible, multiple-protocol, multiple service, multiple vendor approach and framework that remains evolvable and scalable as protocols and technologies progress. Accordingly, the present invention differs from various protocol-specific feedback approaches such as Congestion Avoidance with Proportional Control (CAPC) [9], Adaptive Load Service (ALS)[10], eXpress Control Protocol (XPC)[11-12], Performance Transparency Protocol (PTP) [13], and Congestion Avoidance with Distributed Proportion Control (CADPC) [13].

### 6. Call/Session-Level Closed-Loop Control

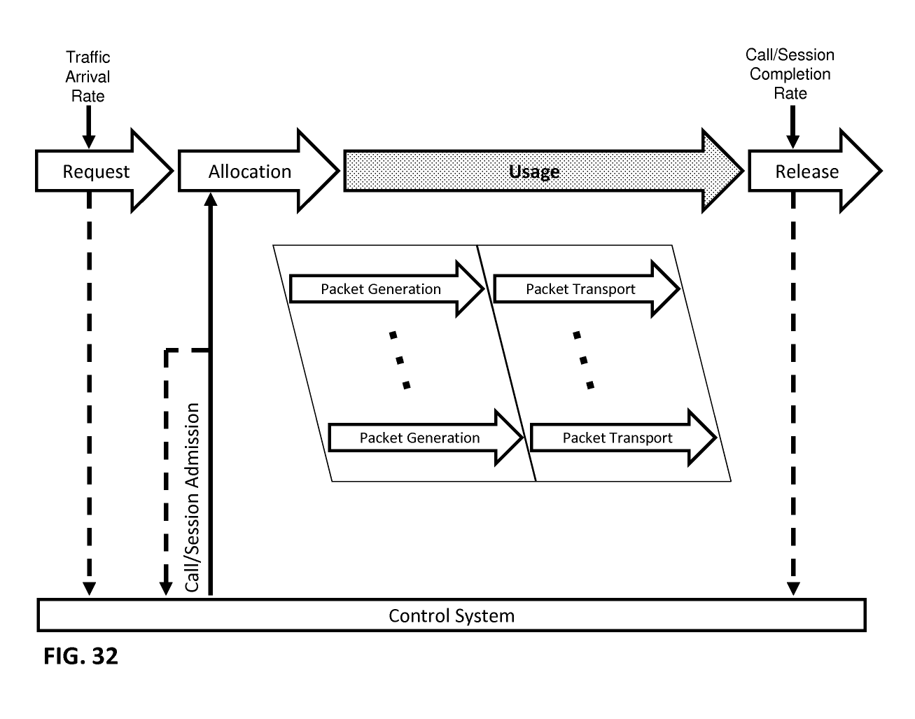

FIG. 32 depicts an example framework for closed-loop control combining the controlled “plant” input arrangements represented in FIG. 18 and FIG. 19 with various control system inputs, for example as taught in U.S. Pat. No. 7,738,492 (for example comprising such variable monitoring and estimation approaches as interactions with gatekeepers, configuration files, APIs, network monitors, etc.). In an example implementation, incoming call/session request information from various service gateways and communications silos can be presented to a control system. In an enhanced version of such an arrangement (represented in FIG. 32), call/session completion event information can also be presented to the control system various service gateways and communications silos.

In addition, various real-time or near-real-time network usage measurements, such as those taught in U.S. Pat. No. 7,738,492, can also be presented to the control system. For example:
Separate network monitoring can be used to gather raw information for subsequent filtering, sorting, classification, and interpretation:
   Monitored control packet header and content information can be identified and used to calculate the rate of new call and session requests for one or more types of supported services, the average duration of calls and sessions for these services during a recent interval in time, and other service-specific statistics and attributes that can be useful.
   Interpreters and models can be used to derive indirect or implied measurement values. The interpreters and models used can be based on abstract models and/or comprise empirical models made from a priori study, run-time estimators, run-time predictors, etc.
In some cases, gatekeepers and APIs can present various types of real-time or near-real-time network usage measurements:
   Real-time event reports can be used to calculate the rate of new call and session requests for one or more types of supported services, the average duration of calls and sessions for these services during a recent interval in time, and other service-specific statistics and attributes that can be useful.
   Interpreters and models can be used to derive indirect or implied measurement values. The interpreters and models used can be based on abstract models and/or comprise empirical models made from a priori study, run-time estimators, run-time predictors, etc.

In various implementation approaches and embodiments of the invention, the control system can process this information so as to in turn adjust control parameter(s) so as to affect the decision of the session-admission and allocation process. Attention is directed to various session-admission control aspects, methods, and systems.

As a review of the observations made thus far:
First recall that full-sharing of a pool of bandwidth among services allows full access to all possible bandwidth sharing conditions, but can be unfair to low-usage services in intervals of heavy demand from high-use services.
An industry product response to this is to create gateways that allow only a maximum number of simultaneously active calls/sessions for at least some services. As seen in FIG. 11C, this effectively partitions the bandwidth into a number of limiting “cannot exceed” domains. Recall from the discussion associated with FIG. 11C that such a method of fixed partitions (“maximum usage” limits) set individually for each service cannot attain and utilize a large number of bandwidth and resource sharing opportunities for the amount of bandwidth represented by the sum of all the partitions. Efficiency and effectiveness of bandwidth usage can be poor if the amount of bandwidth used by each of the services differs widely.
A more efficient and effective system is one where there is full sharing with fixed reservations. However, such systems can be inefficient and/or unfair to high-usage services when there is simultaneously small or no usage of low-usage services. In one implementation (see FIGS. 14C-14F and associated discussions), a “global” control system can implement fixed reservations by manipulating the maximum number of calls/sessions allowed by each service gatekeeper.
An improvement on fairness and efficiency can be obtained by making the aforementioned reservations adaptive rather than fixed (i.e., allocations with “controlled adaptive reservations”). The introduction of such controlled adaptive reservations would typically comprise a control system responsive at least to the state of the current bandwidth allocations and/or bandwidth usage. In an example implementation, the “global” control system described above can be used as the control system implementing an adaptive reservations arrangement such as those described in the discussions to follow.

The control system required for adaptive reservations can also be configured to be responsive to other information in order to obtain yet further enhancements. Some of the other information and control system enhancement considered in this section include:
Responsiveness to empirically-measured rate-of-change of call/session state;
Responsiveness to empirically-estimated call/session traffic-model parameters (such as modulated Poisson arrival rate, modulated holding time, etc.);
Control of allocated bit-rates of new calls/sessions (“rate adaptation”)

Additionally, a number of elements and features of such control systems are also considered. In Section 8, the control systems described here are optionally enhanced further by including inputs from and or interaction with QoS and packet-process measurements and control actions.

Attention is next directed to various approaches to useful control of an adaptive reservation systems and related systems and methods for high-performance call/session allocation control in high-performance bandwidth management systems. First to be considered (Section 6.1) is call/session admission control, i.e., the simple granting or denying a new incoming call/session request). Then the finer detail of what permitted bandwidth is allocated when granting a new incoming call/session request is considered (Section 6.2)

### 6.1 Control of Call/Session Admissions

At the level of simply granting or denying a new incoming call/session request, there are at least two approaches that can be employed:
Approaches wherein the admission control system is not involved with or responsive to packet level processes (considered in this section), and
Approaches wherein the admission control system is involved with and/or responsive to packet level processes (considered Section 8 and implemented, for example, as in FIG. 31A and FIG. 31B).
   Because the underlying media is packet-oriented, admission control systems that are not involved with or responsive to packet level processes treat each call/session a particular service type as if it occupies or consumes some sort of bandwidth footprint, (i.e. an “effective bandwidth” value, “average bandwidth” value, “peak bandwidth” value, etc.), that is an abstract block of bandwidth for each call/session of a particular service type. This is as was discussed in the opening portions of this patent application, but is recalled as a reminder here.

### 6.1.1 Example Architectures for Implementing Adaptive Admission Control Reservations

As just described in the previous section, a control system provided with at least call/session state information can be used to implement a fixed or adaptive reservation system across multiple services on a common network by manipulating the settings for the maximum number of simultaneously active calls/sessions for each participating gatekeeper, applications, or other aspects within each individual communications service silo. The control and measured information flows of such a system can be implemented, for example, as depicted in FIG. 14C. Alternatively, the reservation system can be implemented without a centralized controller through use of a shared database or shared files (as represented in FIG. 14E), direct peer-to-peer communications among the communications silos (as represented in FIG. 14F), as well as other possible approaches.

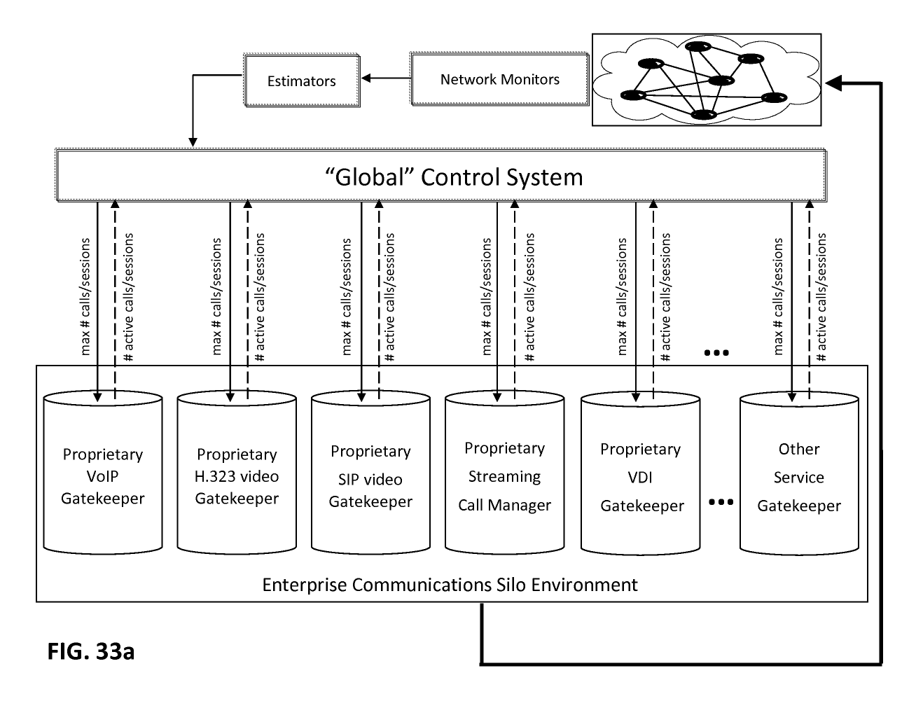

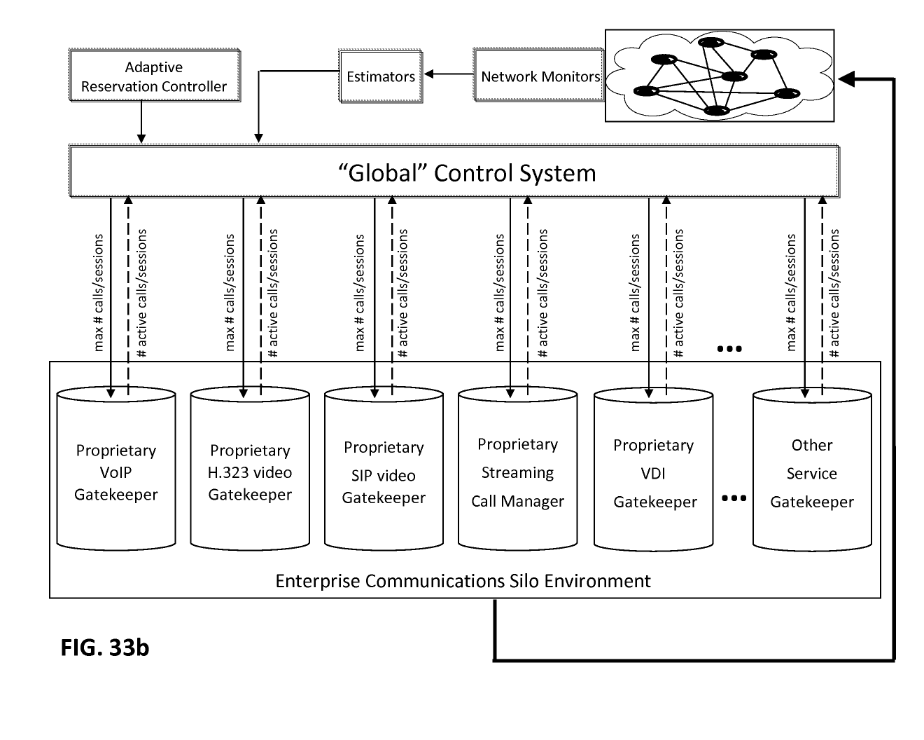

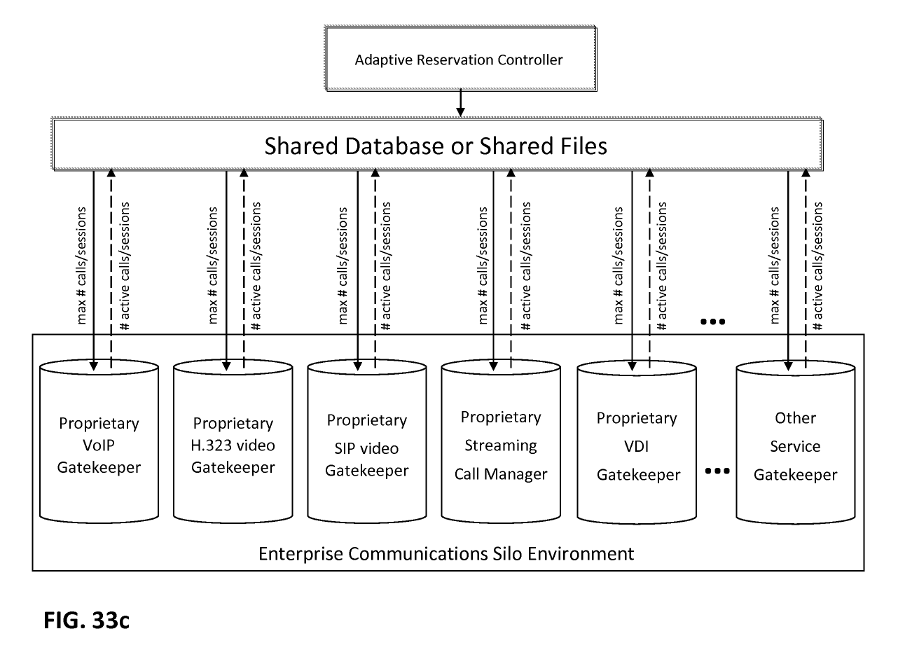

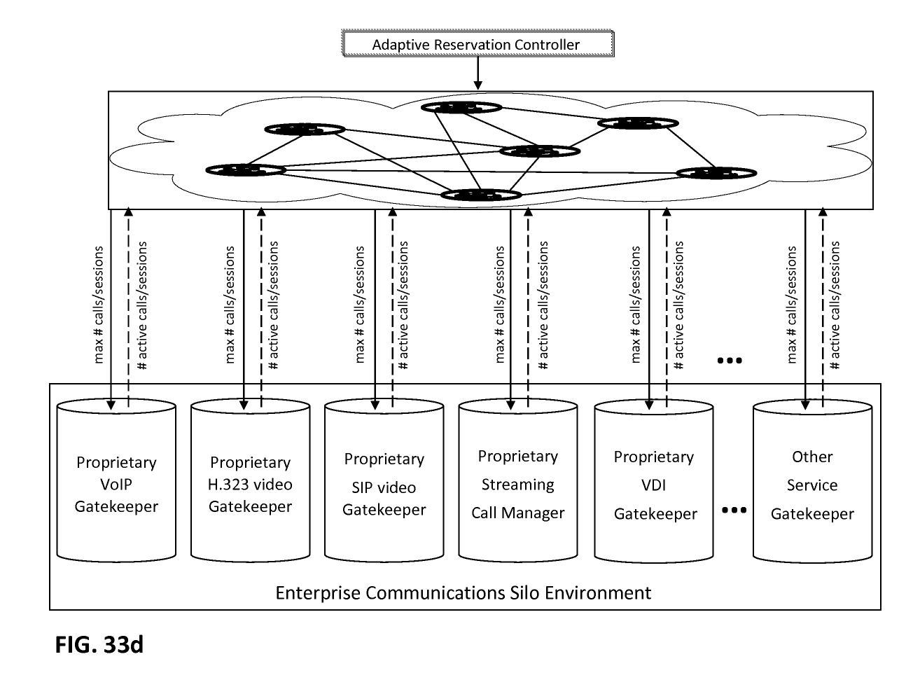

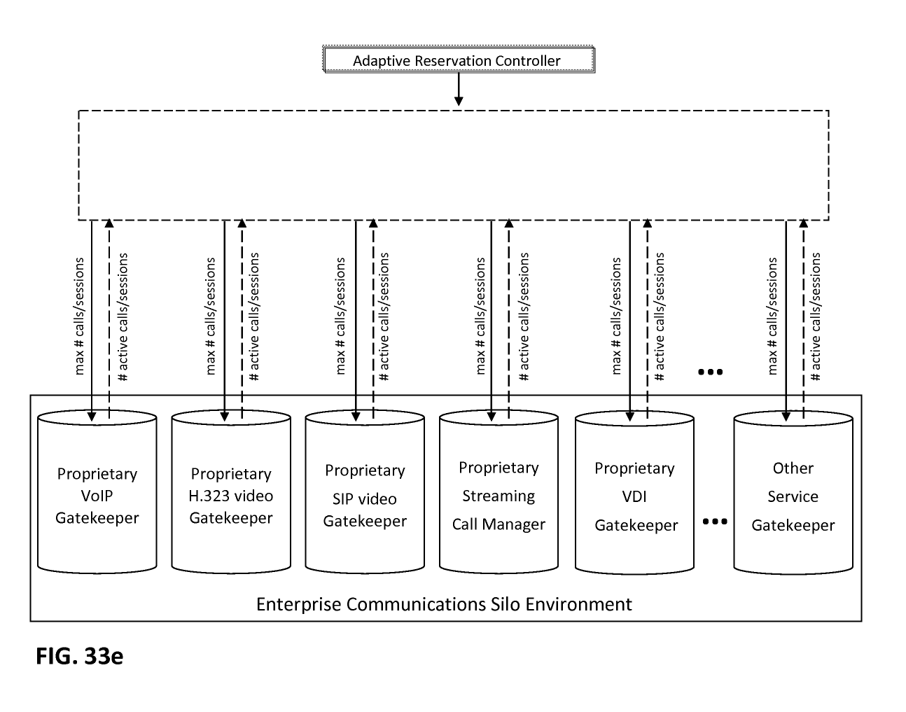

For arrangements such as depicted in FIG. 14C, there are at least two approaches for incorporating adaptive control given that a control system is already in place. In one approach, the fixed reservation control system is replaced by an adaptive reservation control system, or modified so as to provide adaptive reservation control capabilities. Such an arrangement is depicted in FIG. 33A.

In a second approach to incorporating adaptive control into arrangements such as that depicted in FIG. 14C, the fixed reservation control system in FIG. 14C is arranged to be (in turn) controlled by an additional control system that can adjust and modulate the fixed reservation settings. Such an arrangement is depicted in FIG. 33B. Inputs to the additional control system are not shown in but can include one or more of:
the same information provided to the global controller;
subsets of the information provided to the global controller;
additional information provided by the communications silos;
additional information obtained by additional estimators and/or network monitor measurements of traffic on the network.

For arrangements such as depicted in FIG. 14E, an external adaptive reservation control system can communicate with the shared database or shared files. Such an arrangement is depicted in FIG. 33C. Inputs to the additional control system are not shown in but can include one or more of:
additional information provided by the communications silos;
additional information obtained by additional estimators and/or network monitor measurements of traffic on the network.

For arrangements such as depicted in FIG. 14F, an external adaptive reservation control system can communicate with each of the communications silos. Such an arrangement is depicted in FIG. 33D. Inputs to the additional control system are not shown in but can include one or more of:
additional information provided by the communications silos;
additional information obtained by additional estimators and/or network monitor measurements of traffic on the network.

FIG. 33E shows a representation generalizing each of the examples described in conjunction with FIGS. 33A-33D (as well as other possible arrangements). For any of these arrangements (as well as others), as represented in the two-service examples depicted in FIG. 14D, the settings for each service silo's maximum number of simultaneously active calls/sessions can be widely adjusted so as to ride along the edge/surface of the full-sharing boundary. If no adjustment is performed only to limiting values for each service, reservation systems with allowed state spaces such as those depicted in FIGS. 12A-12C can be implemented. Such is the case where these limiting values are fixed (for example, by a communications service administrator or network administrator), resulting in a system that behaves a fixed reservation system, If instead these limiting values are allowed to vary responsive to traffic conditions, for example employing feedback control, the result is an inventive controlled adaptive reservation system.

### 6.1.2 Control as a Function of Active Call/Session State

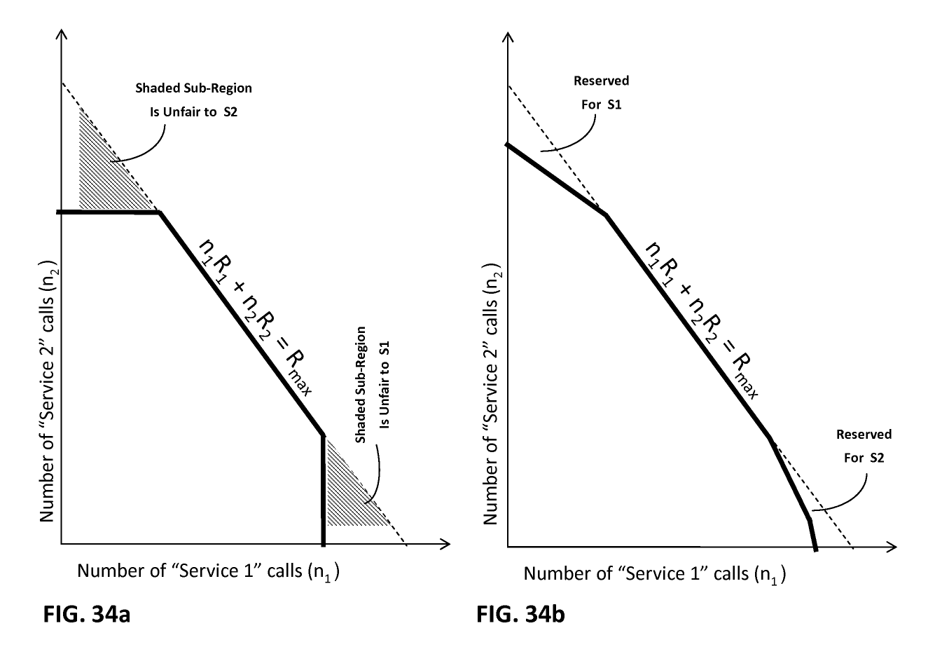

As a first exemplary implementation of adaptive reservation control, the reservation boundaries (for example, as suggested in FIGS. 12A-12C) can be changed as a function of the state of the current bandwidth allocations and/or bandwidth usage. The rational for this is worthy of a brief philosophical aside:
The whole purpose of fixed reservations is to guarantee a minimum amount of bandwidth for a particular service when one or more other services would otherwise consume all available shared bandwidth;
However, if at least one service is experiencing high traffic demands while one or more other services hardly have any usage, then the result is unfair to the heavily loaded service(s), and further is wasteful as the reserved bandwidth goes unused;
If the fixed reservations are large, or there are many services with fixed reservations, then the waste and unfairness can become extensive.
   A moment's reflection on the above points yields at some point that reservation arrangements such as those depicted in FIGS. 12A-12C provide desired fairness goals for a service but additionally provide too much protection for that service in that in some situations the reservations are excessive. As a start to further considering this, consideration of the example presented in FIG. 34A shows that at least most of the shaded sub-regions of the reservation regions are unfair to the other service(s). Thus the problem with fixed reservations is that the reservation region has the wrong-shaped boundary. Further review of desired policy can produce more desirable boundary shapes for the reservations region. For example, in FIG. 34B the reservation boundary associated with Service 1 is sloped at a different angle than the corresponding reservation boundary of FIG. 34A, and the reservation boundary associated with Service 1 comprises at least one breakpoint. In general forms of this arrangement as provided for by the invention, state information can be used to control the maximum number of calls/sessions so as to effectively shape the permitted state-space boundary over a range of arbitrary curvatures. Typically, however, it is advantageous to have whatever the resulting shape of the entire bold curve be convex (for as shown in [2] non-convex shapes can give rise to unrealistic and/or undesired outcomes).

In another example implementation, conditional tests are performed on the values of current-state input, the outcome of the conditional tests causing the generation of a control message to change the maximum number of calls/sessions for at least one service.

### 6.1.3 Quantizing and Hysteresis

With quick reference to FIG. 14C, it can be seen that the angular-sloped (i.e., not parallel to a coordinate axis) portions of the bold curves in FIGS. 12A-12C and 34A-34B require an ongoing flux (and typically a high number) of communications messages from the controller to the individual communications silos as the state changes from one state value to another. Also, importantly, it can be seen that the arrangement of FIG. 34B requires a higher number of communications messages from the controller to the individual communications silos than the arrangement of FIG. 34A—this is because the reservation regions of FIG. 34A will not require further communications messages from the controller until the state leaves these regions). One signature of the latter circumstance is that a reservation boundary is parallel to a coordinate axes.

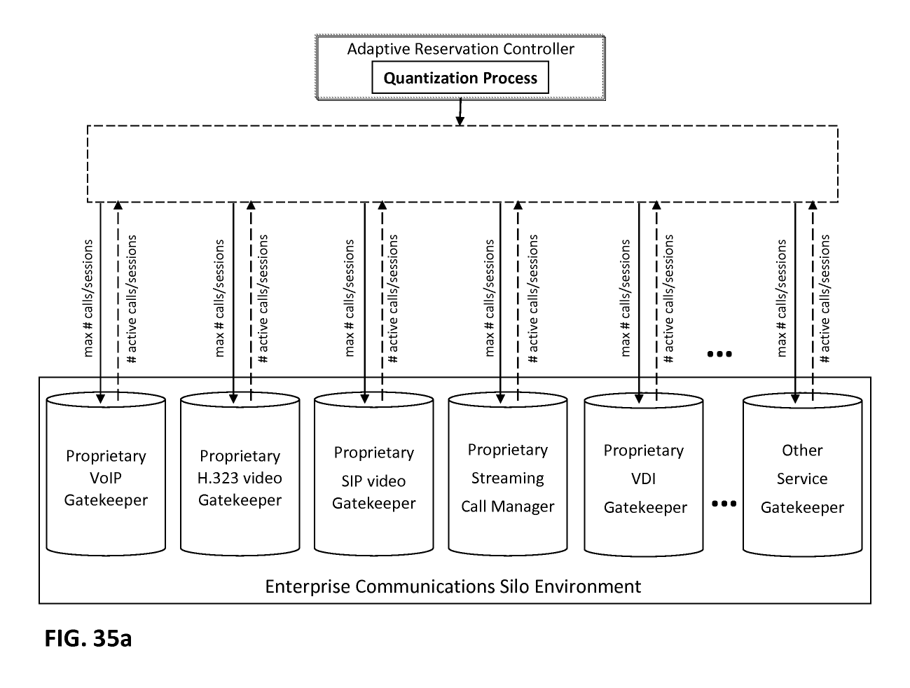

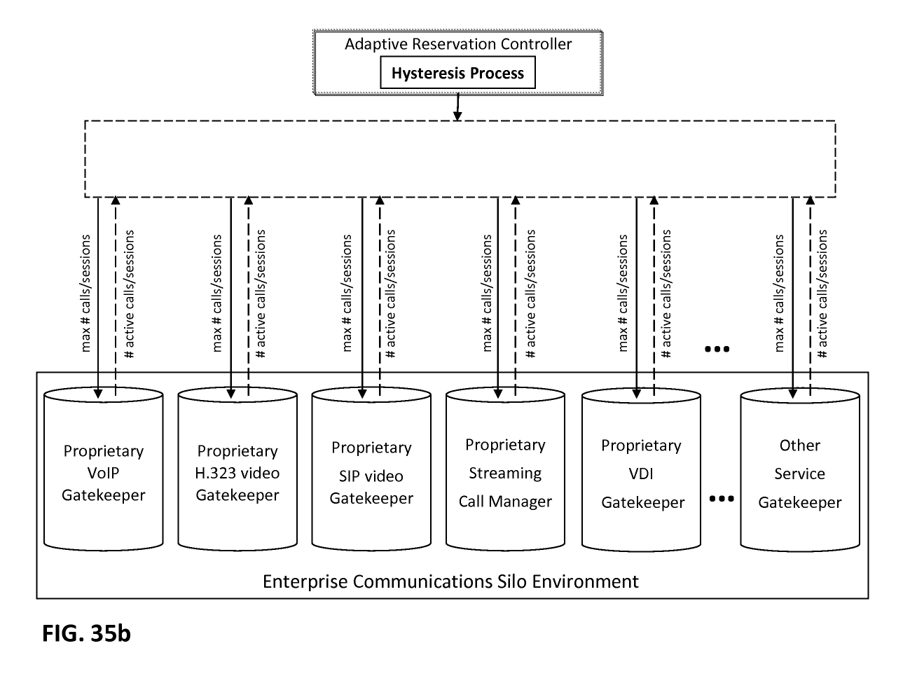

Thus, the number of messages can be reduced if the various slopes depicted In the arrangements of FIGS. 12A-12C and 34A-34B and their higher-dimensional generalizations are quantized into staircases (for two services) or more generally (for three or more services) quantized into convex hulls with surfaces parallel to planes defined by pairs of coordinate axes. The greater the level of this form of quantization, the less message flux required from the controller to the individual communications silos so as to adjust the maximum number of calls/sessions for each service as suggested in FIG. 14C. In order to reduce the message flux from the controller to the individual communications silos, in an embodiment the quantization process is implemented in the controller as represented in FIG. 35A.

Another way to reduce the message flux is to employ hysteresis in the adjustment of the maximum number of calls/sessions for each service. In one example implementation, the hysteresis process introduces directional memory into the adjustment process of the maximum number of calls/sessions for each service. In order to reduce the message flux from the controller to the individual communications silos, an embodiment the hysteresis process is implemented in the controller as represented in FIG. 35B.

Yet other arrangements are possible, anticipated, and accordingly provided for by the invention.

### 6.1.4 Overall Controller Dynamics Considerations

In the situations described thus far, the call/session request dynamics can cause the state to vary widely, so much so that only use of current state (i.e., the current number of active calls/sessions at a given instant) can result in both erratic behavior and a high flux of control messages. One approach to improve these shortcomings would be to include the rate-of-change of the state (i.e., the rate-of-change of the number of active calls/sessions at a given instant) as an input to the adaptive reservation controller. This allows, for example, the observance of high rates-of-change in the state (current number of active calls/sessions at a given instant) to cause anticipatory adjustments in relevant reservation settings.

In an example implementation, the rate-of-change measurement can be implemented as a simple difference between a previous state value and the current state value. In another example implementation, the rate-of-change measurement can be implemented as a more sophisticated numerical difference operator approximating a time-derivative (for example, multi-point stencil, difference quadrature, etc.).

In contrast to rate-of-change “time-derivative” controller input which produces anticipatory behavior, “time-integral” input can be used to produce lagging conservative influences in the response. More generally, a weighted combination of current-state input, rate-of-change “time-derivative” input, and “time-integral” input can be used to produce a response with more desirable dynamics. In the case of a linear controller, such an arrangement would correspond to a “Proportional/Integral/Derivative” or PID controller. The invention provides for use of linear PID controllers but also provides for the use of nonlinear PID controllers as advantageous in various applications. For example:
In an example implementation, a linear PID controller (comprising separate weighting coefficients for current-state input, rate-of-change “time-derivative” input, and “time-integral” input) is arranged so that the weighting coefficients are adjusted as function of state (for example, with different anticipatory versus conservative lagging behaviors when the state is nearer resource limit and reservation boundaries than when the state is farther from these resource limit and reservation boundaries;
In another example implementation, conditional tests are performed on the values of current-state input and one or more of rate-of-change “time-derivative” input and “time-integral” input, the outcome of the conditional tests causing the generation of a control message to change the maximum number of calls/sessions for at least one service.

Many other dynamic control arrangements are possible and are provided for by embodiments of the invention. For example, the controller can comprise one or more of:
A linear predictor;
A nonlinear predictor;
A traditional Kalman (Gaussian) filter;
A modified Kalman filter (for example, non-Gaussian);
A time-driven ramp generator;
A periodic or dithering function;
A quantization process;
A hysteresis process.
   Yet other arrangements are possible, anticipated, and accordingly provided for by the invention.

### 6.1.5 Overall Stochastic Model Considerations for Controllers

In another approach, the adaptive reservations controller can include aspects structured around a model of the stochastic dynamics and/or statistics of the call/session arrival and departure processes. These can facilitate the advantage or need for providing the adaptive reservations controller with other types of input information.

For example:
In one example implementation an adaptive reservations controller can comprise aspects specifically designed around mathematical expressions derived from models employing Markovian dynamics. In such an arrangement, it can be advantageous to provide the adaptive reservations controller with real-time estimates of arrival rates and holding times.
As another example, an implementation an adaptive reservations controller can comprise aspects based on Bayesian decision theory. In such an arrangement, it can be advantageous to provide the adaptive reservations controller with real-time estimates of various probability distributions with respect to a set of observations.
As yet another example, an implementation an adaptive reservations controller can comprise aspects based on time-series data. In such an arrangement, it can be advantageous to provide the adaptive reservations controller with real-time estimates of various time-series quantities with respect to a set of observations.
As still another example, an implementation an adaptive reservations controller can comprise aspects based on other types of models, for example Usage Parameter Control (UPC) parameters—for example, Peak Cell Rate (PCR), Burst Tolerance or Maximum Burst Size (MBS), Sustainable Cell Rate (SCR), etc [8]. In such an arrangement, it can be advantageous to provide the adaptive reservations controller with real-time tabulations of various UPC parameter values and demographics with respect to the currently active calls/sessions.
As a further example, an implementation an adaptive reservations controller can comprise aspects based on other types of models, for example Network Parameter Control (NPC) parameters (such as PCR, MBS, SCR, etc.) [8]. In such an arrangement, it can be advantageous to provide the adaptive reservations controller with real-time tabulations of various NPC parameter values and demographics with respect to the currently active calls/sessions.
   Yet other arrangements are possible, anticipated, and accordingly provided for by the invention.

### 6.2 Control of Rate Allocation

The arrangement can be further extended to control the bit-rate allocation for new calls/sessions (allocated at their admission), thus affecting the bandwidth footprint of that particular session/call. For example, as traffic levels increase, new session/call requests are allocated less bandwidth.

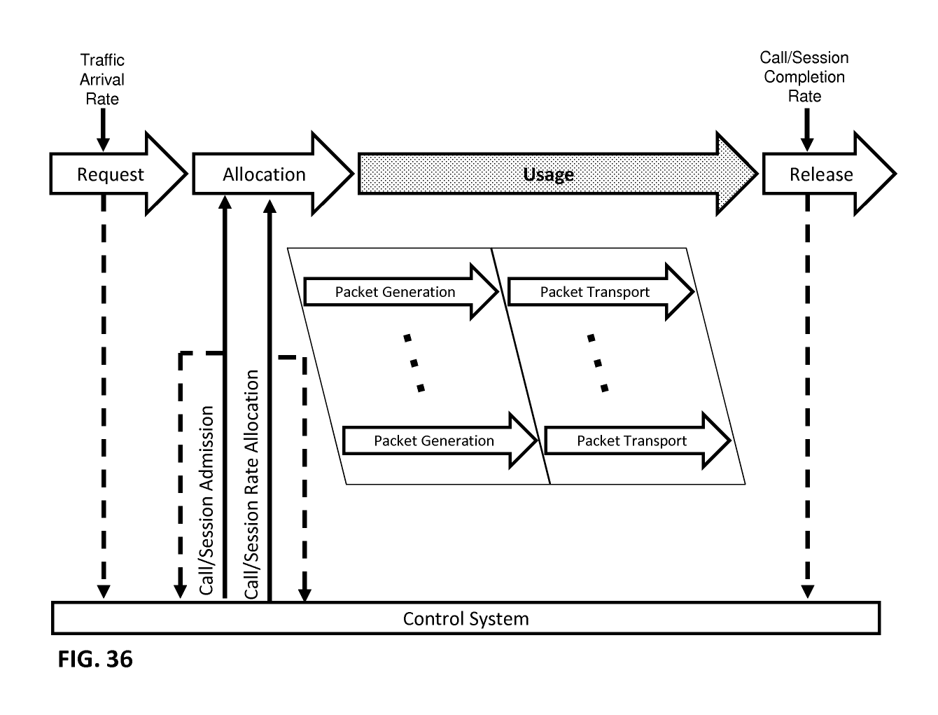

FIG. 36 depicts an exemplary adaptation of the arrangement of FIG. 32 wherein the basic call/session admission closed-loop control system also variably controls call/session rate allocation made at the beginning of each new call/session allocation. An adaptive reservation controller could be designed, as advantageous, to take various policy actions in response to current traffic, traffic measurements, call/session parameter demographics, traffic trends, etc.

As with adaptive call/session allocation reservation control, the control of control the bit-rate allocation for new calls/sessions (wherein the initial operating bit rate is allocated at the admission of a new call/session) could also be made to respond to network packet statistics. This approach is considered in Section 8. Example architectural arrangements for this approach was considered earlier in the discussions associated with FIG. 31A and FIG. 31B.

### 6.2.1 Example Rate Allocation Control Actions and Policies

Some exemplary actions and policies pertaining to actions for the control of bit-rate allocations made at each new call/session acceptance can include the following (as well as mixtures, variations, and feature combinations of these and others):
Admitting all new calls/session at higher bit rates when the network is lightly loaded with active calls/sessions and admitting all new calls/session at lower bit rates when the network is more heavily loaded with active calls/sessions.
Admitting all new calls/session at higher bit rates when the network is lightly loaded with active calls/sessions and admitting some new calls/session at lower bit rates when the network is more heavily loaded with active calls/sessions.
In cases where only some new calls/session are admitted at lower bit rates, the selection could be made according to:
   i. round-robin w/fixed duty cycle
   ii. round-robin w/variable duty cycle
Admitting all new calls/sessions of certain types at higher bit rates when the network is lightly loaded with active calls/sessions and admitting all new calls/session of these certain types or classes at lower bit rates when the network is very heavily loaded with active calls/sessions (while admitting all new calls/sessions of other at higher bit rates when the network is lightly loaded with active calls/sessions and admitting some new calls/session at lower bit rates when the network is only somewhat heavily loaded with active calls/sessions).

As with the aforedescribed call/session adaptive (admission) reservations controllers, rate allocation control actions can include similar types of features, attributes and behaviors as described below.

### 6.2.2 Rate Allocation Control as a Function of Active Call/Session State

As a first example implementation of call/session rate allocation control, the allocated rate can be changed as a function of the state. For example, conditional tests are performed on the values of current-state input, the outcome of the conditional tests causing the generation of a control message to change the bit rate allocated to new calls/sessions for at least one service until the next update.

### 6.2.3 Quantizing and Hysteresis in Rate Allocation Control

In one or more embodiments, the number of rate allocation control messages can be reduced if the allowed bit rates are quantized in some way, for example from a list of standardized values, a list of conveniently spaced values, or according to a mathematical quantization function. The greater the level of this form of quantization, the less message flux required from the controller to the individual communications silos. As described earlier, in order to reduce the message flux from the controller to the individual communications silos, the quantization process is implemented in the controller as represented in FIG. 35A.

Another way to reduce the rate allocation control message flux is to employ hysteresis in the adjustment of the rate allocation for new calls/sessions for each affected service. In one example implementation, the hysteresis process introduces directional memory into the rate allocation adjustment process. As described earlier, in order to reduce the message flux from the controller to the individual communications silos, the hysteresis process is implemented in the controller as represented in FIG. 35B.

Yet other arrangements are possible, anticipated, and accordingly provided for by the invention.

### 6.2.4 Controller Dynamics Considerations in Rate Allocation Control

In one or more embodiments, the controller dynamics employed in rate allocation control can incorporate one or more of the features described in Section 6.1.4. These include:
Rate-of-change measurements;
Time-integral;
PID controllers:
   Linear;
   Nonlinear;
   Weighting coefficients are adjusted as function of state (for example, with different anticipatory versus conservative lagging behaviors when the state is nearer resource limit and reservation boundaries than when the state is farther from resource limit and reservation boundaries;
   Conditional tests are performed on the values of current-state input and one or more of rate-of-change “time-derivative” and “time-integral” quantities;
Conditional tests are performed on the values of current-state input and one or more of rate-of-change “time-derivative” and “time-integral” quantities;
Linear predictor;
Nonlinear predictor;
Traditional Kalman (Gaussian) filter;
Modified Kalman filter (for example, non-Gaussian);
Time-driven ramp generator;
Periodic or dithering function;
Quantization process;
Hysteresis process.
   Yet other arrangements are possible, anticipated, and accordingly provided for by the invention.

### 6.2.5 Stochastic Model Considerations in Rate Allocation Control

In another approach, rate allocation control can include aspects structured around a model of the stochastic dynamics and/or statistics of the call/session arrival and departure processes. These can facilitate the advantage or need for providing the adaptive reservations controller with other types of input information. For example:
In one example implementation, rate allocation control can comprise aspects specifically designed around mathematical expressions derived from models employing Markovian dynamics. In such an arrangement, it can be advantageous to provide the adaptive reservations controller with real-time estimates of arrival rates and holding times.
As another example, an implementation of rate allocation control can comprise aspects based on Bayesian decision theory. In such an arrangement, it can be advantageous to provide the rate allocation control function with real-time estimates of various probability distributions with respect to a set of observations.
As yet another example, an implementation of rate allocation control can comprise aspects based on time series data. In such an arrangement, it can be advantageous to provide the rate allocation control function with real-time estimates of various time series quantities with respect to a set of observations.
As still another example, an implementation of rate allocation control can comprise aspects based on other types of models, for example UPC parameters. In such an arrangement, it can be advantageous to provide the rate allocation control function with real-time tabulations of various UPC parameter values and demographics with respect to the currently active calls/sessions.
   Yet other arrangements are possible, anticipated, and accordingly provided for by the invention.

### 7. Packet-Level and QoS Parameter Closed-Loop Control

Despite the immense gap between envisioned and available QoS capabilities, the extremely wide range of possible QoS capabilities, and the possible extensive reach of QoS infrastructure (potentially threaded through applications, endpoint devices, operating systems, servers, network switches, routers, firewalls, and WANs), it is nonetheless possible to incorporate packet-level processes (for example, as can be had by adjusting QoS parameters) generically into a broader bandwidth management control system.

Just as the session/call admission and rate adaptation parameters can be governed by closed-loop feedback control environment so as to increase network performance towards the extreme limit possible by the policy to which the control system is optimized, a similar closed-loop feedback control environment can be applied to packet-level processes (for example, as can be had by adjusting QoS parameters).

Earlier, an informative novelty parking lot analogy was used in describing call/session allocation. Regarding packet-level processes and QoS, an informative novelty analogy can be made with loading suitcase and duffle bag baggage on to a conveyer belt, for example as at an airport. Some representative types of baggage include:
RIGID BIG SUITCASES—Analogous with real-time traffic (often large-to-very-large and relatively inflexible as to delivery time)
SLIGHTLY FLEXIBLE BAGS OF ALL SIZES—Analogous with
   Near-real-time traffic low-to-very-large and only partially flexible as to delivery time;
   Live data applications low-to-very-large and more flexible as to delivery time;
LOOSE DUFFLE BAGS OF ALL SIZES—Analogous with background data applications low-to-very-large and very flexible as to delivery time.
   In this analogy, the equivalent desired packet-level process and QoS bandwidth management outcome is to manipulate and position these items so that while honoring the requirements and properties of each item, as much as possible of every cubic inch of the conveyer belt is used.

In one or more embodiments, the closed-loop feedback control of session/call admission parameters acts on a considerably slower time-scale than the closed-loop feedback control of packet-level processes (for example, as can be had by adjusting QoS parameters). As described below, the present invention provides for combining closed-loop feedback control of session/call admission and rate adaptation parameters with closed-loop feedback control of packet-level processes (for example, as can be had by adjusting QoS parameters). The combinations can be made in various ways, for example via a two-layer control implementation with no coordination between call/session admission control and QoS control (for example, as represented in FIG. 30), as addressed in this section. Alternatively a two-layer control implementation with coordination between call/session admission control and QoS control (for example, as represented in FIG. 31A) or a unitary two time-scale control implementation (as depicted in FIG. 31B) can be used, as addressed in Section 8.

An immense amount of analytical, standards, and technology development work has been undertaken to explore the possibilities and capabilities of QoS for ATM and IP networks. On the technology development side, some QoS features are implemented to varying degrees in network products (such as IP switches) from major network equipment manufacturers. On the standards side, earlier QoS standards material developed for ATM is being repurposed for IP networks. Some aspects, such as some IPC parameters, suffer from definitions and concepts that present implementation difficulties in practical product offerings. On the analytical side, vast amounts of mathematical modeling, innovation, performance prediction, optimization, approximation, definitional, metric, simulation, and other work has been performed. This work was initially directed towards ATM and later repurposed, adapted, and continued for IP networks and more recently wireless and mobile networks. The creative solutions and mathematical prowess of these results are in many aspects truly astonishing and worthy of great praise. However, without any criticism or mount of prejudice, it has turned precious few of these results lend themselves to direct use in current network technology. Many of the wide range of analytical results have nonetheless made important contributions to the conceptual base, behavioral understanding, definitional rigor, intuition, and design principles. With full respect to all the far reaching work performed by all camps, one reference providing practical QoS implementation approaches in terms of contemporary product technology is the book by Miguel Barreiros and Peter Lundqvist entitled QOS-Enabled Networks: Tools and Foundations published 2010 by John Wiley & Sons, Ltd. [4].

In practical QoS systems deployed in products from major network equipment manufacturers typically [5-7] perform functions such as:
Identification of individual traffic flows/classes/groups;
Classification/reclassification these, for example:
   Use of DiffSery Code Point (DSCP) field in IP packets;
   Use of 802.1p Class of Service (CoS) field in Ethernet packets;
   Use of source/destination IP or MAC address;
   Use of Layer 4 Transmission Control Protocol (TCP) ports;
   Use of User Datagram Protocol (UDP) ports;
Policing incoming packets;
Marking of incoming packets;
Traffic Shaping;
Rate Shaping;
Assigned to an appropriate outgoing switch queue;
Perform of scheduling input queue-servicing, for example:
   Weighted Round-Robin (WRR) scheduling;
   Strict priority scheduling;
Dynamic creation of new classes of service;
Rate adaptation (in wireless 802.11 networking).

However, these provisions provided in contemporary networking products are typically performed responsive to associated configuration QoS parameter settings made (and on rare occasion adjusted) by network administrators and are not varied over time by a control system responsive to network traffic conditions. In contrast, the present invention provides for such QoS parameter settings to be varied over time by a control system responsive to network traffic conditions.

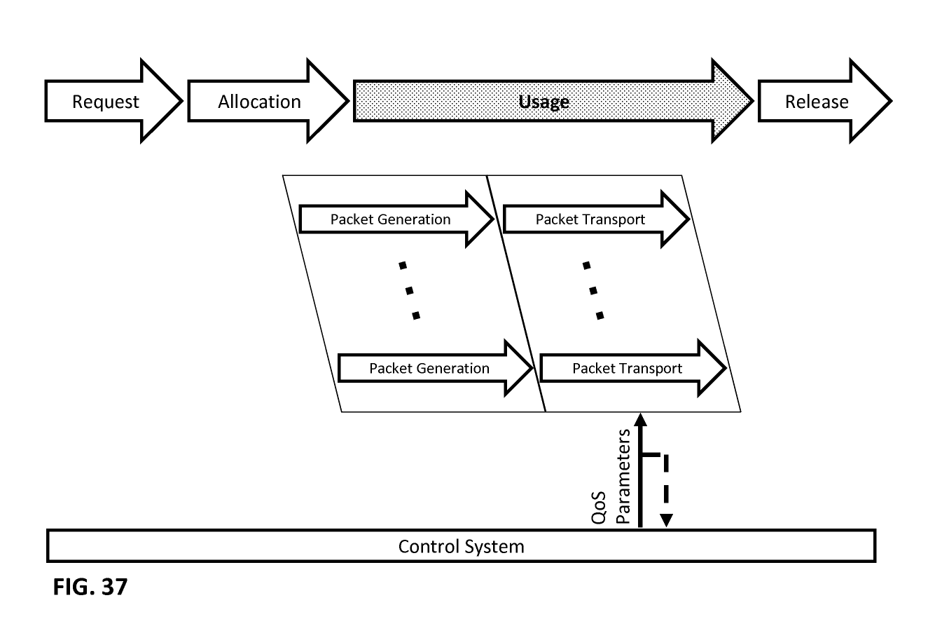

Further, the actions taken by the afore-listed provisions provided in contemporary networking technology are (with the exception of rate adaptation) typically performed strictly within network-internal packet transport systems such as switches and routers. In contrast, the present invention provides for other QoS-related actions to be taken by applications in some instances where advantageous, For example, FIG. 37 depicts an example arrangement wherein a control system controls QoS parameters affecting packet transport, varying these over time responsive to network traffic conditions.

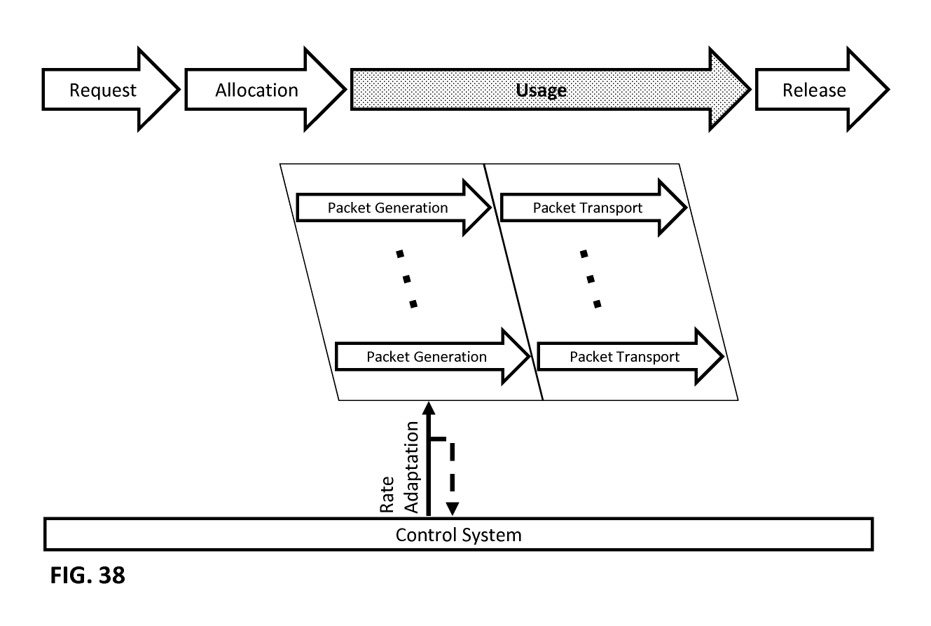

An exemplary QoS parameter whose control has been richly studied and which at least conceptually involves QoS-related actions taken by applications to be varied over time responsive to network traffic conditions is rate adaptation as used in wireless 802.11 networks (wherein the bit rate of an active call/session is changed from the bit-rate value initially allocated to a new bit-rate value). The invention provides for including the variation of bit rate at an application by a control system wherein the variation is responsive to network traffic conditions. For example, FIG. 38 depicts an example arrangement wherein a control system controls bit rate at applications, varying these over time responsive to network traffic conditions.

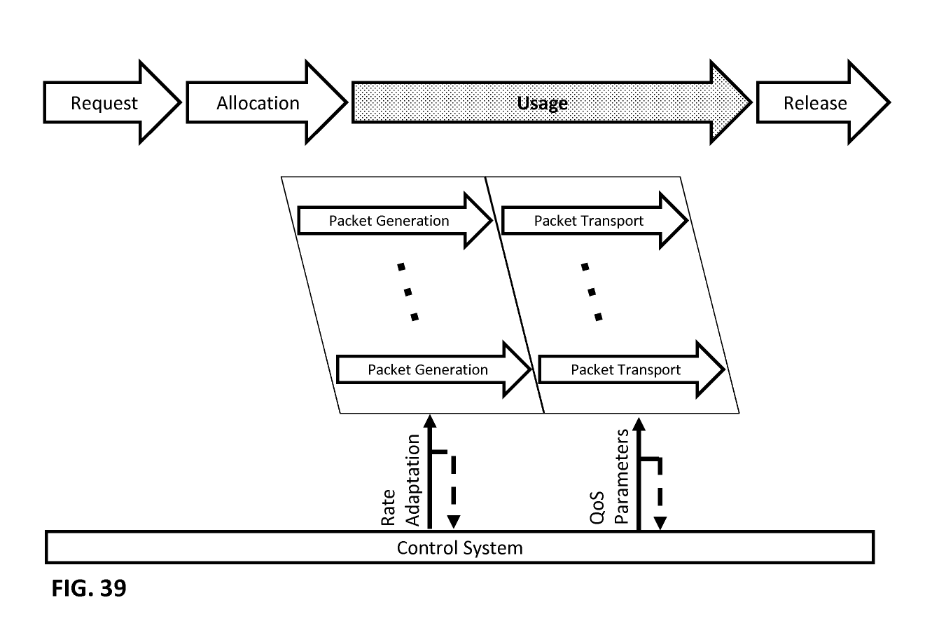

An embodiment of the invention further provides for a control system that combines real-time control of rate adaptation at applications together with real-time control of packet-level processes (for example, as can be had by adjusting QoS parameters). In various situations it can be advantageous to control these together, selectively or in combination varying one or both of these over time responsive to network traffic conditions. FIG. 39 depicts an example arrangement wherein a common control system controls bit rate at applications and packet-level processes (for example, as can be had by adjusting QoS parameters) at network elements, varying these over time responsive to network traffic conditions.

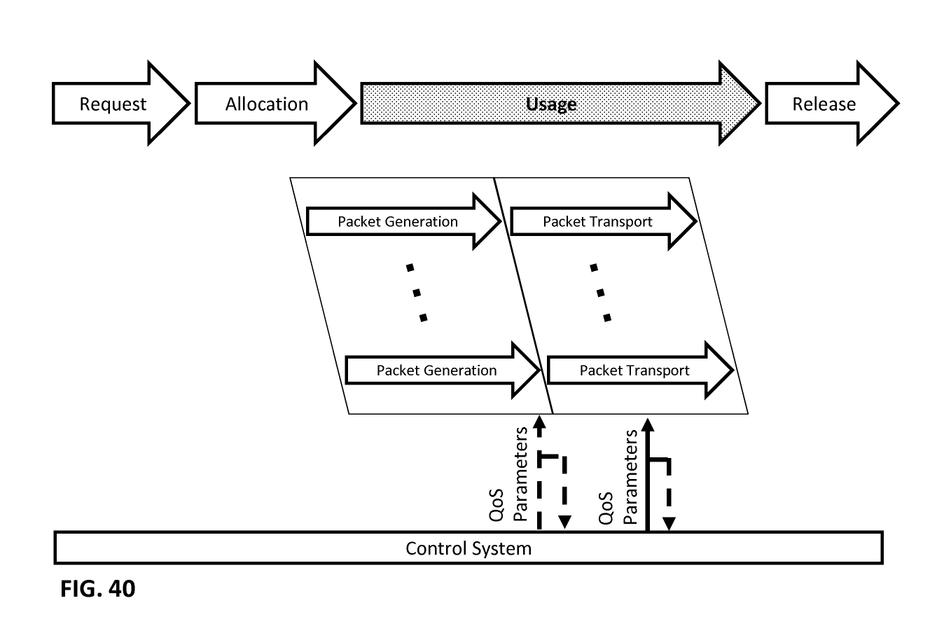

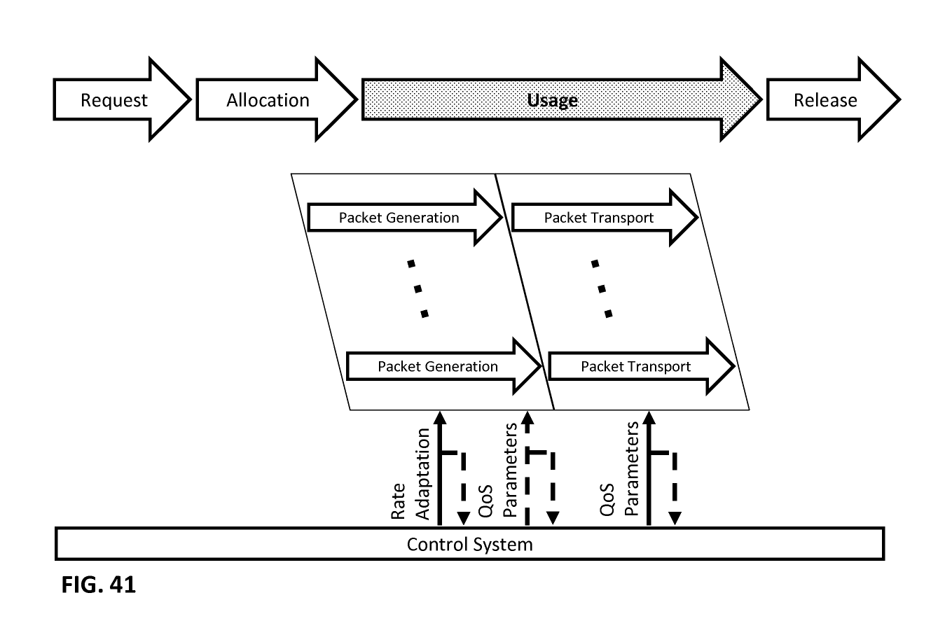

Yet further, an embodiment of the present invention provides for QoS-related actions taken by applications to be varied over time by a control system responsive to network traffic conditions. Aside from rate adaptation, this is not a direction taken by either the QoS community or applications developers. However, such an approach could be useful in some situations, for example in real-time video encoding. In some circumstances it could be advantageous to only adjust QoS-related actions taken by applications and this is anticipated and provided for by the invention. In most circumstances, however, it would be more be advantageous for a common control system to vary both QoS parameters at applications and packet transport QoS parameters at network elements, varying these over time responsive to network traffic conditions. FIG. 40 depicts an example of such an arrangement. FIG. 41 extends the example arrangement of FIG. 40 further by also including control of rate adaptation provisions at applications.

### 7.1 Example QoS and Other Packet-Level Process Control Actions and Policies

Some example actions and policies pertaining to actions for the control of packet-level processes (for example, as can be had by adjusting QoS parameters) can include the following (as well as mixtures, variations, and feature combinations of these and others):
Adjusting packet transport QoS parameters for calls/sessions operating at higher bit rates.
Adjusting packet transport QoS parameters for all calls/sessions of a particular service, class, or type.
Adjusting packet transport QoS parameters for only most recent calls/sessions of a particular service, class, or type when the network becomes loaded with active calls/sessions.
   Yet other arrangements are possible, anticipated, and accordingly provided for by the invention.

### 7.2 Quantizing and Hysteresis in the Control of QoS Parameters and Other Packet-Level Processes

The number of packet-level process and QoS parameter control messages can be reduced if the allowed bit rates are quantized in some way, for example from a list of standardized values, a list of conveniently spaced values, or according to a mathematical quantization function. The greater the level of this form of quantization, the less message flux required from the controller to the individual communications silos. As described earlier, in order to reduce the message flux from the controller to the individual communications silos, the quantization process is implemented in the controller as represented in FIG. 35A.

Another way to reduce QoS control message flux is to employ hysteresis in the adjustment of the rate allocation for new calls/sessions for each affected service. In one example implementation, the hysteresis process introduces directional memory into the rate allocation adjustment process. As described earlier, in order to reduce the message flux from the controller to the individual communications silos, the hysteresis process is implemented in the controller as represented in FIG. 35B.

Yet other arrangements are possible, anticipated, and accordingly provided for by the invention.

### 7.3 Controller Dynamics Considerations in the Control of QoS Parameters and Other Packet-Level Processes

The controller dynamics employed in the control of packet-level processes (for example, as can be had by adjusting QoS parameters) can incorporate one or more of the features described in Section 6.1.4. These include:
Rate-of-change measurements;
Time-integral;
PID controllers:
   Linear;
   Nonlinear;
   Weighting coefficients are adjusted as function of state (for example, with different anticipatory versus conservative lagging behaviors when the state is nearer resource limit and reservation boundaries than when the state is farther from resource limit and reservation boundaries;
   Conditional tests are performed on the values of current-state input and one or more of rate-of-change “time-derivative” and “time-integral” quantities;
Conditional tests are performed on the values of current-state input and one or more of rate-of-change “time-derivative” and “time-integral” quantities;
Linear predictor;
Nonlinear predictor;
Traditional Kalman (Gaussian) filter;
Modified Kalman filter (for example, non-Gaussian);
Time-driven ramp generator;
Periodic or dithering function;
Quantization process;
Hysteresis process.
   Yet other arrangements are possible, anticipated, and accordingly provided for by the invention.

### 7.4 Stochastic Model Considerations in the Control of QoS Parameters and Other Packet-Level Processes

In another approach, QoS parameter and other packet-level process control system elements can include:
In one example implementation, control of packet-level processes (for example, as can be had by adjusting QoS parameters) can comprise aspects specifically designed around mathematical expressions derived from models employing Markovian dynamics. In such an arrangement, it can be advantageous to provide a controller of packet-level processes (for example, as can be had by adjusting QoS parameters)—at network elements and/or at applications—with real-time estimates of packet transport measurements.
As another example, an implementation of control of packet-level processes (for example, as can be had by adjusting QoS parameters) can comprise aspects based on Bayesian decision theory. In such an arrangement, it can be advantageous to provide the packet-level process or QoS parameter control function(s) with real-time estimates of various probability distributions with respect to a set of observations.
As yet another example, an implementation of control of packet-level processes (for example, as can be had by adjusting QoS parameters) can comprise aspects based on time-series data. In such an arrangement, it can be advantageous to provide the packet-level process or QoS parameter control function with real-time estimates of various time-series quantities with respect to a set of observations.
As still another example, an implementation of control of packet-level processes (for example, as can be had by adjusting QoS parameters)—at network elements and/or at applications—can comprise aspects based on other types of models, for example UPC and NPC parameters. In such an arrangement, it can be advantageous to provide the QoS control function with real-time tabulations of various UPC and NPC parameter values and demographics with respect to the currently active calls/sessions.

Yet other arrangements are possible, anticipated, and accordingly provided for by the invention.

### 8. Joint (Two-Time-Scale) Call/Session and Packet (QoS) Closed-Loop Control

As mentioned before, an embodiment of the invention provides closed-loop feedback control of session/call admission parameters and closed-loop feedback control of packet-level processes (for example by closed-loop feedback control of QoS parameters). Also as mentioned before, the closed-loop feedback control of session/call admission parameters acts on a considerably slower time-scale than the closed-loop feedback control of packet process (for example packet process affected by QoS parameters).

In Section 7, closed-loop feedback control of session/call admission parameters is performed independently from the closed-loop feedback control of QoS parameters. Accordingly, in an embodiment provided for by the invention, closed-loop feedback control of session/call admission parameters can be done in parallel and independently from closed-loop feedback control of packet-level processes (for example, as can be had by adjusting QoS parameters). In such an arrangement, each of these two control systems can be separately designed and separately optimized without any coordination between these two control systems. Such an arrangement was depicted earlier as the example provided in FIG. 30.

In this section, alternate embodiments are provided wherein the closed-loop feedback control of session/call admission parameters is done together and in coordination with the closed-loop feedback control of network QoS parameters. Such a control system acts on two time-scales in a manner that permits a coordinated optimization of both course and fine structure of bandwidth allocation and utilization. Such an arrangement was depicted earlier as the example provided in FIG. 31A. Alternatively, other embodiments can comprise only the third operation comprising both the first time-scale and the second time-scale in a unitary controller, as depicted in FIG. 31B.

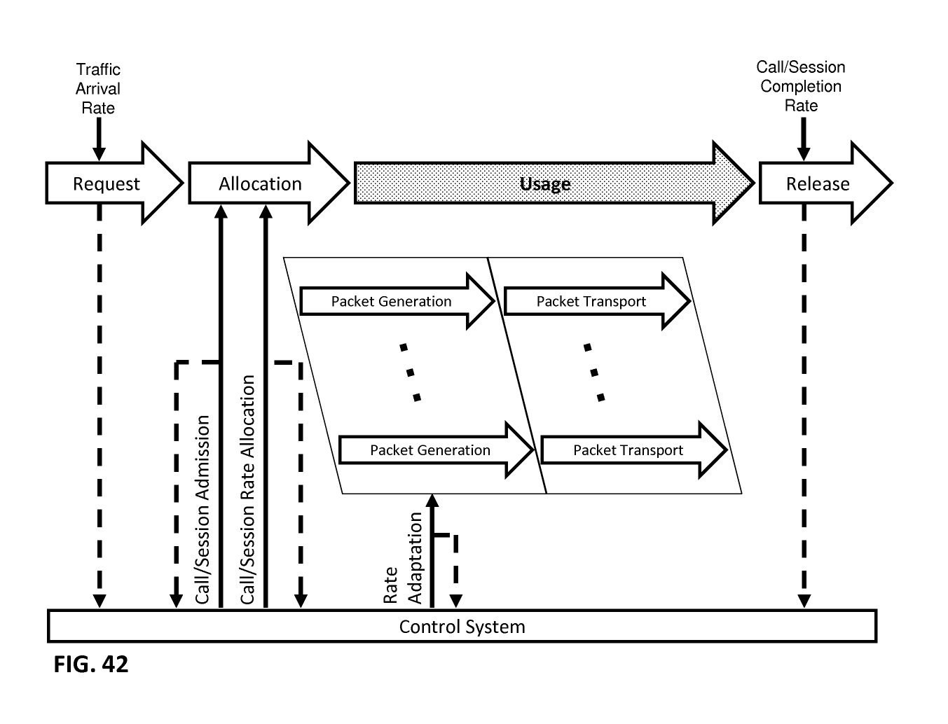

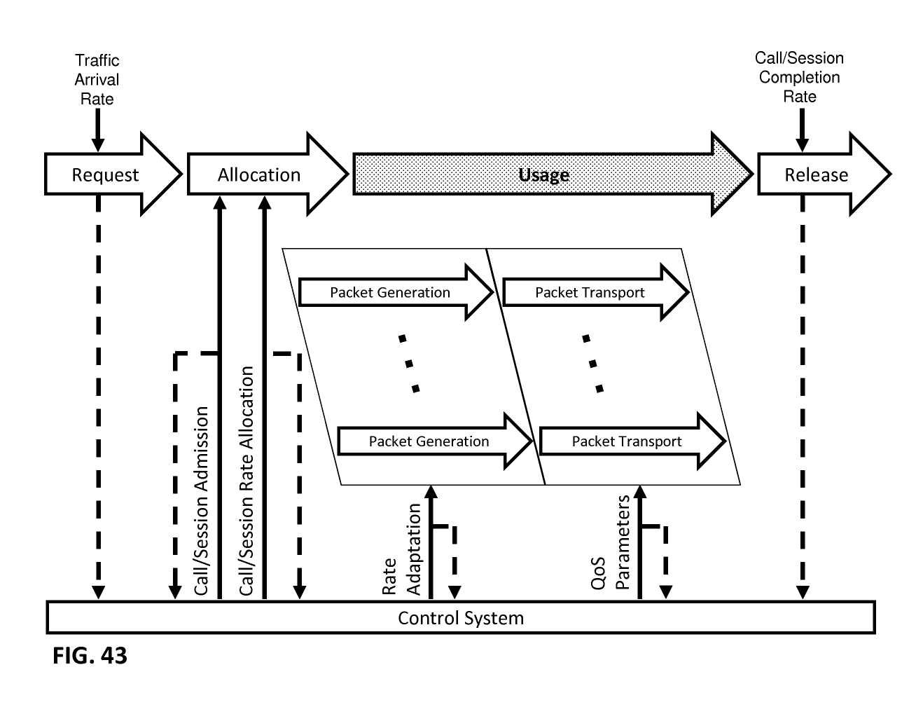

Some examples of joint two-time-scale call/session and packet (QoS) closed-loop control include:
Control of rate adaptation (bit-rate of active calls/sessions after their admission, thus changing the bandwidth footprint of that particular active session/call) as a function of the number and type of active calls/sessions. For example, as traffic levels increase, various active sessions/calls are allocated less bandwidth. FIG. 42 depicts an example adaptation of the arrangement of FIG. 36 wherein the basic session admission closed-loop control system also variably controls at least one rate adaptation parameter within the duration of an active call or session.
Combined closed-loop feedback control of session/call admission, rate adaptation parameters, and network element packet (QoS) parameters. FIG. 43 depicts an example implementation approach.

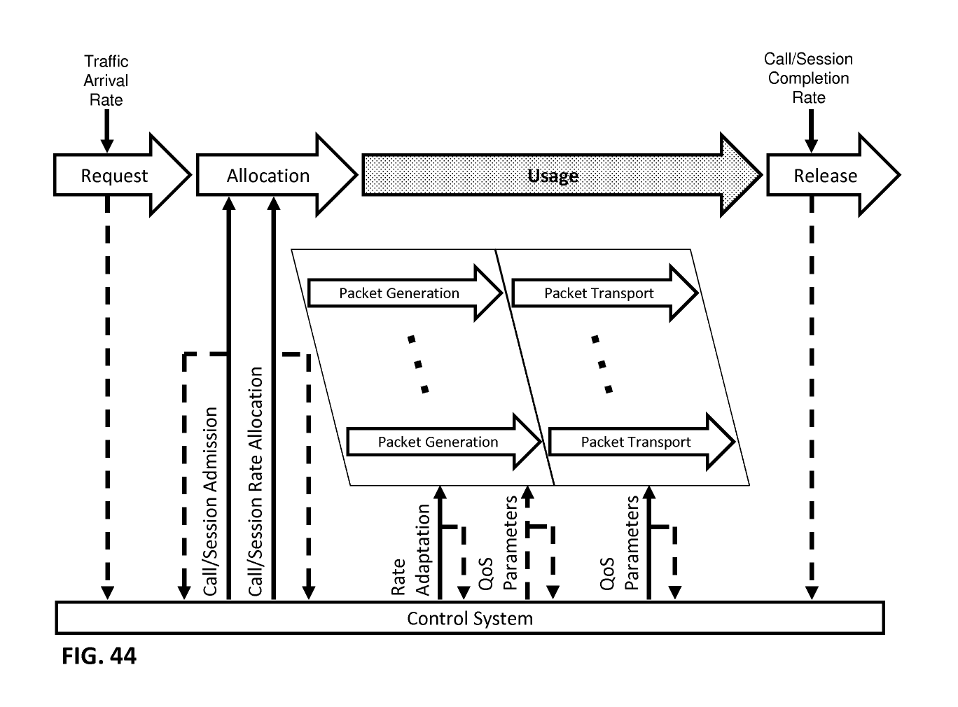

FIG. 44 depicts an example adaptation of the arrangement of FIG. 43 wherein the closed-loop control system additionally controls additional packet generation QoS parameters at the application.

Yet other arrangements are possible, anticipated, and accordingly provided for by the invention.

In principle, a number of methods can be used to construct a control system operating at two such differing time-scales. These include but are not restricted to:
Abstracting the faster (packet) dynamics into statistical moments (averages, variances, etc.), extremal values, etc. to create control signals for slower (call/session) dynamics;
Abstracting the faster (packet) dynamics into extremal values to create control signals for slower (call/session) dynamics;
Abstracting the slower (call/session) dynamics to piecewise constant controls to the faster (packet) dynamics;
Use of rare events models;
Use of singular perturbation techniques;
Combinations of these among themselves and or with yet other techniques.
   Yet other arrangements are possible, anticipated, and accordingly provided for by the invention.

### 8.1 Example Control Actions and Policies for Joint Call/Session and Packet Control

Some example actions and policies pertaining to actions for the control of QoS parameters can include the following (as well as mixtures, variations, and feature combinations of these and others):
Adjusting packet transport QoS parameters for only most recent calls/sessions of a particular service, class, or type when the network becomes loaded with active calls/sessions;
Admitting all new calls/session at higher bit rates when the network is lightly loaded with active calls/sessions and admitting some new calls/session at lower bit rates when the network is more heavily loaded with active calls/sessions;
In cases where only some packet flows and/or applications are to have QoS parameters adjusted, the selection could be made according to:
   i. round-robin w/fixed duty cycle;
   ii. round-robin w/variable duty cycle.
Conditional tests can be performed on the values of current-state input, the outcome of the conditional tests causing the generation of a control message to change a QoS parameter until the next update.
Yet other arrangements are possible, anticipated, and accordingly provided for by the invention.

### 8.2 Quantizing and Hysteresis in Joint Call/Session and Packet Control

As described above, the number of control messages can be reduced if the allowed bit rates are quantized in some way, for example from a list of standardized values, a list of conveniently spaced values, or according to a mathematical quantization function. The greater the level of this form of quantization, the less message flux required from the controller to the individual communications silos. In order to reduce the message flux from the controller to the individual communications silos, the quantization process is implemented in the controller as represented in FIG. 35A.

As described earlier, another way to reduce control message flux is to employ hysteresis in the adjustment of the rate allocation for new calls/sessions for each affected service. In one example implementation, the hysteresis process introduces directional memory into the rate allocation adjustment process. In order to reduce the message flux from the controller to the individual communications silos, the hysteresis process is implemented in the controller as represented in FIG. 35B.

Yet other arrangements are possible, anticipated, and accordingly provided for by the invention.

### 8.3 Controller Dynamics Considerations in Joint Call/Session and Packet Control

The controller dynamics employed in the combined control of call/session processes and packet-level processes (for example, as can be had by adjusting QoS parameters) can incorporate one or more of several approaches to two time-scale control approaches which can be optimized, for example:
Two time-scale singular perturbation (for example, structuring a perturbation parameter to be the ratio of the slower time-scale to the faster time-scale and taking the limit as is diminished to zero) [14];
Modulations of a “Slow” (Gaussian or Markov) process by a “Fast” Markov process [15];
Fluid models [16] wherein the faster time-scale phenomena (particularly if it represents a flow, as in a communications system) is modeled as a fluid flow controlled by the slower time-scale dynamics.
   Often the dynamics of two time-scale dynamical systems are effectively separable and support separate expectations and intuitions as to behavior and control at each time-scale for the subsequently reduced-order systems. In some circumstances, however, the dynamics can be much richer and take on aspects of the full underlying dimensionally comprised across all the time scales [17].

Additionally, the controller dynamics employed in the combined control of call/session processes and packet-level processes (for example, as can be had by adjusting QoS parameters) can also incorporate one or more of several approaches to coordinated hierarchical control, for example:
Multilayer traffic models [16, Section IV], [18];
Hierarchical state space, state aggregation, decomposition [19],[20];
Supervisory control of Markov chains [21];
Hierarchical deterministic control [22];
Hierarchical deterministic control [23].

Further, the controller dynamics employed in the combined control of call/session processes and packet-level processes (for example, as can be had by adjusting QoS parameters) can also incorporate one or more of several approaches to hybrid system and Markov switching control, for example [24], [25].

Yet further, the controller dynamics employed in the combined control of call/session processes and packet-level processes (for example, as can be had by adjusting QoS parameters) can also incorporate one or more of several approaches to large deviations and excessive measures, for example [18], [19].

Still further, the controller dynamics employed in the combined control of call/session processes and packet-level processes (for example, as can be had by adjusting QoS parameters) can additionally incorporate one or more of the features described in Section 6.1.4. These include:
Rate-of-change measurements;
Time-integral;
PID controllers:
   Linear;
   Nonlinear;
   Weighting coefficients are adjusted as function of state (for example, with different anticipatory versus conservative lagging behaviors when the state is nearer resource limit and reservation boundaries than when the state is farther from resource limit and reservation boundaries;
   Conditional tests are performed on the values of current-state input and one or more of rate-of-change “time-derivative” and “time-integral” quantities;
Conditional tests are performed on the values of current-state input and one or more of rate-of-change “time-derivative” and “time-integral” quantities;
Linear predictor;
Nonlinear predictor;
Traditional Kalman (Gaussian) filter;
Modified Kalman filter (for example, non-Gaussian);
Time-driven ramp generator;
Periodic or dithering function;
Quantization process;
Hysteresis process.
   Yet other arrangements are possible, anticipated, and accordingly provided for by the invention.

### 8.4 Stochastic Model Considerations in Joint Call/Session and Packet Control

In another approach, QoS parameter control (at network elements and/or at applications) can include aspects structured around a model of the stochastic dynamics and/or statistics of the call/session arrival and departure processes. These can facilitate the advantage or need for providing the adaptive reservations controller with other types of input information. For example:
In one exemplary implementation, rate allocation control can comprise aspects specifically designed around mathematical expressions derived from models employing Markovian dynamics. In such an arrangement, it can be advantageous to provide a controller of QoS parameter control (at network elements and/or at applications) with real-time estimates of arrival rates and holding times.
As another example, an implementation of rate allocation control can comprise aspects based on Bayesian decision theory. In such an arrangement, it can be advantageous to provide the QoS control function with real-time estimates of various probability distributions with respect to a set of observations.
As yet another example, an implementation of rate allocation control can comprise aspects based on time series data. In such an arrangement, it can be advantageous to provide the QoS control function with real-time estimates of various time series quantities with respect to a set of observations.
As still another example, an implementation of QoS parameter control (at network elements and/or at applications) can comprise aspects based on other types of models, for example UPC and NPC parameters. In such an arrangement, it can be advantageous to provide the QoS control function with real-time tabulations of various UPC and NPC parameter values and demographics with respect to the currently active calls/sessions.

Yet other arrangements are possible, anticipated, and accordingly provided for by the invention.

### 9. Description of Exemplary Computer Hardware Platform

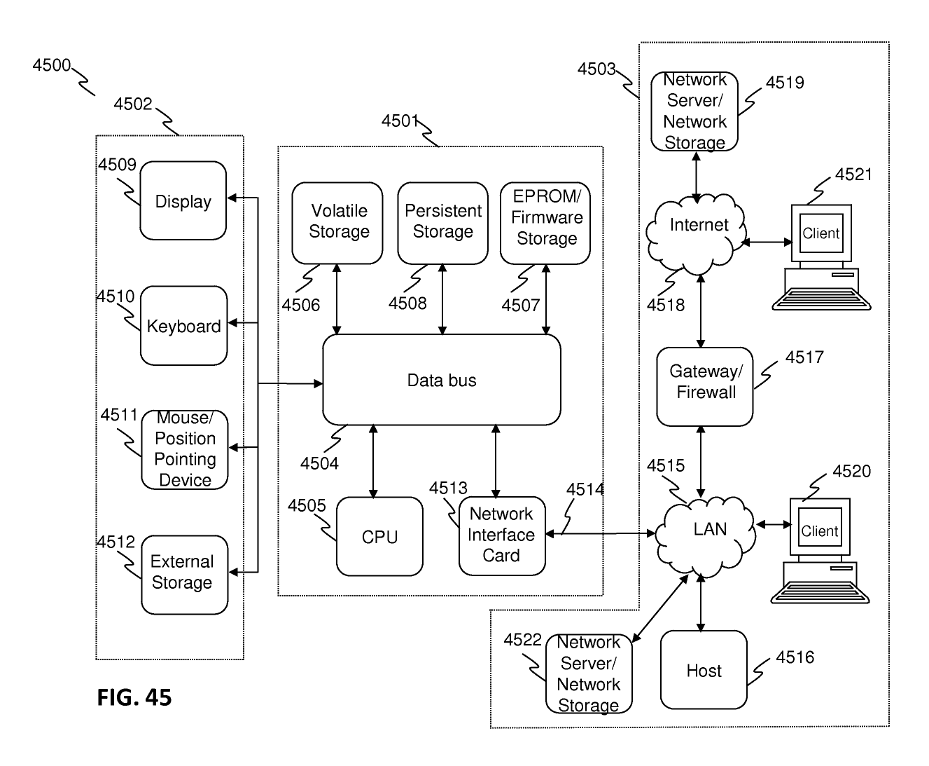

FIG. 45 is a block diagram that illustrates an embodiment of a computer/server system 4500 upon which an embodiment of the inventive methodology may be implemented. The system 4500 includes a computer/server platform 4501, peripheral devices 4502 and network resources 4503.

The computer platform 4501 may include a data bus 4504 or other communication mechanism for communicating information across and among various parts of the computer platform 4501, and a processor 4505 coupled with bus 4504 for processing information and performing other computational and control tasks. Computer platform 4501 also includes a volatile storage 4506, such as a random access memory (RAM) or other dynamic storage device, coupled to bus 4504 for storing various information as well as instructions to be executed by processor 4505. The volatile storage 4506 also may be used for storing temporary variables or other intermediate information during execution of instructions by processor 4505. Computer platform 4501 may further include a read only memory (ROM or EPROM) 4507 or other static storage device coupled to bus 4504 for storing static information and instructions for processor 4505, such as basic input-output system (BIOS), as well as various system configuration parameters. A persistent storage device 4508, such as a magnetic disk, optical disk, or solid-state flash memory device is provided and coupled to bus 4504 for storing information and instructions.

Computer platform 4501 may be coupled via bus 4504 to a display 4509, such as a cathode ray tube (CRT), plasma display, or a liquid crystal display (LCD), for displaying information to a system administrator or user of the computer platform 4501. An input device 4510, including alphanumeric and other keys, is coupled to bus 4504 for communicating information and command selections to processor 4505. Another type of user input device is cursor control device 4511, such as a mouse, a trackball, or cursor direction keys for communicating direction information and command selections to processor 4505 and for controlling cursor movement on display 4509. This input device typically has two degrees of freedom in two axes, a first axis (e.g., x) and a second axis (e.g., y), that allows the device to specify positions in a plane.

An external storage device 4512 may be coupled to the computer platform 4501 via bus 4504 to provide an extra or removable storage capacity for the computer platform 4501. In an embodiment of the computer system 4500, the external removable storage device 4512 may be used to facilitate exchange of data with other computer systems.

The invention is related to the use of computer system 4500 for implementing the techniques described herein. In an embodiment, the inventive system may reside on a machine such as computer platform 4501. According to one embodiment of the invention, the techniques described herein are performed by computer system 4500 in response to processor 4505 executing one or more sequences of one or more instructions contained in the volatile memory 4506. Such instructions may be read into volatile memory 4506 from another computer-readable medium, such as persistent storage device 4508. Execution of the sequences of instructions contained in the volatile memory 4506 causes processor 4505 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 4505 for execution. The computer-readable medium is just one example of a machine-readable medium, which may carry instructions for implementing any of the methods and/or techniques described herein. Such a medium may take many forms, including but not limited to, non-volatile media and volatile media. Non-volatile media includes, for example, optical or magnetic disks, such as storage device 4508. Volatile media includes dynamic memory, such as volatile storage 4506.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, a flash drive, a memory card, any other memory chip or cartridge, or any other medium from which a computer can read.

Various forms of computer readable media may be involved in carrying one or more sequences of one or more instructions to processor 4505 for execution. For example, the instructions may initially be carried on a magnetic disk from a remote computer. Alternatively, a remote computer can load the instructions into its dynamic memory and send the instructions over a telephone line using a modem. A modem local to computer system can receive the data on the telephone line and use an infra-red transmitter to convert the data to an infra-red signal. An infra-red detector can receive the data carried in the infra-red signal and appropriate circuitry can place the data on the data bus 4504. The bus 4504 carries the data to the volatile storage 4506, from which processor 4505 retrieves and executes the instructions. The instructions received by the volatile memory 4506 may optionally be stored on persistent storage device 4508 either before or after execution by processor 4505. The instructions may also be downloaded into the computer platform 4501 via Internet using a variety of network data communication protocols well known in the art.

The computer platform 4501 also includes a communication interface, such as network interface card 4513 coupled to the data bus 4504. Communication interface 4513 provides a two-way data communication coupling to a network link 4515 that is coupled to a local network 4515. For example, communication interface 4513 may be an integrated services digital network (ISDN) card or a modem to provide a data communication connection to a corresponding type of telephone line. As another example, communication interface 4513 may be a local area network interface card (LAN NIC) to provide a data communication connection to a compatible LAN. Wireless links, such as well-known 802.11a, 802.11b, 802.11g and Bluetooth may also used for network implementation. In any such implementation, communication interface 4513 sends and receives electrical, electromagnetic or optical signals that carry digital data streams representing various types of information.

Network link 4513 typically provides data communication through one or more networks to other network resources. For example, network link 4515 may provide a connection through local network 4515 to a host computer 4516, or a network storage/server 4517. Additionally or alternatively, the network link 4513 may connect through gateway/firewall 4517 to the wide-area or global network 4518, such as an Internet. Thus, the computer platform 4501 can access network resources located anywhere on the Internet 4518, such as a remote network storage/server 4519. On the other hand, the computer platform 4501 may also be accessed by clients located anywhere on the local area network 4515 and/or the Internet 4518. The network clients 4520 and 4521 may themselves be implemented based on the computer platform similar to the platform 4501.

Local network 4515 and the Internet 4518 both use electrical, electromagnetic or optical signals that carry digital data streams. The signals through the various networks and the signals on network link 4515 and through communication interface 4513, which carry the digital data to and from computer platform 4501, are exemplary forms of carrier waves transporting the information.

Computer platform 4501 can send messages and receive data, including program code, through the variety of network(s) including Internet 4518 and LAN 4515, network link 4515 and communication interface 4513. In the Internet example, when the system 4501 acts as a network server, it might transmit a requested code or data for an application program running on client(s) 4520 and/or 4521 through Internet 4518, gateway/firewall 4517, local area network 4515 and communication interface 4513. Similarly, it may receive code from other network resources.

The received code may be executed by processor 4505 as it is received, and/or stored in persistent or volatile storage devices 4508 and 4506, respectively, or other non-volatile storage for later execution.

Finally, it should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention. For example, the described software may be implemented in a wide variety of programming or scripting languages, such as Assembler, C/C++, Perl, Shell, PHP, Java, etc.

### CLOSING REMARKS

While the invention has been described in detail with reference to disclosed embodiments, various modifications within the scope of the invention will be apparent to those of ordinary skill in this technological field. It is to be appreciated that features described with respect to one embodiment typically can be applied to other embodiments.

The invention can be embodied in other specific forms without departing from the spirit or essential characteristics thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein. Therefore, the invention properly is to be construed with reference to the claims.

### REFERENCES

[1] L. Ludwig, “Adaptive Links—A Methodology for Dynamic Bandwidth Allocation,”Proc. 6th International Conference on Computer Communications, London, September 1982.
[2] J. S. Kaufman, “Blocking in a Shared Resource Environment,” IEEE Transactions on Communications, vol. COM-29, No. 10, October 1981 pp. 1474-1481.
[3] K. W. Ross, Multiservice Loss Models for Broadband Telecommunication Networks, Springer, 1995, ISBN 3-540-19918-7.
[4] Miguel Barreiros and Peter Lundqvist, QOS-Enabled Networks: Tools and Foundations, John Wiley & Sons, Ltd, 2010 (ISBN-10 0470686979; ISBN-13 978-0-470-68697-3).
[5] Cisco Systems, “Cisco Catalyst 2950 Series Switches with Enhanced Image SW” http://www.cisco.com/en/US/prod/collateral/switches/ps5718/ps628/product_data_sheet09186a00801cfb64_ps6558 Products_Data_Sheet.html (visited Jun. 29, 2011).
[6] Juniper Networks, “EX Server Ethernet Switches: QoS Enabling the Enterprise,” http://www.juniper.net/us/en/local/pdf/whitepapers/2000255-en.pdf (visited Jun. 29, 2011).
[7] Juniper Networks, “JUNOSe Policy and QoS Configuration Guide—Configuring Quality of Service,” http://www.juniper.net/techpubs/software/erx/junose61/swconfig-policy-qos/frameset.htm (visited Jun. 29, 2011).
[8] ITU-T, Traffic control and congestion control in B ISDN, Recommendation I.371, International Telecommunication Union, 2004, Annex A.
[9] A. W. Barnhart, “Explicit Rate performance Evaluations,” ATM Forum Technical Committee Traffic Management Working Group, Contribution ATM Forum/94-0983, 1994.
[10] D. Sisalem; H. Schulzrinne, “The Adaptive Load Service: An ABR-like Service for the Internet,” Fifth IEEE Symposium on Computers and Communications (ISCC '2000), 2000.
[11] D. Katabi; M. Handley, “Enhancing Internet Congestion Control Using Explicit and Precise Feedback,” Oxygen 2000 Workshop, 2000.
[12] D. Katabi, “Decoupling Congestion Control from the Bandwidth Allocation Policy and its Application to High Bandwidth-Delay Product Networks,” Ph.D. Thesis, M.I.T., 2000.
[13] M. Welzl, Scalable Performance Signalling and Congestion Avoidance, Kluwer, 2003, ISBN 1-4020-7570-7.
[14] J. H. Chow, ed., Time-Scale Modeling of Dynamic Networks with Applications to Power Systems, Springer, ISBN 0-387-12106-4, 1982.
[15] Y. Kabanov; S. Pergamenshchikov, Two-Scale Stochastic Systems, Springer, 2003, ISBN 3-540-65332-5.
[16] Filipiak, Modelling and Control of Dynamic Flows in Communications Networks, Springer, 1988, ISBN 0-387-18292-6.
[17] C. Jones; A. Khibnik, Multiple-Time-Scale Dynamical Systems, Springer, 2001, ISBN 0-387-95126-1.
[18] J. Hui, “Resource Allocation for Broadband Networks,” IEEE Selected Areas Commun., vol. 6, no. 9., December 1988.
[19] M. Aoki, New Approaches to Macroeconomic Modeling, Cambridge University Press, 1996, ISBN 0-521-63769-4.
[20] P. J. Courtis, Decomposability, Academic Press, 1977, ISBN 0-12-193750-X.
[21] J. Forestier and P. Varaiya, “Multilayer Control of Large Markov Chains,” IEEE Transactions on Automatic Control, vol. AC-23, no. 2, pp. 298-305, April 1978.
[22] M. Singh, Dynamical Hierarchical Control (Revised edition), North Holland, 1977, ISBN 0-444-85488-6.
[23] S. Sethi; Q. Zhang, Hierarchical Decision Making in Stochastic Manufacturing Systems, Birkhauser, 1994, ISBN 0-8176-3735-4.
[24] A. Matveev; A. Savkin, Qualitative Theory of Hybrid Dynamical Systems, Birkhauser, 2000, ISBN 0-8176-4141-6.
[25] X. Mao; C. Yuan, Stochastic Differential Equations with Markov Switching, Imperial College Press, 2006, ISBN 1-86094-701-8.

I claim:

1. A real-time control environment for managing bandwidth allocation in a bandwidth-constrained network, the control environment comprising:
means of observing at least one session-level network performance parameter of a session-level bandwidth allocation process, the session-level network performance parameter comprising an associated value;
means of observing at least one QoS-level network performance parameter of a QoS-level bandwidth allocation process, the QoS-level network performance parameter comprising an associated value;
means of adjusting at least one session-level control parameter of the session-level bandwidth allocation process;
means of adjusting at least one QoS-level control parameter of the QoS-level bandwidth allocation process; and
a real-time control system, the control system comprising a first operation comprising a first time-scale associated with sessions, a second operation comprising a second time-scale associated with packets, and a third operation comprising both the first time-scale and the second time-scale,
wherein the real-time control system performs control actions by adjusting the at least one of the session-level control parameter and the QoS-level control parameter;
wherein the control actions comprise utilizing the value of the session-level network performance parameter and the value of the QoS-level network performance parameter as inputs to real-time control calculations, the real-time control calculations comprising the first operation, second operation, and third operation, and
wherein the adjusting the at least one of the session-level control parameter is responsive to the first operation and third operation, and the adjusting the at least one of the QoS-level control parameter is responsive to the second operation and third operation.

2. The real-time control environment of claim 1, wherein the bandwidth-constrained network is an enterprise network.

3. The real-time control environment of claim 1, wherein the bandwidth-constrained network is the interconnection network for a computing cloud.

4. The real-time control environment of claim 1, wherein the bandwidth-constrained network is a wireless network.

5. The real-time control environment of claim 1, wherein the bandwidth-constrained network is a mobile network.

6. The real-time control environment of claim 1, wherein the means of observing the at least one session-level network performance parameter comprises network monitoring.

7. The real-time control environment of claim 1, wherein the means of observing the at least one QoS-level network performance parameter comprises network monitoring.

8. The real-time control environment of claim 1, wherein the means of adjusting the at least one session-level network performance parameter comprises communications utilizing an API of a router.

9. The real-time control environment of claim 1, wherein the means of adjusting the at least one session-level network performance parameter comprises communications utilizing configuration file of a router.

10. The real-time control environment of claim 1, wherein the means of observing the at least one QoS-level network performance parameter comprises communications utilizing an API of a router.

11. The real-time control environment of claim 1, wherein the means of adjusting the at least one session-level network performance parameter comprises communications utilizing an API of a switch.

12. The real-time control environment of claim 1, wherein the means of adjusting the at least one session-level network performance parameter comprises communications utilizing a configuration file of a switch.

13. The real-time control environment of claim 1, wherein the means of observing the at least one QoS-level network performance parameter comprises communications utilizing an API of a switch.

14. The real-time control environment of claim 1, wherein the means of observing the at least one QoS-level network performance parameter comprises communications utilizing an API of a gatekeeper.

15. The real-time control environment of claim 1, wherein the means of observing the at least one QoS-level network performance parameter comprises communications utilizing a configuration file of a gatekeeper.

16. The real-time control environment of claim 1, wherein the means of adjusting the at least one session-level network performance parameter comprises communications utilizing an API of a gatekeeper.

17. The real-time control environment of claim 1, wherein the means of adjusting the at least one session-level network performance parameter comprises communications utilizing an API of a service-specific communications manager.

18. The real-time control environment of claim 1, wherein the means of observing the at least one QoS-level network performance parameter comprises communications utilizing an API of a service-specific communications manager.

19. The real-time control environment of claim 1, wherein the wherein the real-time control calculations are responsive to the rate-of-change of the at least one session-level network performance parameter;

20. The real-time control environment of claim 1, wherein the wherein the real-time control calculations are responsive to the rate-of-change of the at least one QoS-level network performance parameter;

21. The real-time control environment of claim 1, wherein the real-time control calculations further comprise a PID controller, wherein the adjusting of at least one of the session-level control parameter and the QoS-level control parameter is responsive to the output of the PID controller.

22. The real-time control environment of claim 1, wherein the real-time control calculations further comprise a linear predictor, wherein the adjusting of at least one of the session-level control parameter and the QoS-level control parameter is responsive to the output of the linear predictor.

23. The real-time control environment of claim 1, wherein the real-time control calculations further comprise a nonlinear predictor, wherein the adjusting of at least one of the session-level control parameter and the QoS-level control parameter is responsive to the output of the nonlinear predictor.

24. The real-time control environment of claim 1, wherein the real-time control calculations further comprise a Gaussian Kalman filter and wherein the adjusting of at least one of the session-level control parameter and the QoS-level control parameter is responsive to the output of the Gaussian Kalman filter.

25. The real-time control environment of claim 1, wherein the real-time control calculations further comprise a non-Gaussian Kalman filter and wherein the adjusting of at least one of the session-level control parameter and the QoS-level control parameter is responsive to the output of the non-Gaussian Kalman filter.

26. The real-time control environment of claim 1, wherein the real-time control calculations further comprise a time-driven ramp generator and wherein the adjusting of at least one of the session-level control parameter and the QoS-level control parameter is responsive to the output of the time-driven ramp generator.

27. The real-time control environment of claim 1, wherein the real-time control calculations further comprise a dithering function and wherein the adjusting of at least one of the session-level control parameter and the QoS-level control parameter is responsive to the output of the dithering function.

28. The real-time control environment of claim 1, wherein the real-time control calculations further comprise a quantization process and wherein the adjusting of at least one of the session-level control parameter and the QoS-level control parameter is responsive to the output of the quantization process.

29. The real-time control environment of claim 1, wherein the real-time control calculations further comprise hysteresis and wherein the adjusting of at least one of the session-level control parameter and the QoS-level control parameter is responsive to the output of the hysteresis process.
